(19) United States
(12) Patent Application Publication
(10) Pub. No.: US 2003/0182437 A1
(43) Pub. Date: Sep. 25, 2003

(54) Proxy server and proxy control program

(75) Inventors: Masayoshi Kobayashi, Tokyo (JP); Toshiyasu Kurasugi, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/228,925

(22) Filed: Aug. 28, 2002

(30) Foreign Application Priority Data
Feb. 28, 2002 (JP) 2002-054196

(51) Int. Cl. G06F 15/16

(52) U.S. Cl. 709/232

(57) ABSTRACT

The stream proxy server of the present invention includes a network information acquisition unit, a transport layer protocol control unit capable of transmitting and receiving data by using a plurality of transport layer protocols having a flow control function and different band sharing characteristics, a reception rate control unit for reading data at a rate determined by the transport layer protocol control unit, and a prefetch control unit for determining a rate of contents acquisition from an origin server and a transport layer protocol to be used based on information obtained from the network information acquisition unit and a buffer margin, and notifying the reception rate control unit of the determined rate and notifying the transport layer protocol control unit of the transport layer protocol to be used.

### BACKGROUND OF THE INVENTION

1. Field of the Invention

The present invention relates to a stream proxy server for streaming the contents to a client, with a part or all of contents held in a storage device, while obtaining a content fragment that a stream proxy server fails to have from an origin server and adding the same to the storage device and, more particularly, to a stream proxy server and a network technique which realize acquisition of contents from an origin server while suppressing effects on other traffic flowing through a network.

2. Description of the Related Art

FIG. 34 shows a structural diagram of a network using a conventional stream proxy server. A conventional stream proxy server 200 is assumed to provide a number n of clients 100-1 to 100-n with n-stream proxy service with respect to contents held by a number m of origin servers 400-1 to 400-m. Also assume that the proxy server and the origin servers 400-1 to 400-m are connected to each other via a router 300, a link 700 and a network 500. On the link 700, traffic between the network 500 and a network 600 also flow.

Streaming is to transmit contents requested by the clients 100-1 to 100-n starting at a position in the contents requested by the client at a requested speed (transmission rate) to the client. Streaming allows the clients 100-1 to 100-n to sequentially reproduce (or use) contents starting with a received part of the contents, so that the client has no need to wait until receiving the whole part to reduce a time before reproduction starts.

The stream proxy service is to receive a viewing and listening request from an element C (e.g. clients 100-1 to 100-n) within a network and obtain, as to the content whose viewing and listening is requested, a part held by the stream proxy server 200 from the stream proxy server 200 and a part not held from an element S (e.g. origin servers 400-1 to 400-m) within the network which holds the content to stream the content to the element C (e.g. clients 100-1 to 100-n) within the network. The stream proxy server 200 preserves a part or all of the contents obtained from the element S (e.g. origin server) in the network in a storage device. When a viewing and listening request is made for the same contents next time by the element C (e.g. clients 100-1 to 100-n) in the network, the stream proxy server reads the preserved part from the own storage device and streams the same by streaming to the element C (e.g. client) without obtaining the part from the element S (e.g. origin server) in the network. It is also possible to use an origin server which conducts streaming as the element C in the network and use a disc device as the element S in the network.

FIG. 35 is a diagram showing an internal structure of a conventional stream proxy server 200. Description will be made of each component.

A streaming control unit 201 has a function of receiving a content viewing and listening request from a client, reading content whose viewing and listening is requested from a storage unit 204 and streaming the content to the client. The unit 201 also has a function of transferring a viewing and listening request to a prefetch control unit 202.

The prefetch control unit 202 receives a viewing and listening request from the streaming control unit 201 and as to content whose viewing and listening is requested by a client, when there exists a content fragment (all or a part of the content) which is not held in the storage unit 204, instructs a transport layer control unit 205 to set up a connection with the origin server. In addition, the unit 202 transmits a content acquisition request (composed of a content identifier and a start position and an end position of each content fragment to be obtained) to the set up connection (using a writing interface provided by the transport layer control unit). Since the server returns the relevant content fragment to the connection, the prefetch control unit 202 reads the fragment from the connection (using a reading interface provided by the transport layer control unit) and writes the same to the storage unit 204. Although the content fragments will be written into the storage unit as long as a capacity of the storage device permits, when the capacity runs out, delete a part of the contents whose streaming is already done to ensure a writing capacity.

The storage unit 204 stores a part or all of the contents of the origin server. The unit provides the streaming control unit and the prefetch control unit with an interface for write to an arbitrary position of a stream and for read from an arbitrary position and positional information held for each content.

The transport layer control unit 205 is a part for controlling data communication using a transport layer protocol (e.g. TCP). According to an instruction from the prefetch control unit 202, the unit conducts set-up and cut-off of a connection with the origin server and termination processing of a transport layer (e.g. TCP transmission and reception protocol processing in a case where the transport layer is TCP) necessary for data transmission and reception. The unit also has an interface for data read from and data write to the prefetch control unit for each connection set up.

Next, operation of the conventional stream proxy server will be outlined. A viewing and listening request transmitted by the client includes viewing and listening initialization (a content identifier is designated), viewing and listening start (a position in the content is designated, e.g. designating how many seconds after reproduction starts), viewing and listening pause and viewing and listening end. At the time of viewing and listening, the client first transmits a viewing and listening request for “viewing and listening initialization” to the stream proxy server to set up a connection between the stream proxy server and the client for streaming service of contents designated by a content identifier in the request. The client thereafter views and listens to the contents using a viewing and listening request for “viewing start” (by which an arbitrary start position and a streaming rate can be designated) or “viewing pause” (temporarily pause) and when finishing viewing and listening, notifies the stream proxy server of the end of viewing and listening using a viewing and listening request for “viewing and listening end”.

FIG. 36 shows a timing chart of typical content viewing and listening using the above-described viewing and listening request. In the example of FIG. 36, assume that the client starts viewing and listening to the contents from the beginning and ends with viewing and listening after viewing the contents to the end. In addition, a leading part (0 sec to Ta sec) of the requested contents and a middle part of the contents (Tb sec to Tc sec) are held by the stream proxy server.

FIG. 37 shows a position of contents held by the stream proxy server in this example. A time difference between a position (streaming position) at which transmission to the client is currently made and a position at which a first position of the remaining contents which are not stored in the storage unit is transmitted will be referred to as a stream buffer margin (or buffer margin) for viewing and listening (or for a client as a target). In a case, for example, where as to certain contents, a part stored in the storage unit is as indicated in FIG. 37, when the current streaming position is T1, the stream buffer margin is Ta−T1 sec and when the current streaming position is T2, the stream buffer margin is zero second.

FIG. 36 shows how the stream proxy server streams contents by streaming to the client while obtaining other part (Ta to Tb sec and Tc to Td sec) of the requested contents than that it holds. In the following, the operation will be described. At XT-10 in FIG. 36, the client sends a request for “viewing and listening initialization” to the proxy server to set up a connection for streaming between the client and the stream proxy server. Next, at XT-20, the client sends a viewing and listening request for “viewing and listening start” (to start from the beginning (zero second), with streaming rate (Kbps etc.) also designated), so that a content switch starts streaming at the designated position (zero sec) of the contents in question held in the storage unit (XT-30). In addition, for obtaining other part of the contents than that held, set up a connection with the origin server (XT-40) and issue an acquisition request (XT-50). Then, start obtaining the following content part from the server (XT-60). Acquisition is conducted as long as a capacity of the storage unit allows and the acquired part will be stored in the storage unit. When the requested acquisition is completed (XT-65), if there exists a part that is not held following the current streaming position, further issue an acquisition request (XT-70). While obtaining the contents from the origin server (XT-63 and XT-73), the stream proxy server reads the contents held in the storage device to stream the contents to the client by streaming. At this time, when the contents are yet to be obtained (when the stream buffer margin becomes zero second), until acquisition is completed (until the stream buffer margin has a positive value), streaming is temporarily interrupted to cause the client irregular skip of viewing and listening (picture breaks or voice breaks), which is degradation in viewing and listening quality. When finishing obtaining all the contents, the client sends the viewing and listening request for “viewing and listening end” (XT-110) and the stream proxy server responsively cuts off the connection with the server (XT-120).

Next, description will be made of how the streaming control unit 201, the prefetch control unit 202, the storage unit 204 and the transport layer control unit 205 operate in the timing chart of FIG. 36. Upon receiving the viewing and listening request from the client, the streaming control unit 201, in a case where the request is for “viewing and listening end”, pauses streaming to notify the prefetch control unit of the identifier of the relevant contents and that the request is for the end of viewing and listening. In a case of “viewing and listening initialization”, search for the relevant content in the storage unit 204 to obtain an address in the storage unit. When no relevant content is found, instruct the prefetch control unit 202 to ensure a storage region in the storage unit 204 and have an address in the storage unit notified. In addition, notify the prefetch control unit 202 that the request is for “viewing and listening initialization” and of the identifier of the contents. In a case of “viewing and listening start”, when a designated viewing and listening start position is within the storage unit, conduct operation of adjusting the top of the streaming to a designated position. In addition, notify the prefetch control unit that the request is for “viewing and listening start”. Thereafter, read the contents from the storage unit to conduct streaming. When acquisition from the origin server fails to be in time and a part of the contents to be read fails to exist in the storage unit (when the buffer margin becomes 0 second), the contents of the relevant part will not be streamed, so that viewing and listening seems to be irregularly skipped (image breaks or voice breaks) to the client. In addition, the streaming control unit 201 also returns a current viewing and listening position and a current content streaming rate in response to a request from the prefetch control unit 202.

Upon receiving the notification of “viewing and listening end” from the streaming control unit, the prefetch control unit 202 cuts off the connection with the origin server with respect to the contents in question. In a case of “viewing and listening initialization”, instruct the transport layer control unit 205 to conduct processing of setting up a connection with the origin server for the contents in question. In addition, in a case of “viewing and listening initialization”, when the relevant contents fail to exist in the storage unit, ensure a storage region and notify its address to the streaming control unit. In a case of “viewing and listening start”, obtain a part of the contents following the viewing and listening start position which fails to exist in the storage unit from the origin server through the transport layer control unit and write the contents into the storage unit as long as the capacity of the storage unit allows. When there remains no capacity in the storage unit, conduct operation of deleting a part of the contents whose streaming is already finished to free the capacity.

While the conventional stream proxy server obtains a part of the contents that it fails to have from the origin server upon start of viewing and listening by the client, as to acquisition of a part following the current streaming position (which operation will be hereinafter referred to as “prefetch”), actual streaming to the client is made at a time when the streaming position reaches there and therefore has a low degree of urgency. On the other hand, traffic flowing through the network in general includes contents whose degree of urgency is high and prefetch therefore should have lower priority than that of such traffic. In a case, for example, of FIG. 27, in which the link 700 is used also for the communication between the networks 500 and 600, since the conventional stream proxy server takes no degree of congestion of the link 700 into consideration, when the link congests due to the communication between the networks 500 and 600, the link 700 will be further congested by traffic caused by prefetch.

In addition, at the conventional stream proxy server, a rate of obtaining contents from the origin server is not controlled and a data transmission rate obtained by a transport layer protocol is taken as a content acquisition rate. Therefore, in a case where a plurality of contents are being obtained from the origin server through the same bottleneck, when the bottleneck temporarily congests to make a free band of the bottleneck have a value lower than a total of streaming rates, a content acquisition band can not be preferentially assigned to contents having a small stream buffer margin, resulting in that it is highly probable that the stream buffer margin will reach zero to generate viewing and listening whose quality is degraded.

Assume, for example, that with stream proxy service provided for two of content viewing and listening of the same streaming rate, prefetch is conducted for each viewing and listening from the origin server through the same bottleneck. Assume in this case that the bottleneck temporarily congests to have a free band of the bottleneck usable for content acquisition equivalent to one streaming rate. Also assume that buffer margins of the two of the viewing and listening at this time are one second and 100 seconds, respectively. Since in the conventional stream proxy server, free bands are evenly streamed by two prefetch, each content acquisition will be made from the origin server at a rate half the streaming rate. As a result, the stream buffer margin of one viewing and listening becomes zero after two seconds to degrade viewing and listening quality. If acquisition from the origin server is temporarily paused for viewing and listening having 100 seconds of a stream buffer margin and a band for acquisition from the origin server is assigned to viewing and listening having a stream buffer margin of one second, time before the stream buffer margin of either of the viewing and listening becomes zero can be increased to eliminate the temporal congestion before that time, so that degradation in quality of viewing and listening by a client can be avoided, which, however, can not be realized by a conventional stream proxy server.

It is not possible to determine an acquisition rate dependently on other factors (client who is viewing and listening or contents viewed and listened to) than a buffer margin either. It is therefore impossible to set an acquisition rate for a specific client or content to be high to prevent quality of viewing and listening by the client and that of contents from degrading.

### SUMMARY OF THE INVENTION

A first object of the present invention is to provide a proxy server and a proxy control program which realize acquisition of contents from an origin server with effects on other traffic flowing through a network mitigated as much as possible.

A second object of the present invention is to provide a proxy server and a proxy control program which enable a probability of degradation in viewing and listening quality to be reduced as much as possible by controlling a rate of obtaining contents from an origin server and controlling band assignment among contents sharing the same bottleneck.

A third object of the present invention is to provide a proxy server and a proxy control program which enable a probability of degradation in viewing and listening quality to be minimized for viewing and listening with high priority by controlling a rate of content acquisition from an origin server.

According to one aspect of the invention, a proxy server, with a part or all of contents stored in a storage device, for streaming the contents from the storage device to a client, while obtaining a part of the contents not held from an origin server and adding the part to the storage device, which controls a rate of content acquisition from the origin server according to at least either network conditions or conditions of a reception buffer of the contents.

According to another aspect of the invention, a proxy server, with a part or all of contents stored in a storage device, for streaming the contents from the storage device to a client, while obtaining a part of the contents not held from an origin server and adding the part to the storage device, which selects a protocol for use in obtaining contents from the origin server from among a plurality of protocols having different band sharing characteristics according to at least either network conditions or conditions of a reception buffer of the contents.

In the preferred construction, the proxy server obtains contents from the origin server by using a protocol having a flow control function and realizes the control of the rate of content acquisition from the origin server by the control of a rate of reading contents from the reception buffer of the protocol.

In another preferred construction, the proxy server selects a protocol for use in obtaining contents from the origin server from among a plurality of kinds of protocols having a flow control function and different band sharing characteristics according to at least either network conditions or conditions of the reception buffer of the contents and realizes the control of the rate of content acquisition from the origin server by the control of a rate of reading contents from the reception buffer of the protocol.

In another preferred construction, the proxy server realizes the control of the rate of content acquisition from the origin server by instructing the origin server on a transmission rate.

In another preferred construction, the proxy server realizes content acquisition from the origin server by selecting a protocol for use in obtaining contents from among a plurality of kinds of protocols having different band sharing characteristics according to at least either network conditions or conditions of the reception buffer of the contents and realizing the control of the rate of content acquisition from the origin server by instructing the origin server on a transmission rate.

In another preferred construction, the proxy server determines the rate of content acquisition from the origin server also taking priority set for the contents or client into consideration.

According to another aspect of the invention, a proxy server, with a part of contents accumulated in a buffer, for streaming the contents from the buffer to a client, while obtaining a part of the contents following a current position of accumulation of the contents in the buffer from an origin server and adding the part to the buffer, which detects

the remainder of time of the contents accumulated in the buffer and obtains the content part following the current position of accumulation of the content in question in the buffer from the origin server at the timing when the remainder of time attains a value equal to or below a threshold value.

In the preferred construction, the proxy server, with priority given to acquisitions of the following content parts, makes adjustment to prevent a band use width of a bottlenecking link from exceeding a reference value by canceling acquisition whose the priority is low.

In another preferred construction, the proxy server sets the priority based on a difference between a position of content viewing and listening by the client and the accumulation position in the buffer.

In another preferred construction, the proxy server sets the priority for at least any of each origin server in which the contents are accumulated, each client to which the contents are streamed and each content to be obtained.

According to another aspect of the invention, a proxy server, with a part of contents accumulated in a buffer, for streaming the contents from the buffer to a client, while obtaining a part of the contents following a current position of accumulation of the contents in the buffer from an origin server and adding the part to the buffer, which obtains

the content part following the current position of accumulation of the content in question in the buffer from the origin server by predicting that the remainder of time of contents accumulated in the buffer will attain a value equal to or below a threshold value at designated time.

In the preferred construction, the proxy server obtains a content part following the current position of accumulation of the content in question in the buffer from the origin server such that at designated time, the remainder of time of the contents accumulated in the buffer exceeds a designated value by selectively using a plurality of data transmission and reception means having different communication speeds.

In another preferred construction, the proxy server uses protocols having preferential control as a plurality of data transmission and reception means having different communication speeds.

In another preferred construction, the proxy server selectively uses different transport layer protocols as a plurality of data transmission and reception means having different communication speeds.

In another preferred construction, the proxy server dynamically updates a threshold value for determining timing of obtaining a content part following the current position of accumulation of the content in question in the buffer from the origin server according to a change of congestion conditions of a network connected with the origin server.

According to another aspect of the invention, a proxy server, with a part or all of contents stored in a storage device, for streaming the contents from the storage device to a client, while obtaining a part of the contents not held from an origin server and adding the part to the storage device, which selects

a protocol having a transmission rate control function for use in obtaining contents from the origin server from among a plurality of protocols having different band sharing characteristics according to at least either network conditions or conditions of a reception buffer.

In the preferred construction, the proxy server obtains contents from the origin server by using a protocol having a flow control function and a transmission rate control function and realizes the control of the rate of content acquisition from the origin server by the control of a rate of reading contents from the reception buffer of the protocol having the flow control and transmission rate control functions.

In another preferred construction, the proxy server selects a protocol having a transmission rate control function for use in obtaining contents from the origin server from among a plurality of kinds of protocols having a flow control function and different band sharing characteristics according to at least either network conditions or conditions of the reception buffer and realizes the control of the rate of content acquisition from the origin server by the control of a rate of reading contents from the reception buffer of the protocol having the transmission rate control function.

In another preferred construction, the proxy server selects a protocol for use in obtaining contents from the origin server from among a plurality of kinds of protocols having different band sharing characteristics and a transmission rate control function according to at least either network conditions or conditions of the reception buffer and realizes the control of the rate of content acquisition from the origin server by instructing a transmission rate to the origin server.

In another preferred construction, the proxy server uses as conditions of the reception buffer, a difference between a buffer margin set as a target and a current buffer margin.

In another preferred construction, the proxy server changes the buffer margin set as a target according to network conditions.

In another preferred construction, the proxy server simultaneously executes a plurality of prefetchs for contents as the same streaming targets.

In another preferred construction, the proxy server, in prefetchs for contents as the same streaming targets, simultaneously executes the prefetchs as a plurality of requests for different parts.

In another preferred construction, the proxy server simultaneously executes a plurality of prefetchs for contents as the same streaming targets within a range which invites no network congestion.

In another preferred construction, the proxy server, in prefetchs for contents as the same streaming targets, simultaneously executes the prefetchs as a plurality of requests for different parts within a range which invites no network congestion.

According to a further aspect of the invention, a proxy control program executed on a computer, with a part or all of contents stored in a storage device, for streaming the contents from the storage device to a client, while obtaining a part of the contents not held from an origin server and adding the part to the storage device, which has

a function of controlling a rate of content acquisition from the origin server according to at least either network conditions or conditions of a reception buffer of the contents.

According to a further aspect of the invention, a proxy control program executed on a computer, with a part or all of contents stored in a storage device, for streaming the contents from the storage device to a client, while obtaining a part of the contents not held from an origin server and adding the part to the storage device, which has

a function of selecting a protocol for use in obtaining contents from the origin server from among a plurality of protocols having different band sharing characteristics according to at least either network conditions or conditions of a reception buffer of the contents.

According to a further aspect of the invention, a proxy control program executed on a computer, with a part of contents accumulated in a buffer, for streaming the contents from the buffer to a client, while obtaining a part of the contents following a current position of accumulation of the contents in the buffer from an origin server and adding the part to the buffer, which has

a function of detecting the remainder of time of the contents accumulated in the buffer and obtaining the content part following the current position of accumulation of the content in question in the buffer from the origin server at timing when the remainder of time attains a value equal to or below a threshold value.

According to a further aspect of the invention, a proxy control program executed on a computer, with a part of contents accumulated in a buffer, for streaming the contents from the buffer to a client, while obtaining a part of the contents following a current position of accumulation of the contents in the buffer from an origin server and adding the part to the buffer, which has

a function of obtaining the content part following the current position of accumulation of the content in question in the buffer from the origin server by predicting that the remainder of time of the contents accumulated in the buffer will attain a value equal to or below a threshold value at designated time.

According to a still further aspect of the invention, a proxy control program executed on a computer, with a part or all of contents stored in a storage device, for streaming the contents from the storage device to a client, while obtaining a part of the contents not held from an origin server and adding the part to the storage device, which has

a function of selecting a protocol having a transmission rate control function for use in obtaining contents from the origin server from among a plurality of protocols having different band sharing characteristics according to at least either network conditions or conditions of a reception buffer.

According to the present invention, a network information acquisition means collects information of a residual band of a network, an acquisition rate determination means determines a rate of acquisition from an origin server based on the residual band and a reception rate control means or a means for instructing the origin server on a content transmission rate obtains contents at the determined acquisition rate, thereby realizing acquisition of contents from the origin server with effects on other traffic flowing through the network reduced, which is the first object of the present invention.

In addition, by means of a transport layer protocol determination means, the network determines a transport layer protocol which has little effect on other traffic flowing through the network among a plurality of transport layer protocols having different band sharing characteristics and conducts content acquisition by means of a transport layer protocol control means capable of transmitting and receiving data using a plurality of transport layer protocols having different band sharing characteristics, thereby enabling acquisition of contents from the origin server with effects on other traffic flowing through the network reduced, which is the first object of the present invention.

Moreover, a buffer margin measuring means obtains a size of a buffer margin of each content to determine a rate of acquisition from the origin server based on the obtained margin and the reception rate control means or the means for instructing the origin server on a content transmission rate conducts content acquisition at the determined rate, thereby enabling a stream proxy server to control a rate of obtaining contents from the origin server and adjust bands among contents sharing the same bottleneck to reduce a probability of occurrence of viewing and listening quality degradation, which is the second object of the present invention.

Furthermore, a means for determining an acquisition rate taking designated priority into consideration determines a rate of acquisition from the origin server taking designated priority into consideration to assign a higher acquisition rate to viewing and listening having high priority and the reception rate control means or the means for instructing the origin server on a content transmission rate conducts content acquisition at the determined acquisition rate, thereby enabling the stream proxy server to reduce a probability of occurrence of degradation in viewing and listening quality in viewing and listening having high priority according to the designated priority, which is the third object of the present invention.

In addition, by means of a prefetch means for sending a content acquisition request from the origin server based on a buffer margin, excessive sending of a prefetch request can be suppressed and by means of a prefetch control means for requesting acquisition of contents as a partial content fragment, contents can be time-divisionally obtained, so that content acquisition from the origin server can be realized with effects on other traffic flowing through the network reduced, which is the first object of the present invention.

Suppression of execution of an acquisition request having a good buffer margin by means of the network information acquisition means, a means for determining priority among acquisition requests to be simultaneously executed and a means for canceling a request being executed based on priority enables the stream proxy server to suppress a rate of content acquisition from the origin server and adjust bands among contents sharing the same bottleneck, thereby reducing a probability of occurrence of degradation in viewing and listening quality, which is the second object of the present invention.

By means of a means for determining priority based on a size of a buffer margin and the means for canceling a request being executed based on the determined priority, execution of an acquisition request having a good buffer margin is suppressed to enable the stream proxy server to suppress a rate of obtaining contents from the origin server and adjust bands among contents sharing the same bottleneck, thereby reducing a probability of occurrence of degradation in viewing and listening quality, which is the second object of the present invention.

A means for determining priority by the origin server accumulating contents to be obtained by a request enables prioritization based on the origin server accumulating the contents and the means for canceling a request being executed based on the determined priority suppresses execution of an acquisition request having a good buffer margin, thereby enabling the stream proxy server to reduce a probability of occurrence of degradation in viewing and listening quality in viewing and listening having high priority according to designated priority, which is the third object of the present invention.

A means for determining priority by a client to which data of a content fragment acquired by a request is streamed enables prioritization based on the client as a target of streaming and the means for canceling a request being executed based on the determined priority suppresses execution of an acquisition request having a good buffer margin, thereby allowing the stream proxy server to reduce a probability of occurrence of degradation in viewing and listening quality in viewing and listening having high priority according to the designated priority, which is the third embodiment of the present invention.

A means for determining priority by requested contents enables prioritization based on the contents and the means for canceling a request being executed based on the determined priority suppresses execution of an acquisition request having a good buffer margin, thereby allowing the stream proxy server to reduce a probability of occurrence of degradation in viewing and listening quality in viewing and listening having high priority according to the designated priority, which is the third embodiment of the present invention.

A prefetch control means for predicting a change of a buffer margin and when a buffer margin is likely to be short in the near future, sending a subsequent content fragment acquisition request enables adjustment of bands among requests having a wider margin, thereby enabling the stream proxy server to reduce a probability of occurrence of viewing and listening quality degradation by controlling a rate of obtaining contents from the origin server to adjust bands among contents sharing the same bottleneck, which is the second object of the present invention.

A means for executing subsequent content fragment acquisition by selectively using a plurality of data transmission and reception means having different communication speeds increases a probability of selecting acquisition with network congestion suppressed, thereby enabling the stream proxy server to reduce a probability of occurrence of viewing and listening quality degradation by controlling a rate of content acquisition from the origin server to adjust bands among contents sharing the same bottleneck, which is the second object of the present invention.

With a means for using network layer protocols having priority control as the plurality of data transmission and reception means having different communication speeds for the purpose of acquiring subsequent content fragments, adopting such an existing protocol as Diffserv enables with relative ease the stream proxy server to reduce a probability of occurrence of degradation in viewing and listening quality by suppressing a rate of content acquisition from the origin server to adjust bands among contents sharing the same bottleneck, which is the second object of the present invention.

With a means for executing acquisition of subsequent content fragments by selectively using different transport layer protocols as the plurality of data transmission and reception means having different communication speeds, selective use of existing protocols such as TCP Reno and TCP Vegas enables with relative ease the stream proxy server to reduce a probability of occurrence of degradation in viewing and listening quality by suppressing a rate of content acquisition from the origin server to adjust bands among contents sharing the same bottleneck, which is the second object of the present invention.

With a means for adjusting an interval of sending a subsequent content fragment request according to network conditions, adjustment of traffic caused by prefetch according to network congestion conditions to suppress network congestion enables with relative ease the stream proxy server to reduce a probability of occurrence of degradation in viewing and listening quality by suppressing a rate of content acquisition from the origin server to adjust bands among contents sharing the same bottleneck, which is the second object of the present invention.

With a means for simultaneously executing a plurality of prefetchs for the same streaming target and a means for determining an appropriate number of requests to be simultaneously executed inviting no network congestion and controlling the number of requests to be simultaneously executed, even when an effective band allowed for one acquisition request to obtain data is limited, by simultaneously executing a plurality of acquisition requests targeting one client, active acquisition making the best of a free band can be realized to enable a buffer margin to be ensured which is good enough for more clients to maintain streaming quality.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a diagram showing a network structure using a stream proxy server according to a first embodiment of the present invention;

FIG. 2 is a block diagram showing an internal structure of the stream proxy server according to the first embodiment of the present invention;

FIG. 3 is a flow chart showing operation of a prefetch control unit of the stream proxy server according to the first embodiment of the present invention;

FIG. 4 is a flow chart showing operation of the prefetch control unit of the stream proxy server according to the first embodiment of the present invention;

FIG. 5 is a flow chart showing operation of the prefetch control unit of the stream proxy server according to the first embodiment of the present invention;

FIG. 6 is a flow chart showing operation of the prefetch control unit of the stream proxy server according to the first embodiment of the present invention;

FIG. 7 is a flow chart showing operation of the prefetch control unit of the stream proxy server according to the first embodiment of the present invention;

FIG. 8 is a diagram for use in explaining a method of determining a desired rate according to the present invention;

FIG. 9 is a timing chart for use in explaining operation of the stream proxy server according to the first embodiment of the present invention;

FIG. 10 is a diagram for use in explaining a stream fragment held by the stream proxy server according to the first embodiment of the present invention;

FIG. 11 is a diagram showing a network structure using a stream proxy server according to a second embodiment of the present invention;

FIG. 12 is a block diagram showing an internal structure of the stream proxy server according to the second embodiment of the present invention;

FIG. 13 is a flow chart showing operation of a prefetch control unit of the stream proxy server according to the second embodiment of the present invention;

FIG. 14 is a flow chart showing operation of the prefetch control unit of the stream proxy server according to the second embodiment of the present invention;

FIG. 15 is a flow chart showing operation of the prefetch control unit of the stream proxy server according to the second embodiment of the present invention;

FIG. 16 is a flow chart showing operation of the prefetch control unit of the stream proxy server according to the second embodiment of the present invention;

FIG. 17 is a flow chart showing operation of the prefetch control unit of the stream proxy server according to the second embodiment of the present invention;

FIG. 18 is a timing chart for use in explaining operation of the stream proxy server according to the second embodiment of the present invention;

FIG. 19 is a diagram for use in explaining a stream fragment held by the stream proxy server according to the second embodiment of the present invention;

FIG. 20 is a block diagram showing an internal structure of a stream proxy server according to a third embodiment of the present invention;

FIG. 21 is a block diagram showing an internal structure of a stream proxy server according to a fourth embodiment of the present invention;

FIG. 22 is a diagram showing a structure indicative of network connection conditions according to fifth and sixth embodiments of the present invention;

FIG. 23 is a block diagram showing an internal structure of a stream proxy server according to the fifth embodiment of the present invention;

FIG. 24 is a flow chart showing operation of a prefetch control unit of the stream proxy server according to the fifth embodiment of the present invention;

FIG. 25 is a diagram for use in explaining a method of calculating a range of requested content fragments in the fifth embodiment of the present invention;

FIG. 26 is a block diagram showing an internal structure of a stream proxy server according to the sixth embodiment of the present invention;

FIG. 27 is a flow chart showing operation of a prefetch control unit of the stream proxy server according to the sixth embodiment of the present invention;

FIG. 28 is a flow chart showing operation of a prefetch control unit of a stream proxy server according to an eighth embodiment of the present invention;

FIG. 29 is a flow chart showing operation of a prefetch control unit of a stream proxy server according to a ninth embodiment of the present invention;

FIG. 30 is a flow chart showing operation of down-classing/cancellation candidate selection conducted by the prefetch control unit of the stream proxy server according to the ninth embodiment of the present invention;

FIG. 31 is a flow chart showing operation of a prefetch control unit of a stream proxy server according to a tenth embodiment of the present invention;

FIG. 32 is a flow chart showing operation of a prefetch control unit of a stream proxy server according to a twelfth embodiment of the present invention;

FIG. 33 is a diagram for use in explaining definition of a prospect buffer in the twelfth embodiment of the present invention;

FIG. 34 is a diagram showing a network structure using a conventional stream proxy server;

FIG. 35 is a block diagram showing an internal structure of the conventional stream proxy server;

FIG. 36 is a timing chart for use in explaining operation of the conventional stream proxy server; and

FIG. 37 is a diagram showing a stream fragment held by the conventional stream proxy server.

### DESCRIPTION OF THE PREFERRED EMBODIMENTS

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

(First Embodiment)

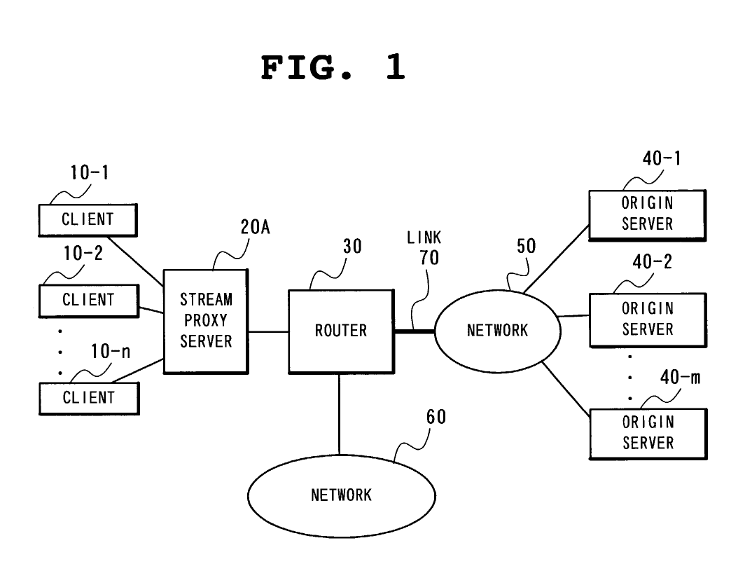

FIG. 1 shows a structure of a first embodiment of the present invention. A stream proxy server 20A provides a number n of clients 10-1 to 10-n with n-stream proxy service related to contents held by a number m of origin servers 40-1 to 40-m. The stream proxy server 20A and the origin servers 40-1 to 40-m are connected to each other via a router 30, a link 70 and a network 50. On the link 70, traffic between the network 50 and a network 60 also flows. Operation of issuing a viewing and listening request conducted by a client is assumed to be equivalent to that described in the Related Art.

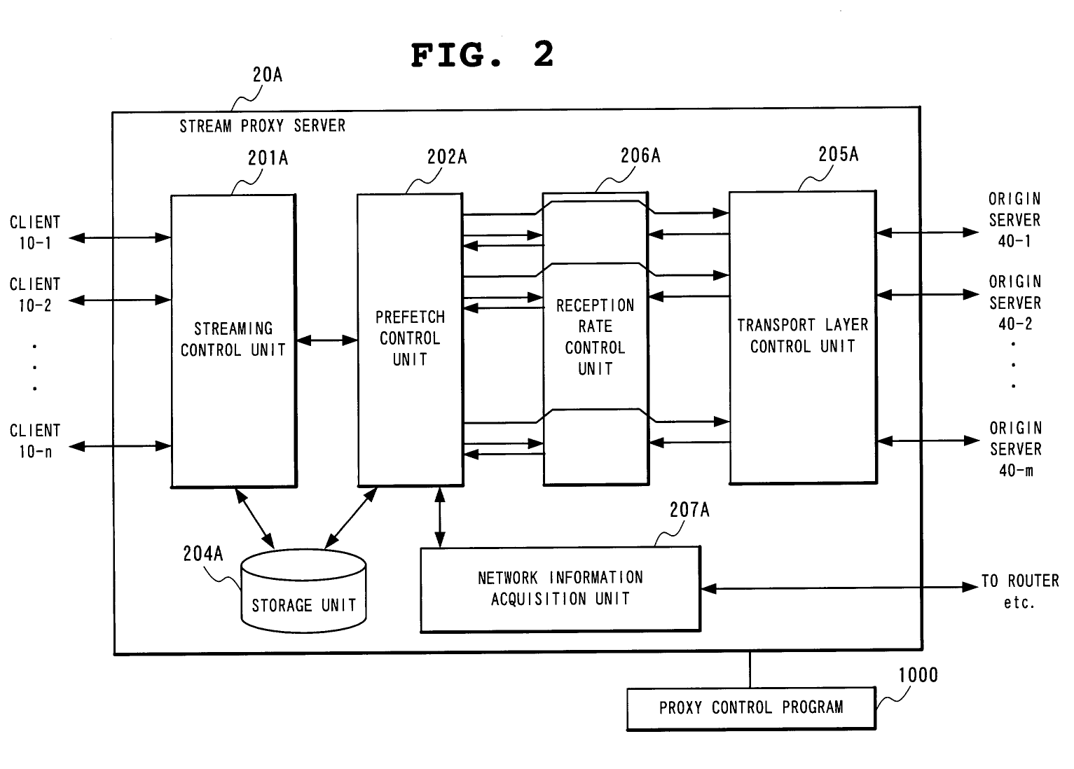

FIG. 2 is a diagram showing an internal structure of the proxy server 20A of the first embodiment of the present invention.

A streaming control unit 201A has a function of receiving a content viewing and listening request from the client, reading contents related to the viewing and listening request from a storage device and streaming the same to the client. The unit also has a function of transferring the viewing and listening request to a prefetch control unit 202A. The unit has a further function of transferring current streaming position and current streaming rate information to the prefetch control unit 202A.

The prefetch control unit 202A receives a viewing and listening request from the streaming control unit 201A and when related to the contents the client wants to view and listen to, a content fragment (all of or a part of the contents) that a storage unit 204A fails to hold exists after a current streaming position, instructs a transport layer control unit to set up a connection with the origin server and issues a content acquisition request (composed of a content identifier and a start position and an end position of each content fragment to be obtained) to the transport layer control unit. The unit also instructs a reception rate control unit 206A on a target rate. According to the target rate, the reception rate control unit 206A reads contents from a transport layer control unit 205A. The prefetch control unit 202A also receives the contents read from the transport layer control unit 205A by the reception rate control unit 206A. The received contents are written into the storage unit 204A. The prefetch control unit 202A also determines a position (start position and end position) of a content fragment to be designated by the content acquisition request and a part in the contents to be deleted in the storage unit. Furthermore, a target rate of content acquisition from the origin server is determined based on information about a position of a content fragment held by the storage unit 204A, current streaming position and streaming rate obtained from the streaming control unit 201A and information obtained from a network information acquisition unit 207A. This determination algorithm is referred to as “reception rate determination algorithm”. Detailed description of operation of the prefetch control unit 202A will be made later with reference to the flow chart. “Reception rate determination algorithm” will be also detailed later.

The storage unit 204A holds a part or all of the copy of the contents of the origin server. The unit provides the streaming control unit 201A and the prefetch control unit 202A with an interface for write and read to/from an arbitrary position of a stream and information about which position of a stream is held.

The transport layer control unit 205A is a part for controlling data communication using a transport layer protocol (e.g. TCP (Transport Control Protocol)) having a flow control function. Flow control function is a function of preventing overflow of a reception buffer on a reception side by the receiver's informing a sender of current vacancy conditions of the reception buffer and the sender's adjustment of a transmission rate based on the informed vacancy conditions. TCP, for example, has this function. According to an instruction from the prefetch control unit 202A, the transport layer control unit 205A conducts set-up and cutoff of a connection with the origin server and termination processing of a transport layer necessary for data transmission and reception (when the transport layer is TCP, for example, transmission and reception protocol processing of TCP). The unit also has two interfaces for data write to the prefetch control unit and data read from the reception rate control unit with respect to each connection set up.

The reception rate control unit 206A reads the contents obtained from the origin server from the transport layer control unit 205A according to a target rate designated by the prefetch control unit 202A and transfers the same to the prefetch control unit 202A. Since a transport layer protocol used by the transport layer control unit 205A has a flow control mechanism, when the reception rate control unit 206A limits a data reading rate to a target rate, a rate of data transfer from the origin server will be limited to the reading rate. Based on the principle, by setting the data reading rate to the target rate, the rate of data transfer from the origin server can be controlled to be the target rate or below.

The network information acquisition unit 207A notifies network information (information indicative of the degree of congestion such as congestion information) to the prefetch control unit according to an instruction from the prefetch control unit. The network information is, for example, information indicative of how much the network congests such as current residual band information (residual band information in the direction from the network 50 to the router 30) of the link 70, which can be obtained by collecting, from the router 30 connected to the link 70, the number of reception bytes of the router 30 from the link 70 by using an SNMP (Simple Network Management Protocol) etc. at fixed time intervals, dividing the number of transferred bytes by the fixed time intervals to obtain a use band and subtracting the use band from a physical band of the link 70. At this time, residual band information may be estimated less by multiplying the number of transferred bytes collected using an SNMP etc. by a certain number and subtracting the use band from the physical band of 70. It is also possible to send a test packet to the origin server and measure an RTT (round trip time) to obtain a bottleneck band.

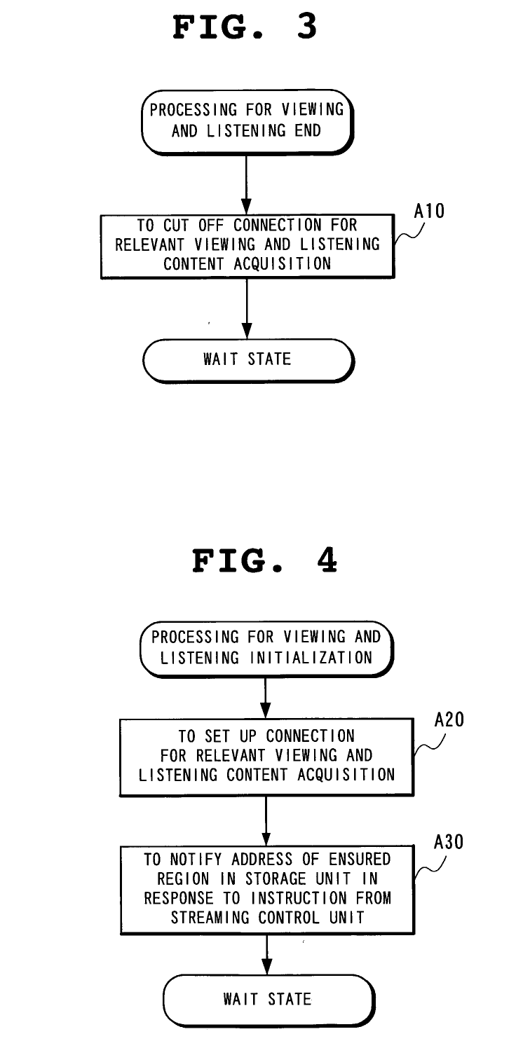

Next, operation of the prefetch control unit 202A will be described with reference to the flow charts of FIGS. 3 to 7.

The prefetch control unit 202A is started at a wait state when time set at a timer not shown (a device which generates a signal when set time elapses) elapses (or when the number set by the counter is counted up) or by a viewing and listening request (viewing and listening end, viewing and listening initialization, viewing and listening start, acquisition completion) from the streaming control unit. In the present embodiment, with predetermined time TO set at a timer T as the time of the timer, the prefetch control unit 202A is started when the timer T indicates 0.

When the viewing and listening request is for “viewing and listening end”, issue an instruction to cut off the connection with the origin server which has the viewing and listening contents in question to the transport layer control unit 205A as shown in FIG. 3 (Step A10).

In a case where the viewing and listening request is for “viewing and listening initialization”, when there exists a content fragment which is not held by the storage unit 204A related to the contents that the client wants to view and listen to, instruct the transport layer control unit to set up a connection with the origin server as shown in FIG. 4 (Step A20). When receiving an instruction from the streaming control unit 201A to ensure a region in the storage unit, ensure the storage region and return its address to the streaming control unit 201A (Step A30).

When the viewing and listening request is for “viewing and listening start”, determine a portion to be obtained from a part of the contents which is located after a position currently viewed and listened to and not held as shown in FIG. 5 (Step A40) and instruct the transport layer control unit on an acquisition request (composed of an identifier of the content and a start position and an end position of each content fragment to be obtained) (Step A50). Also set the timer T to “0” (Step A60) to enable execution of processing of setting a target rate to the contents in question, which is the processing conducted when the timer T indicates “0”.

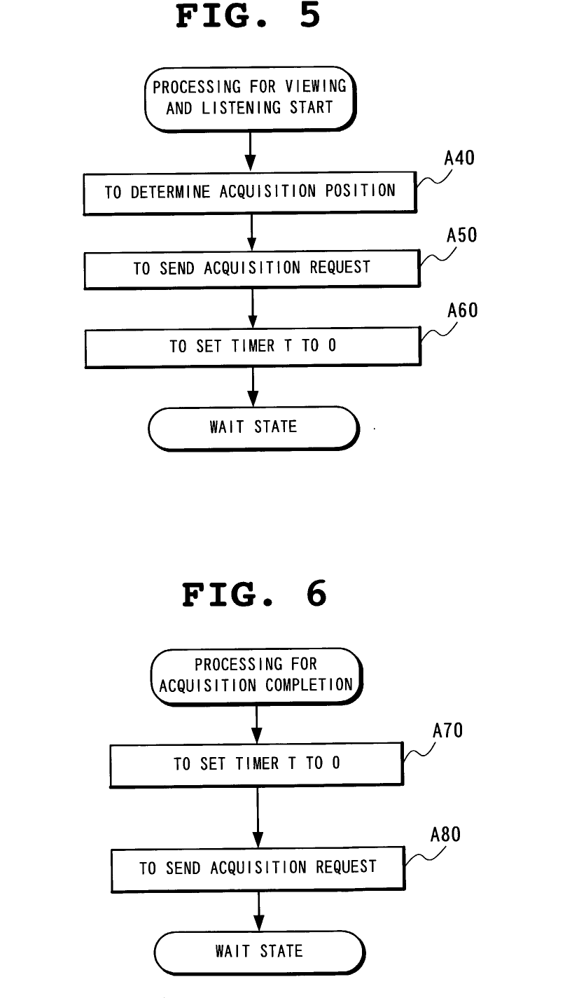

When the viewing and listening request is for “acquisition completion” of a content fragment, set the timer T to “0” (Step A70) to enable execution of the processing of setting a target rate to the contents in question, which is the processing conducted when the timer T indicates “0” as shown in FIG. 6. Then, determine a position of the contents to be obtained next (Step A70) to send an acquisition request (Step A80).

When the timer T indicates “0”, as to all the contents whose acquisition is being made from the origin server, determine a target acquisition rate for the relevant contents based on content fragment position information held by the storage unit 204A, current reproduction position information and viewing and listening rate information obtained from the streaming control unit and information obtained from the network information acquisition unit 207A as shown in FIG. 7 (Step A90). The determination algorithm will be described later. When target rates for all the contents are determined, notify the reception rate control unit 206A of the values (Step A100). Hereafter, the contents obtained by the reception rate control unit 206A are received by the prefetch control unit 202A and written to the storage unit 206A. While executing the writing operation, reset the timer T to a prescribed time “T0” (Step A110) to enter the wait state.

(Reception Rate Determination Algorithm)

Next, a reception rate determination algorithm will be described.

First, the following definition will be made.

(1) Express a set of clients currently conducting viewing and listening (a client who will newly start viewing and listening is not included and a client who will finish viewing and listening is included) as pM={pM₁, pM₂, . . . , pMₘ}.

(2) Express a set of clients obtained by adding a client who will newly start viewing and listening to pM and excluding those who will finish viewing and listening as M={M₁, M₂, . . . , Mₙ}.

(3) Express a streaming rate for the client Mᵢ (i=1, 2, . . . n) at time t as rᵢ(t) bps (bit per second).

(4) Express a stream buffer margin (also called buffer margin) at time t for the viewing and listening by the client Mᵢ (i=1, 2, . . . n) as bᵢ(t) second.

(5) Express a target value of a rate (target rate) at time t for obtaining contents (prefetch) from the origin server for the purpose of the viewing and listening of the client Mᵢ (i=1, 2, . . . , n) as gᵢ(t).

(6) Express an actual acquisition rate for obtaining contents (prefetch) from the origin server at time t for the purpose of the viewing and listening of the client pMᵢ (i=1, 2, . . . , m) as gᵢ*(t).

(7) Express a current target buffer margin for the viewing and listening by the client Mᵢ (i=1, 2, . . . , n) as Thᵢ^{v}(t). Thᵢ^{v}(t) is a buffer margin of a stream proxy server necessary for accommodating a probability of occurrence of reproduction skip at the client within an allowable range. This value may be fixedly given as an experimental value or may be dynamically determined. It may be, for example, a maximum value (e.i. a buffer margin which saves conditions where the buffer margin is the smallest in the past) of a history of integral values of rᵢ(t)−gᵢ*(t) from the start of viewing and listening obtained from a history of a past content acquisition rate gᵢ*(t) and a history of a streaming rate rᵢ(t). Another method can be also used of, when a state of A(t)−P(t)>0 continues at the Step 4 shown below, which means that there remains a spare bottleneck usable band, increasing Thᵢ^{v}(t) and when a state of A(t)−P(t)<0 continues, decreasing Thᵢ^{v}(t) to a certain prescribed value.

(8) Determine sᵢ assuming that related to the viewing and listening by the client Mᵢ (i=1, 2, . . . , n), content acquisition is conducted at si times the current streaming rate when the buffer margin is 0. For example, for all the target contents, it may be uniformly settled to be sᵢ=3 or it may be determined such that sᵢ times the streaming rate is the band of the link 70 (such that when the buffer margin is 0, the entire band of the maximum link 70 can be used).

Step 1: First, assuming that a total of real acquisition rates and the current free band X(t) of the link 70 correspond to a band (usable band) which can be used for obtaining contents from the origin server by the client set M, obtain the band as follows:

$$A ( t ) = X ( t ) + {\sum }_{i ∈ pM} {g}_{i}^{*} ( t )$$

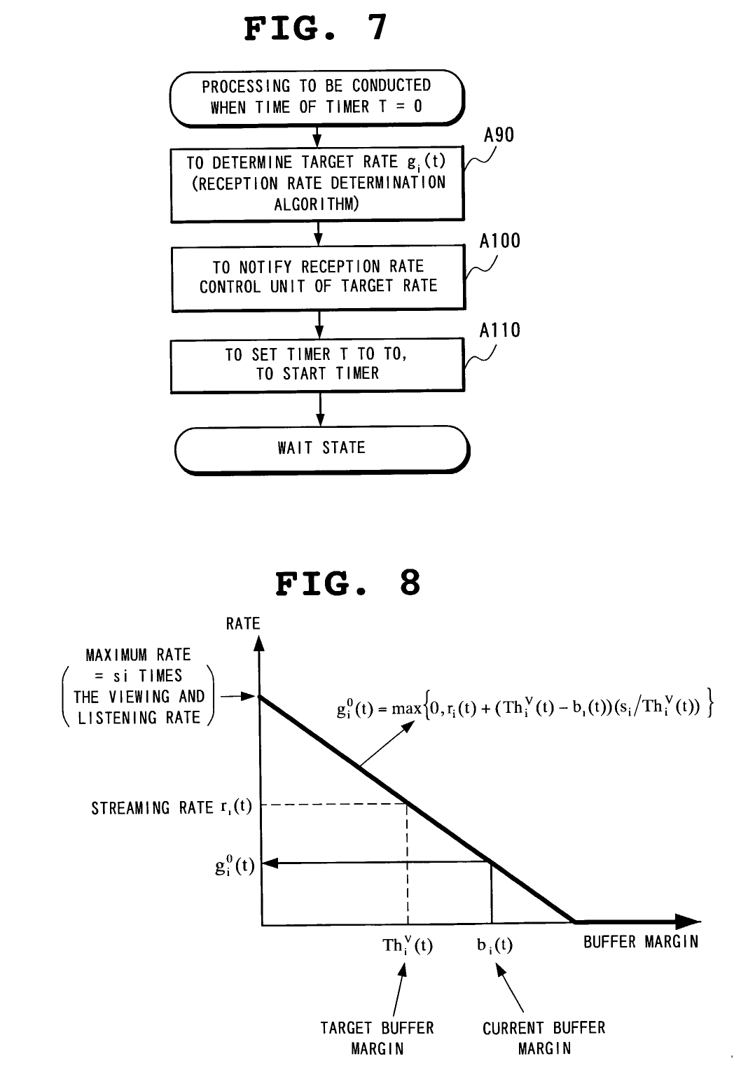

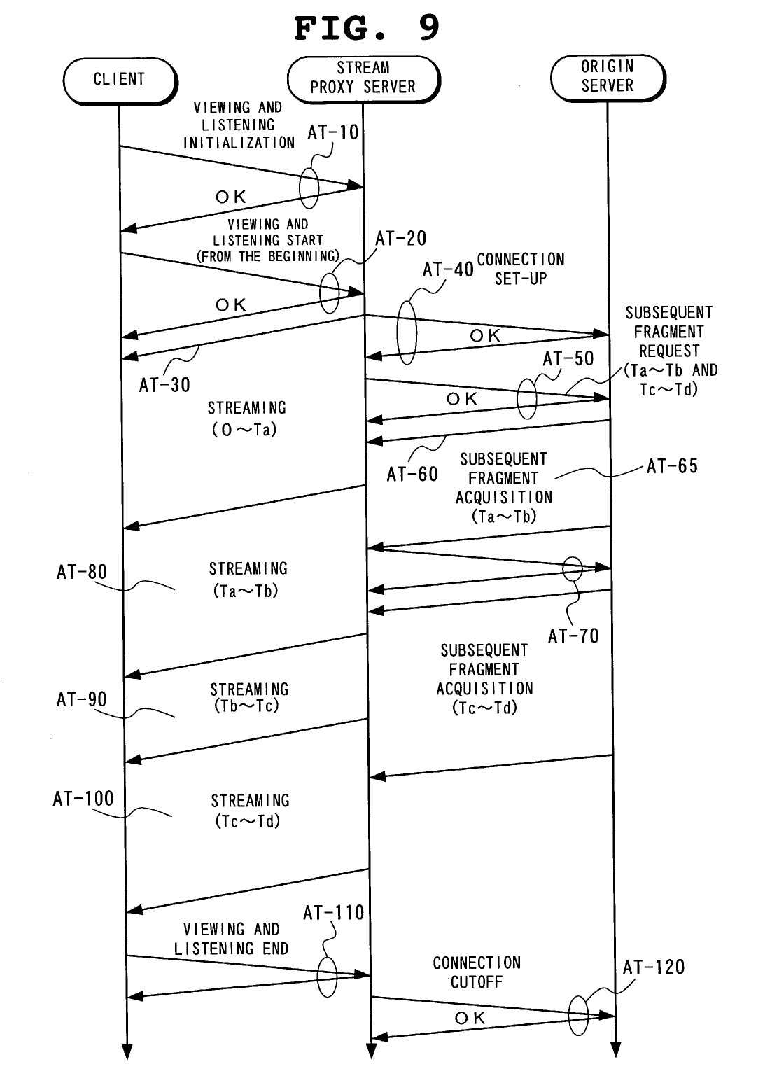

Step 2: As to viewing and listening by each client of the client set M, determine a desired rate gᵢ⁰(t) depending on a current buffer margin. For example, determination is made by calculating gᵢ⁰(t)=max {0, rᵢ(t)+(Thᵢ^{v}(t)−bᵢ(t))(sᵢ/Thᵢ^{v}(t))}. Here, max {a,b} represents a larger one of a and b (see FIG. 8).

Step 3: Obtain the following mathematical expression:

$$P ( t ) = {\sum }_{i = 1}^{n} {g}_{i}^{0} ( t )$$

Step 4: When P(t)≦A(t), end with the target rate gᵢ(t)=gᵢ⁰(t) and otherwise go to Step 5.

Step 5: Consider the target rate gᵢ(t) to be a value obtained by streaming A(t) in proportional to gᵢ⁰(t). End.

The target rate gᵢ(t) may be assigned at Step 5 such that the buffer margin bᵢ(t) is evened as highly as possible. Another method may be employed of sequentially assigning the target rate gᵢ(t) starting with the largest gᵢ⁰(t) within a range where the total of gᵢ(t) fails to exceed A(t) and assigning 0 to that exceeding A(t) as a target rate. More specifically, rearrange gᵢ⁰(t) in descending order to make gᵢ¹(t) and with K as an integer satisfying the following mathematical expression 3, establish the following mathematical expression 4:

$$\begin{matrix}{\sum }_{i = 1}^{K} {g}_{i}^{1} ( t ) \leq A ( t ) , {\sum }_{i = 1}^{K + 1} {g}_{i}^{1} ( t ) > A ( t ) \\ {g}_{i}^{0} ( t ) = {g}_{i}^{1} ( t ) ( i = 1 , 2 , … , K ) , \\ {g}_{K + 1}^{0} ( t ) = A ( t ) - {\sum }_{i = 1}^{K} {g}_{i}^{1} ( t ) , {g}_{i}^{0} ( t ) = 0 ( i = K + 2 , K + 3 , … , n )\end{matrix}$$

A further method may be used of sequentially assigning the target rate gᵢ(t) as gᵢ⁰(t) from A(t) in descending order of priority according to designated priority (priority determined depending on viewing and listening contents and client) set by a manager.

Next, entire operation of the stream proxy server 20A of the first embodiment will be described. Large differences from a conventional stream proxy server are mainly the following points. First, at the time of obtaining contents from the origin server, the prefetch control unit 202A determines a target reception rate based on current reproduction position information and viewing and listening information obtained from the streaming control unit and information obtained from the network information acquisition unit 207A. In addition, by reading data from the transport layer control unit by the reception rate control unit 206A according to the target rate, a rate of data transmission from the origin server to the stream proxy server is suppressed to the target rate.

That viewing and listening requests sent by a client include viewing and listening initialization (content identifier is designated), viewing and listening start (position in the content is designated, e.g. designating how many seconds after reproduction starts), viewing and listening pause and viewing and listening end is the same as that of the conventional stream proxy server. Also the same is operation conducted at the time of viewing and listening and the client first transmits a viewing and listening request for “viewing and listening initialization” to the proxy server to set up a connection between the proxy server and the client for streaming service related to contents designated by a content identifier in the request. The client thereafter views and listens to the contents using a viewing and listening request for “viewing and listening start” (by which an arbitrary start position can be designated) or “viewing and listening pause” (temporary pause) and when finishing viewing and listening, notifies the proxy server by the viewing and listening request for “viewing and listening end” that the viewing and listening will be finished.

FIG. 9 shows a timing chart of typical content viewing and listening.

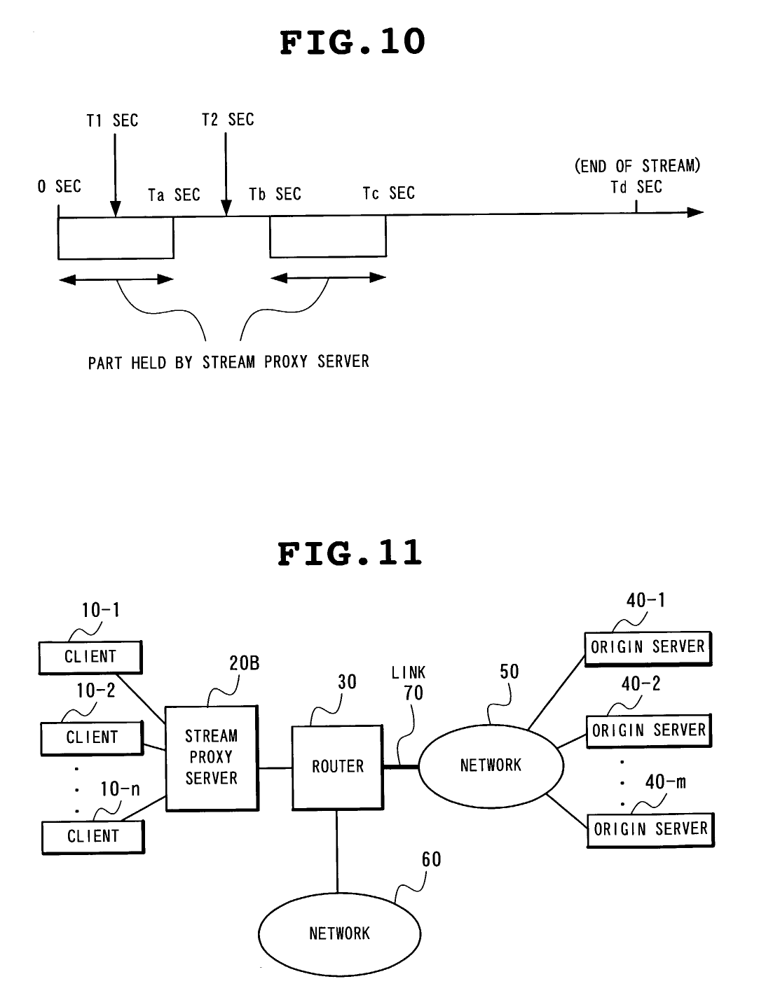

The example shown in FIG. 9 is premised on that the client starts viewing and listening from the beginning of the contents and completes viewing and listening when finishing viewing the contents to the end. In addition, assume that the stream proxy server 20A holds, at the time of the start of viewing and listening, a leading portion (0 sec to Ta sec) of requested contents and a middle portion (Tb sec to Tc sec) of the contents. FIG. 9 shows how streaming to the client is conducted while obtaining other portions (Ta to Tb sec and Tc to Td sec) than those held from the origin server. FIG. 10 shows a position of the contents held by the stream proxy server at the start of viewing and listening in this example.

At AT-10 in FIG. 9, the client sends the request for “viewing and listening initialization” to the proxy server and the server returns an acknowledgement (OK) to set up a connection for the streaming in response to the viewing and listening request between the client and the stream proxy server. Next, at AT-20, the client sends the viewing and listening request for “viewing and listening start” (to be started at 0 sec from the top), so that the stream proxy server starts streaming of the contents starting with the leading portion of the contents in question held in the storage unit (AT-30). The stream proxy server also sets up a connection (AT-40) in order to obtain other part of the contents than those held and issues a request for obtaining a subsequent content portion (AT-50). Then, start obtaining subsequent content fragments from the server (AT-60). Obtained portions will be accumulated in the storage unit. While obtaining the subsequent contents from the origin server (AT-65 and AT-70), the stream proxy server reads the contents held in the storage unit and streams the same to the client. At this time, when the contents are not yet obtained (when the buffer margin is 0 sec), streaming is temporarily interrupted until they are obtained (until the buffer margin has a positive value), whereby viewing and listening seems to be irregularly skipped (image breaks or sound breaks) to the client. Upon finishing obtaining all the contents, the client sends the viewing and listening request for “viewing and listening end” (AT-110) and the stream proxy server responsively cuts off the connection with the server (AT-120).

Next, description will be made how the streaming control unit 201A, the prefetch control unit 202A, the storage unit 204A, the transport layer control unit 205A, the reception rate control unit 206A and the network information acquisition unit 207A operate in the timing chart shown in FIG. 9. Upon receiving a viewing and listening request from the client, the streaming control unit 201A, when the request is for “viewing and listening end”, stops streaming and notifies the prefetch control unit of an identifier of the contents in question and that the request is for viewing and listening end. In a case of “viewing and listening initialization”, the unit 201A searches the storage unit 204A for the relevant contents to obtain an address in the storage unit. When no relevant contents are found, the unit 201A instructs the prefetch control unit 202A to ensure a storage region in the storage unit 204A and have the address in the storage unit notified. The unit 201A also notifies the prefetch control unit 202A that the request is for “viewing and listening initialization” and of the identifier of the contents. In a case of “viewing and listening start”, when a designated viewing and listening start position is in the storage unit, adjust the head of the streaming to the designated position. Also notify the prefetch control unit that the request is for “viewing and listening start”. Thereafter, read the contents from the storage unit and conduct streaming. When acquisition from the origin server is not in time and there is no part of contents to be read in the storage unit (when the buffer margin is 0 sec), the relevant part of the contents will not be streamed, so that viewing and listening seems to be irregularly skipped (image breaks or sound breaks) to the client to degrade viewing and listening quality. The streaming control unit 201A also returns the current viewing and listening position and the current content viewing and listening rate in response to a request from the prefetch control unit 202A.

The prefetch control unit 202A conducts operation according to the above-described flow chart (FIGS. 3 to 7). More specifically, upon receiving a notification of “viewing and listening end” from the streaming control unit, cut off the connection with the origin server related to the contents in question. In a case of “viewing and listening initialization”, instruct the transport layer control unit 205A on the relevant contents to execute processing of setting up a connection with the origin server. In a case of “viewing and listening start”, among the contents located after the viewing and listening start position, obtain a part failing to exist in the storage unit from the origin server through the transport layer control unit and write the same to the storage unit. At this time, when the capacity of the storage unit runs out, delete a part of the contents whose streaming has been already finished or other to free the capacity. Also'as to acquisition, determine a target reception rate according to the reception rate determination algorithm based on network information from the network information acquisition unit 207A, a current rate of delivery and a current streaming position from the streaming control unit 201A, and position information of a content fragment and a history of an actual reception rate of the past in the storage unit 204A and instruct the reception rate control unit 206A on the target reception rate to obtain the contents.

Next, effects of the first embodiment of the present invention will be described.

In the reception rate control algorithm, calculate a sum of a total of current rates of acquisition from the origin server and a free band of the bottleneck obtained from the network information acquisition unit as a usable rate for subsequent acquisition of contents from the origin server at Step 1 and limit a total of target rates to the calculated rate at Steps 4 and 5. In addition, by instructing the reception rate control unit on the target rate determined by the reception rate control algorithm, the rate of acquisition of the content from the origin server is suppressed to be not more than the target rate. The foregoing procedure suppresses the total of actual rates of acquisition of the contents from the origin server to be not more than the free band of the network, so that acquisition of the contents from the origin server can be realized with effects on other traffic (other traffic sharing the bottleneck) in the network suppressed. As a result, the first object of the present invention can be reduced.

In addition, at Step 2 of the reception rate control algorithm, a desired rate of content acquisition (prefetch) from the origin server for each client' viewing and listening is determined such that it becomes higher as the buffer margin becomes smaller and becomes lower as the margin becomes larger. Also at Step 4, when a total of desired rates fails to exceed a usable band, the desired rate is considered as a target rate and when exceeding, since the target band is assumed to be one obtained by proportional division of the usable band by the desired rate at Step 5, among the contents sharing the same bottleneck, a larger band can be assigned to contents having a less buffer margin to enable a probability of occurrence of degradation in viewing and listening quality to be reduced, thereby achieving the second object of the present invention.

Moreover, at Step 5, when congestion occurs, a larger band can be assigned from among usable bands according to designated priority. This enables a probability that degradation in viewing and listening quality will occur in viewing and listening having high priority to be reduced according to designated priority to achieve the third object of the present invention.

(Second Embodiment)

FIG. 11 shows a structure of a second embodiment of the present invention. A stream proxy server 20B provides the number n of clients 10-1 to 10-n with n-stream proxy service related to contents held by the number m of origin servers 40-1 to 40-m. The stream proxy server and the origin servers 40-1 to 40-m are connected to each other via the router 30, the link 70 and the network 50. On the link 70, traffic between the network 50 and the network 60 also flows. Operation conducted by a client for issuing a viewing and listening request is assumed to be the same as that described in the Related Art.

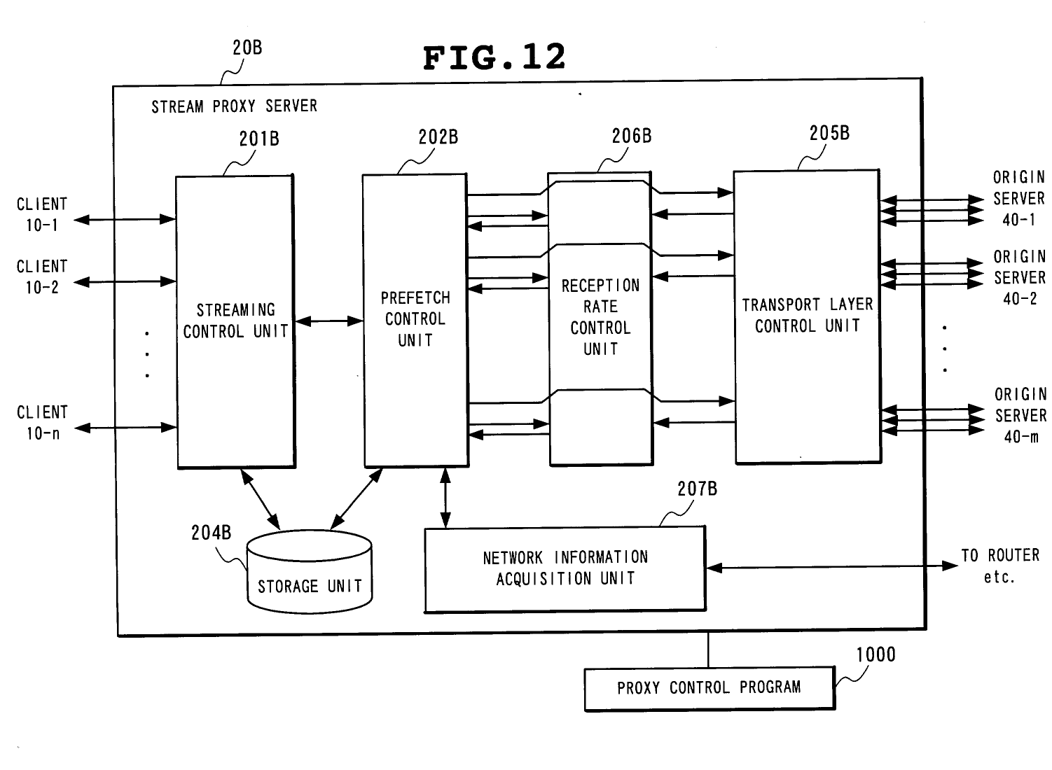

FIG. 12 is a diagram showing an internal structure of the proxy server 20B of the second embodiment of the present invention. A streaming control unit 201B, a storage unit 204B and a network information acquisition unit 207B conduct the same operation as that of the streaming control unit 201A, the storage unit 204A and the network information acquisition unit 207A in the first embodiment of the present invention. Description will be made only of a prefetch control unit 202B, a transport layer control unit 205B and a reception rate control unit whose operation differs from that of the first embodiment of the present invention.

The prefetch control unit 202B receives a viewing and listening request from the streaming control unit 201B and when related to the contents the client wants to view and listen to, a content fragment that a storage unit 204B fails to hold exists after a current streaming position, instructs the transport layer control unit 205B to set up a plurality of connections (each using a transport layer protocol having different band sharing characteristic) with the origin server. Also determine a content acquisition request (composed of a content identifier and a start position and an end position of each content fragment to be obtained) and which connection among the plurality of connections using the transport layer protocols is to be used for the content acquisition (its determination method will be referred to as “transport layer protocol determination algorithm” and described later) and instruct the transport layer control unit 205B on the determination. When there arises a need of switching a transport layer while receiving contents whose acquisition is requested, interrupt the current acquisition and calculate a start position and an end position of a content fragment for obtaining the remaining content fragments based on the amount of data received so far to transfer a subsequent request to the origin server using the connection of the transport layer protocol to be switched. Also instruct a reception rate control unit 206A on a target rate, cause the reception rate control unit 206B to read obtained contents from the transport layer control unit 205B with a speed of reading designated and receive the contents from the reception rate control unit 206B. Write the received contents to the storage unit 204B. Also determine a position (start position and end position) of a content fragment to be designated in the content acquisition request and a part of the contents to be deleted in the storage unit. Furthermore, a target rate of content acquisition from the origin server is determined based on information about a position of a content fragment held by the storage unit 204B, current reproduction position information and viewing and listening rate information obtained from the streaming control unit and information obtained from the network information acquisition unit 207B. This determination algorithm is referred to as “reception rate determination algorithm”. Detailed description of operation of the prefetch control unit 202B will be made later with reference to the flow chart. “Reception rate determination algorithm” will be also detailed later.

The transport layer control unit 205B is a part for controlling data communication using a transport layer protocol (e.g. TCP) having a flow control function. As a transport layer protocol, termination of connections of a plurality of kinds of transport layer protocols having different band sharing characteristics can be conducted. According to an instruction from the prefetch control unit 202B, conduct set-up and cutoff of a connection with the origin server and termination processing of a transport layer necessary for data transmission and reception (when the transport layer is TCP, for example, TCP transmission and reception protocol processing). The unit also has interfaces for data write to the prefetch control unit and data read from the reception rate control unit with respect to each connection set up. Transport layer protocols having different band sharing characteristics include, for example, TCP Reno and TCP Vegas. TCP Vegas is known to have a property of giving a band to TCP Reno when sharing the band with TCP Reno.

The reception rate control unit 206B reads the contents obtained from the origin server from the transport layer control unit 205B according to a target rate designated by the prefetch control unit 202B and transfers the same to the prefetch control unit 202B. Since a transport layer used by the transport layer control unit 205B has a flow control mechanism, when the reception rate control unit limits a data reading rate, a rate of data transfer from the origin server will be limited to the reading rate. This arrangement enables control of a rate of data transfer from the origin server.

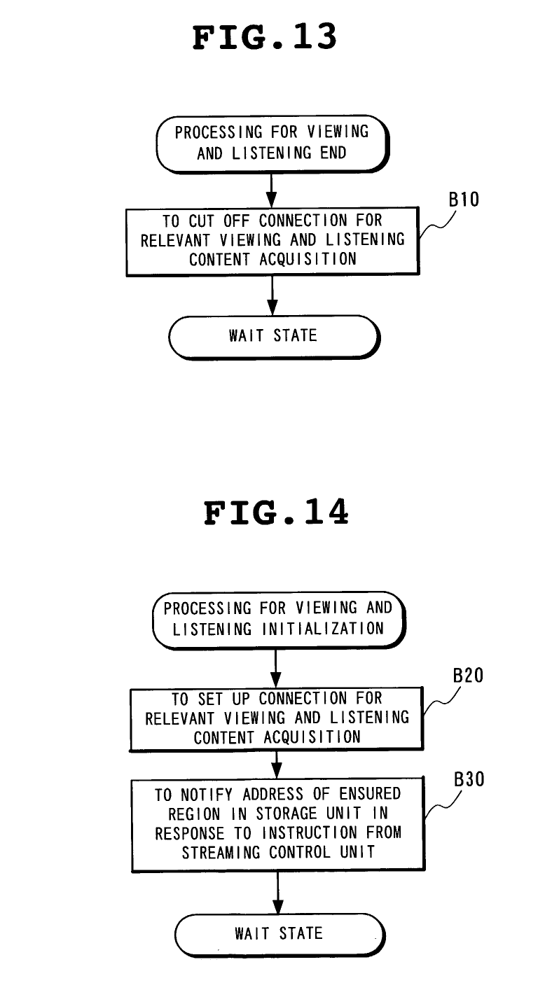

Next, operation of the prefetch control unit 202B will be described with reference to FIG. 8 and the flow charts shown in FIGS. 13 to 17.

(Reception Rate Determination Algorithm)

First, the following definition will be made.

(1) Express a set of clients currently conducting viewing and listening (a client who will newly start viewing and listening is not included and a client who will finish viewing and listening is included) as pM={pM₁, pM₂, . . . pMₘ}.

(2) Express a set of clients obtained by adding a client who will newly start viewing and listening to pM and excluding those who will finish viewing and listening as M={M₁, M₂, . . . , Mₙ}.

(3) Express a streaming rate for the client Mᵢ (i=1, 2, . . . n) at time t as rᵢ(t) bps (bit per second).

(4) Express a stream buffer margin (also called buffer margin) at time t for the viewing and listening by the client Mᵢ (i=1, 2, . . . n) as bᵢ(t) second.

(5) Express a target value of a rate (target rate) at time t for obtaining contents (prefetch) from the origin server for the purpose of the viewing and listening of the client Mᵢ (i=1, 2, . . . , n) as gᵢ(t).

(6) Express an actual acquisition rate for obtaining contents (prefetch) from the origin server at time t for the purpose of the viewing and listening of the client pMᵢ (i=1, 2, . . . , m) as gᵢ*(t).

(7) Express a current target buffer margin for the viewing and listening by the client Mᵢ (i=1, 2, . . . , n) as Thᵢ^{v}(t). Thᵢ^{v}(t) is a buffer margin of the stream proxy server necessary for accommodating a probability of occurrence of reproduction skip at the client within an allowable range. This value may be fixedly given as an experimental value or may be dynamically determined. It may be, for example, a maximum value (e.i. a buffer margin which saves conditions where the buffer margin is the smallest in the past) of a history of integral values of rᵢ(t)−gᵢ*(t) from the start of viewing and listening obtained from a history of a past content acquisition rate gᵢ*(t) and a history of a streaming rate rᵢ(t). Another method can be also used of, when a state of A(t)−P(t)>0 continues at the Step 4 shown below, which means that there remains a spare bottleneck usable band, increasing Thᵢ^{v}(t) and when a state of A(t)−P(t)<0 continues, decreasing Thᵢ^{v}(t) to a certain prescribed value.

(8) Determine sᵢ assuming that related to the viewing and listening by the client Mᵢ (i=1, 2, . . . , n), content acquisition is conducted at sᵢ times the current streaming rate when the buffer margin is 0. For example, for all the target contents, it may be uniformly settled to be sᵢ=3 or it may be determined such that sᵢ times the streaming rate is the band of the link 70 (such that when the buffer margin is 0, the entire band of the maximum link 70 can be used).

Similarly to the first embodiment, the prefetch control unit 202B is started at a wait state when time set at a timer not shown (a device which generates a signal when set time elapses) elapses or by a viewing and listening request (viewing and listening end, viewing and listening initialization, viewing and listening start, acquisition completion) from the streaming control unit.

When the viewing and listening request is for “viewing and listening end”, issue an instruction to cut off the connection with the origin server which has the viewing and listening contents in question to the transport layer control unit 205B as shown in FIG. 13 (Step B10).

In a case where the viewing and listening request is for “viewing and listening initialization”, when there exists a content fragment which is not held by the storage unit 204B related to the contents that the client wants to view and listen to, instruct the transport layer control unit 205B to set up a connection with the origin server as shown in FIG. 14 (Step B20). At this time, connections for a plurality of transport layer protocols having different band sharing characteristics are set up. When receiving an instruction from the streaming control unit 201B to ensure a region in the storage unit 204B, ensure the storage region and return its address to the streaming control unit 201B (Step B30).

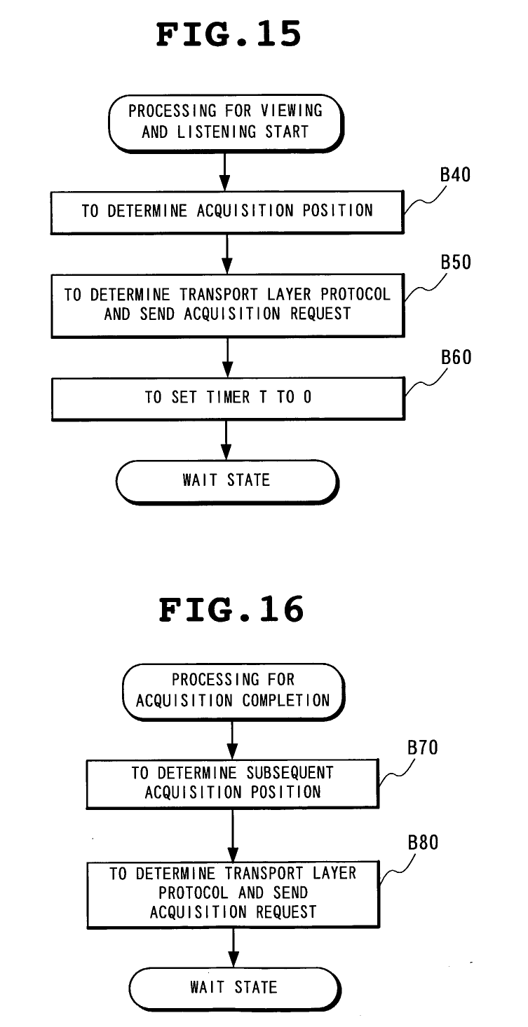

When the viewing and listening request is for “viewing and listening start”, as shown in FIG. 15, determine a position to be obtained from a part of the contents which is located after a position currently viewed and listened to and not held (Step B40), determine a transport layer protocol to be used by the transport layer protocol determination algorithm (which will be described later) and instruct the transport layer control unit 205B on an acquisition request (composed of an identifier of the content and a start position and an end position of each content fragment to be obtained) and the transport layer protocol to be used (Step B50). Also set the timer T to “0” (Step B60) to enable execution of processing of setting a target rate to the contents in question, which is the processing conducted when the timer T indicates “0”.

When the viewing and listening request is for “acquisition completion” of a content fragment, as shown in FIG. 16, determine a position of the contents to be obtained next (Step B70) and determine a transport layer protocol to be used by the transport layer protocol determination algorithm (which will be described later) to instruct the transport layer control unit 205B on the acquisition request (composed of a content identifier and a start position and an end portion of each content fragment to be obtained) and the transport layer protocol to be used (Step B80).

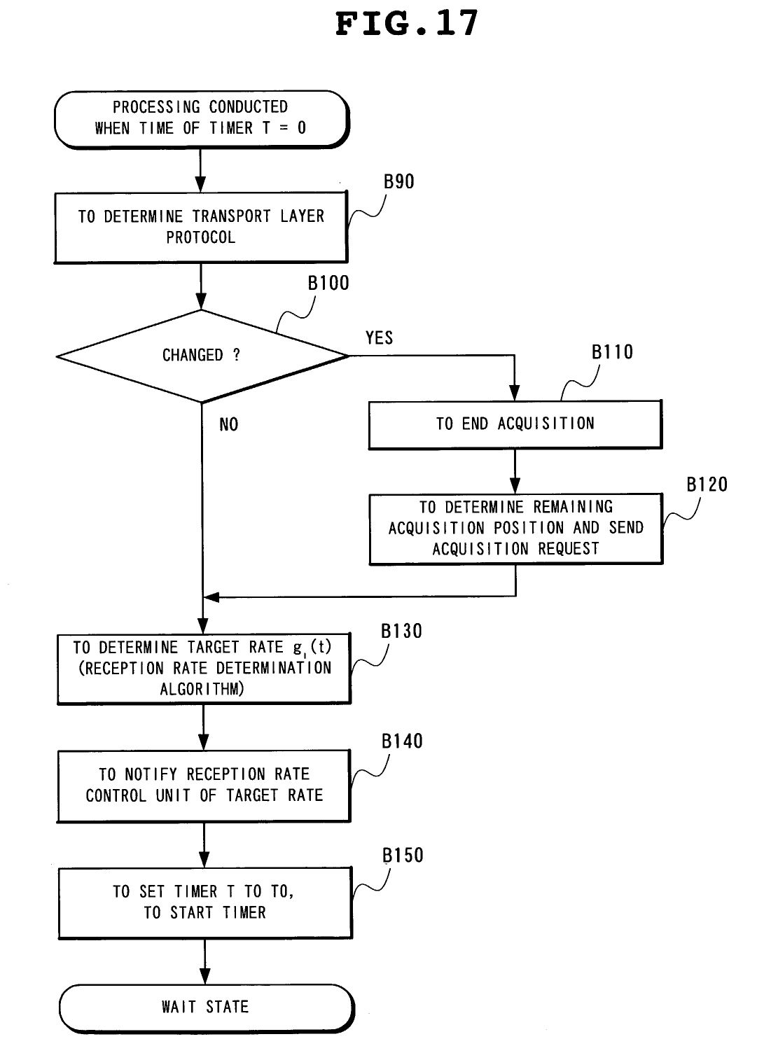

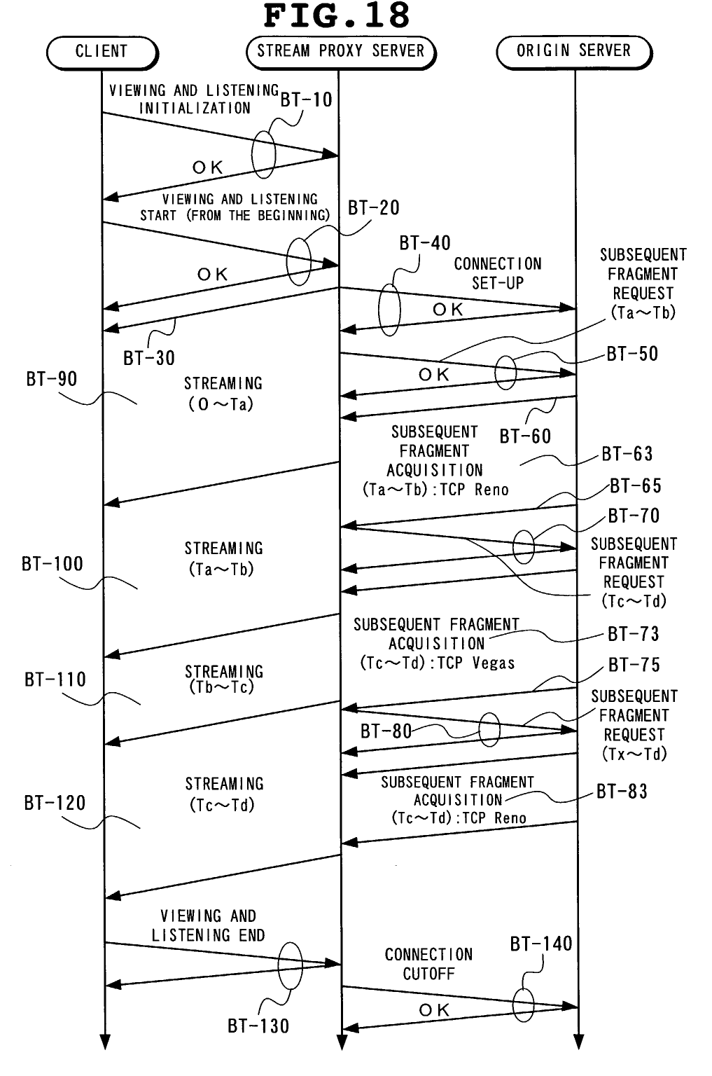

When the timer T indicates “0”, as shown in FIG. 17, as to all the contents whose acquisition is being made from the origin server, determine a transport layer protocol to be used by the transport layer protocol determination algorithm (which will be described later) based on content fragment position information held by the storage unit 204B and information about a current streaming position obtained from the streaming control unit 201B (Step B90). When the transport layer protocol is changed (Step B100), end the current acquisition (Step B110) and determine a position of the remaining content that should have been obtained by the current acquisition request based on a size of the fragment obtained so far to instruct the transport layer control unit 205B on a request for obtaining the remaining contents (composed of a content identifier and a start position and an end position of each content fragment to be obtained) and the transport layer protocol to be used (Step B120).

Next, determine a target acquisition rate for the relevant contents based on information about a position of a content fragment held by the storage unit 204B, current streaming position information obtained from the streaming control unit 201B, information about a current streaming rate obtained from the streaming rate control unit 201B and information obtained from the network information acquisition unit 207A (Step B130). The determination algorithm for a target acquisition rate will be described later. When target rates for all the contents are determined, notify the reception rate control unit 206B of the values (Step B140). When a transport layer is switched at this time, the contents obtained hereafter by the reception rate control unit will be received by the prefetch control unit 202B and written to the storage unit 204B. While executing the writing operation, reset the timer T to the prescribed time “T0” (Step A150) to enter the wait state.

(Transport Layer Protocol Determination Algorithm)

In the following, the above-described transport layer protocol determination algorithm will be described.

Based on the current streaming position obtained from the streaming control unit 201B and the information about which position of a stream is held obtained from the storage unit 204B, obtain a current buffer margin bᵢ(t) and based on the obtained margin and current network conditions obtained from the network information acquisition unit 207B, determine a transport layer protocol to be used. For example, determine two threshold values Thᵢ^{U}(t) and Thᵢ^{M}(t) (assuming that Thᵢ^{U}(t)<Thᵢ^{M}(t)), and when bᵢ(t)<Thᵢ^{U}(t), assume the TCP Reno to be the transport layer and when bᵢ(t)>Thᵢ^{M}(t), assume the TCP Vegas to be the transport layer. In a case where Thᵢ^{U}(t)≦bᵢ(t)≦Thᵢ^{M}(t), when the latest transport layer change is from TCP Reno to TCP Vegas, change the layer to TCP Vegas and when the change is from TCP Vegas to TCP Reno, change the layer to TCP Reno. When no change is made the last time (when switching has never been made), assume the layer to be TCP Vegas, for example. The threshold values Thᵢ^{U}(t) and Thᵢ^{M}(t) can be obtained from the network information acquisition unit. Set the values to be larger when a degree of network congestion varies largely, and set the values to be smaller when a degree of network congestion varies little.

Next, a reception rate determination algorithm will be described (the same as the reception rate algorithm of the first embodiment).

(Reception Rate Determination Algorithm)

Step 1: First, considering that a total of real acquisition rates and the current free band X(t) of the link 70 correspond to a band (usable band) which can be used for obtaining contents from the origin server by the client set M, obtain the band as follows:

$$A ( t ) = X ( t ) + {\sum }_{i ∈ pM} {g}_{i}^{*} ( t )$$

Step 2: As to viewing and listening by each client of the client set M, determine a desired rate gᵢ⁰(t) depending on a current buffer margin. For example, determination is made by calculating gᵢ⁰(t)=max {0, rᵢ(t)+(Thᵢ^{v}(t)−bᵢ(t))(sᵢ/Thᵢ^{v}(t))}. Here, max {a,b} represents a larger one of a and b (see FIG. 8).

Step 3: Obtain the following mathematical expression:

$$P ( t ) = {\sum }_{i = 1}^{n} {g}_{i}^{0} ( t )$$

Step 4: When P(t)≦A(t), end with the target rate gᵢ(t)=gᵢ⁰(t) and otherwise go to Step 5.

Step 5: Consider the target rate gᵢ(t) to be a value obtained by streaming A(t) in proportional to gᵢ⁰(t). End.

The target rate gᵢ(t) may be at Step 5 assigned such that the buffer margin bᵢ(t) is evened as highly as possible. Another method may be employed of sequentially assigning the target rate gᵢ(t) starting with the largest gᵢ⁰(t) within a range where the total of gᵢ(t) fails to exceed A(t) and assigning 0 to that exceeding A(t) as a target rate. More specifically, rearrange gᵢ⁰(t) in descending order to make gᵢ¹(t) and with K as an integer satisfying the following expression 7, establish the following mathematical expression 8:

$$\begin{matrix}{\sum }_{i = 1}^{K} {g}_{i}^{1} ( t ) \leq A ( t ) , {\sum }_{i = 1}^{K + 1} {g}_{i}^{1} ( t ) > A ( t ) \\ {g}_{i}^{0} ( t ) = {g}_{i}^{1} ( t ) ( i = 1 , 2 , … , K ) , \\ {g}_{K + 1}^{0} ( t ) = A ( t ) - {\sum }_{i = 1}^{K} {g}_{i}^{1} ( t ) , {g}_{i}^{0} ( t ) = 0 ( i = K + 2 , K + 3 , … , n )\end{matrix}$$

A further method may be used of sequentially assigning the target rate gᵢ(t) as gᵢ⁰(t) from A(t) in descending order of priority according to designated priority (priority determined depending on viewing and listening contents and client) set by a manager.

Next, entire operation of the stream proxy server 20B of the second embodiment will be described. Large differences from the stream proxy server 20A of the first embodiment are mainly the following points. First, the transport layer control unit has a plurality of connections with the server by using a plurality of transport layer protocols of different band sharing characteristic. Then, at the time of obtaining contents from the origin server, the prefetch control unit 202B changes a transport layer protocol together with a target reception rate based on current reproduction position information and viewing and listening rate information obtained from the streaming control unit and information obtained from the network information acquisition unit 207B.

That viewing and listening requests sent by a client include viewing and listening initialization (content identifier is designated), viewing and listening start (position in the content is designated, e.g. designating how many seconds after reproduction starts), viewing and listening pause and viewing and listening end is the same as that of the conventional stream proxy server. Also the same is operation conducted at the time of viewing and listening and the client first transmits a viewing and listening request for “viewing and listening initialization” to the proxy server to set up a connection between the proxy server and the client for streaming service related to contents designated by a content identifier in the request. The client thereafter views and listens to the contents using a viewing and listening request for “viewing and listening start” (by which an arbitrary start position can be designated) or “viewing and listening pause” (temporary pause) and when finishing the viewing and listening, notifies the proxy server by the viewing and listening request for “viewing and listening end” that the viewing and listening will be finished.

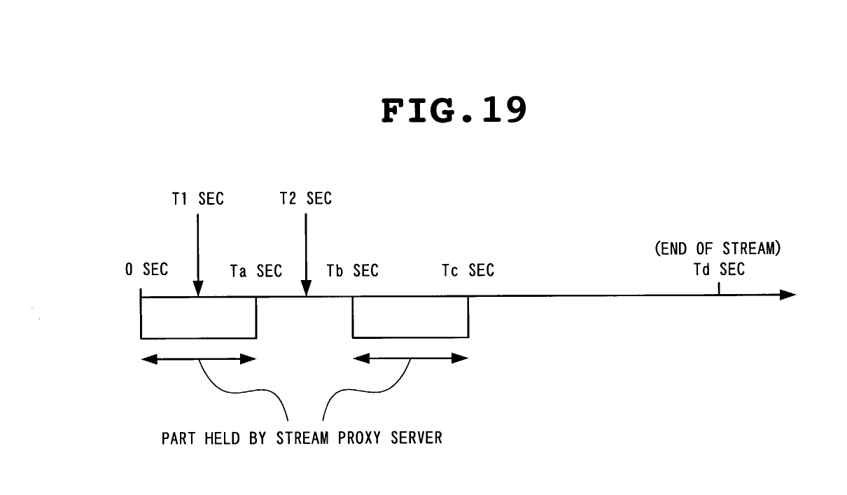

FIG. 18 shows a timing chart of typical content viewing and listening using the above-described viewing and listening requests. The example shown in FIG. 18 is premised on that the client starts viewing and listening from the beginning of the contents and completes viewing and listening when finishing viewing the contents to the end. In addition, as shown in FIG. 19, assume that the stream proxy server holds, at the time of the start of viewing and listening, a leading portion (0 sec to Ta sec) of contents and a middle portion (Tb sec to Tc sec) of the contents. FIG. 18 shows how streaming to the client is conducted while obtaining other portions (Ta to Tb sec and Tc to Td sec) than those held from the origin server.

At BT-10 in FIG. 18, the client sends the request for “viewing and listening initialization” to the proxy server and the server returns an acknowledgement (OK) to set up a connection for the streaming in response to the viewing and listening request between the client and the stream proxy server. Next, at BT-20, the client sends the viewing and listening request for “viewing and listening start” (to be started at 0 sec from the top), so that the content switch starts streaming of the contents starting with the leading portion of the contents in question held in the storage unit (BT-30). Also set up a connection with the origin server (BT-40) in order to obtain other part of the contents than those held and issue a request for obtaining a subsequent content portion (BT-50). Then, start obtaining subsequent content portion from the server (BT-60). Obtained portions will be accumulated in the storage unit. While obtaining the subsequent contents from the origin server and preserving the same in the storage unit 204B, the stream proxy server streams the contents held in the storage unit 204B (BT-90). At this time, when the contents at a position to be streamed are not yet obtained (when the buffer margin is 0 sec), streaming is temporarily interrupted until they are obtained (until the buffer margin has a positive value), whereby viewing and listening seems to be irregularly skipped (image breaks or sound breaks) to the client to degrade viewing and listening quality. Upon finishing obtaining the content fragment (BT-65), the stream proxy server issues the request for obtaining a subsequent content fragment which the server fails to hold and is located after the current streaming position (BT-70). As to content acquisition, a content acquisition rate is controlled by controlling a rate of read from the transport layer by means of the reception rate control unit. A transport layer for obtaining contents is determined according to the transport layer protocol determination algorithm and then used for obtaining contents. In this example, the transport layer protocol of TCP Reno is used for the first following content fragment request (BT-50) and the further following content fragment (time Tc to Td) is obtained using TCP Vegas (BT-73, BT-83), while the transport layer determination protocol makes the determination in the middle (BT-75) that switching to TCP Reno is made. Since the content fragment obtained up to BT-75 corresponds to the part of time Tc to Tx and the current streaming position is prior to Tx, for the still further following content fragment (Tx to Td), a content acquisition request is issued using TCP Reno (BT-80) to conduct content acquisition using TCP Reno (BT-83). Upon finishing obtaining all the contents, the client sends a viewing and listening request for “viewing and listening end” (BT-130) and the stream proxy server responsively cuts off the connection with the server (BT-140).

Next, description will be made how the streaming control unit 201B, the prefetch control unit 202B, the storage unit 204B, the transport layer control unit 205B, the reception rate control unit 206B and the network information acquisition unit 207B operate in the timing chart shown in FIG. 18. Upon receiving a viewing and listening request from the client, the streaming control unit 201B, when the request is for “viewing and listening end”, stops streaming and notifies the prefetch control unit of an identifier of the contents in question and that the request is for viewing and listening end. In a case of “viewing and listening initialization”, search the storage unit 204B for the relevant contents to obtain an address in the storage unit. When no relevant contents are found, instruct the prefetch control unit 202B to ensure a storage region in the storage unit 204B and have the address in the storage unit notified. Also notify the prefetch control unit 202B that the request is for “viewing and listening initialization” and of the identifier of the contents. In a case of “viewing and listening start”, when a designated viewing and listening start position is within the storage unit, adjust the head of the streaming to the designated position. Also notify the prefetch control unit 202B that the request is for “viewing and listening start”. Thereafter, read the contents from the storage unit and conduct streaming. When acquisition from the origin server is not in time and there is no part of contents to be read in the storage unit (when the buffer margin is 0 sec), the relevant part of the contents will not be streamed, so that the viewing and listening seems to be irregularly skipped (image breaks or sound breaks) to the client to degrade the viewing and listening quality. The streaming control unit 201B also returns the current viewing and listening position and the current content viewing and listening rate in response to a request from the prefetch control unit 202B.

The prefetch control unit 202B conducts operation according to the above-described flow chart (Fig. B-3). More specifically, upon receiving a notification of “viewing and listening end” from the streaming control unit, cut off the connection with the origin server related to the contents in question. In a case of “viewing and listening initialization”, instruct the transport layer control unit 205B on the relevant contents to execute processing of setting up a connection with the origin server. In a case of “viewing and listening start”, among the contents located after the viewing and listening start position, obtain a part failing to exist in the storage unit from the origin server through the transport layer control unit 205B and write the same to the storage unit. At this time, when the capacity of the storage unit runs out, delete a part of the contents whose streaming has been already finished or other to free the capacity. Also as to acquisition, determine a target reception rate according to the reception rate determination algorithm based on network information from the network information acquisition unit 207B, a current rate of delivery and a current streaming position from the streaming control unit 201B, and position information of a content fragment and a history of an actual reception rate of the past in the storage unit 204B and instruct the reception rate control unit 206B on the target rate to obtain the contents. Also determine a transport layer protocol for use based on the current streaming position information obtained from the streaming control unit 201B and the current buffer margin calculated based on information about a position at which the current contents from the storage unit 204B is held (according to the transport layer protocol determination algorithm).

Next, effects of the second embodiment of the present invention will be described.

In the reception rate control algorithm, calculate a sum of a total of current rates of acquisition from the origin server and a free band of the bottleneck obtained from the network information acquisition unit as a usable rate for subsequent acquisition of contents from the origin server at Step 1 and limit a total of target rates to the calculated rate at Steps 4 and 5. In addition, by instructing the reception rate control unit on the target rate determined by the reception rate control algorithm, the rate of acquisition of the contents from the origin server is suppressed to be not more than the target rate. The foregoing procedure suppresses the total of actual rates of acquisition of the contents from the origin server to be not more than the free band of the network, so that acquisition of the contents from the origin server can be realized with effects on other traffic (other traffic sharing the bottleneck) in the network reduced. As a result, the first object of the present invention can be achieved.

In addition, when a buffer margin is large, the transport layer determination algorithm employs TCP Vegas to conduct acquisition of contents from the origin server. Under such a condition where other traffic is transmitted by TCP Reno, because TCP Vegas has a property of giving a band to TCP Reno when sharing the band with TCP Reno, at a place where a traffic band for content acquisition is shared with other traffic (e.g. link 70), giving a band to other traffic enables effects on other traffic to be suppressed to achieve the first object of the present invention.

In addition, at Step 2 of the reception rate control algorithm, a desired rate of content acquisition (prefetch) from the origin server for each client' viewing and listening is determined such that it becomes higher as the buffer margin becomes smaller and becomes lower as the margin becomes larger. Also at Step 4, when a total of desired rates fails to exceed a usable band, the desired rate is considered as a target rate and when exceeding, since the target rate is assumed to be one obtained by the proportional division of the usable band by the desired rate at Step 5, among prefetchs sharing the same bottleneck, a larger band can be assigned to that having a less buffer margin to enable a probability of occurrence of degradation in viewing and listening quality to be reduced, thereby achieving the second object of the present invention.

Moreover, at Step 5, when congestion occurs, a larger band can be assigned from among usable bands to specific client and contents whose designated priority is high. This enables a probability that degradation in viewing and listening quality will occur to a specific client or in content to be reduced to achieve the third object of the present invention.

(Third Embodiment)

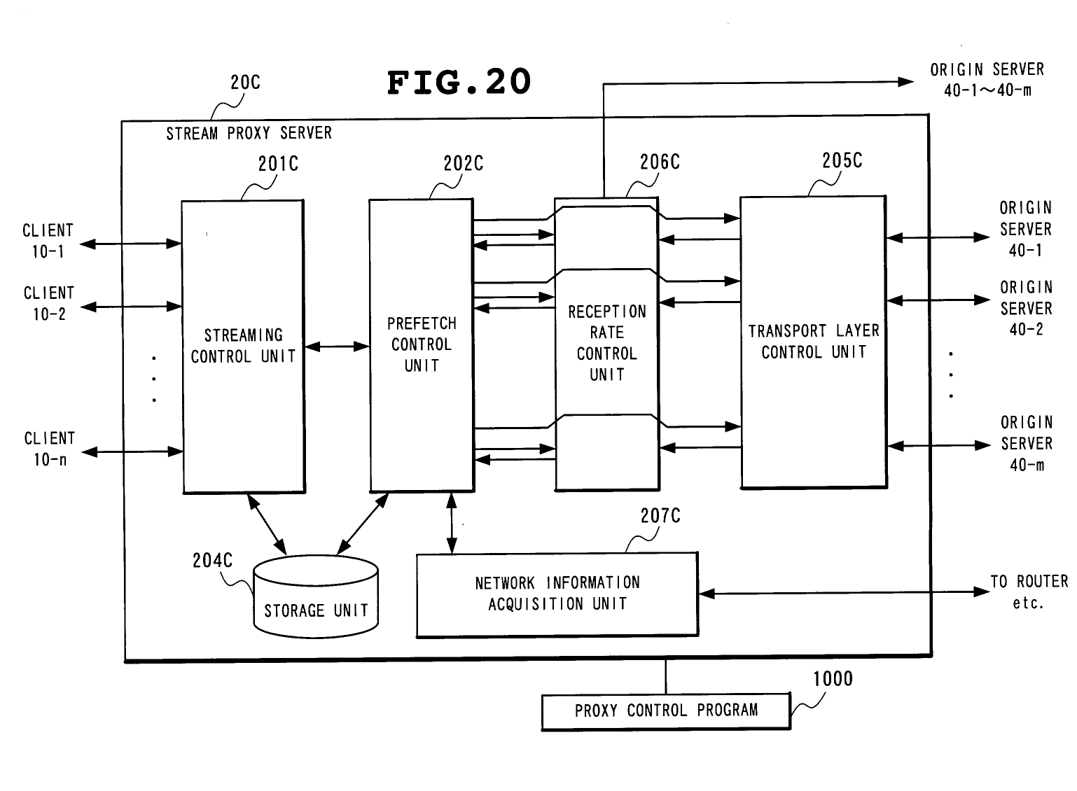

FIG. 20 shows an internal structure of a stream proxy server 20C according to a third embodiment of the present invention.

Although the structure is substantially the same as that of the stream proxy server 20A according to the first embodiment of the present invention, because a method of controlling a rate of content transmission from the server differs, the reception rate control unit 206A is replaced by a reception rate control unit 206C. Another difference is that a transport layer protocol for use by a transport layer control unit 205C needs not to have a flow control function.

Regarding the reception rate control unit 206C, its difference form the reception rate control unit 206A according to the first embodiment of the present invention will be described.

While the reception rate control unit 206A of the first embodiment of the present invention controls a rate of reading contents from the transport layer control unit 205A, the reception rate control unit 206C implicitly designates a transmission rate to the origin server. It is, for example, possible to conduct content acquisition from the origin server by means of the transport layer control unit 205C by using the RTCP protocol and implicitly set a transmission rate by the reception rate control unit 206C for the origin server by using a header field called Speed of the RTCP protocol.

Functions and operation of other components, a streaming control unit 201C, a prefetch control unit 202C, a storage unit 204C, the transport layer control unit 205C and a network information acquisition unit 207C are the same as those of the streaming control unit 201A, the prefetch control unit 202A, the storage unit 204A, the transport layer control unit 205A and the network information acquisition unit 207A of the stream proxy server 20A according to the first embodiment of the present invention and the entire operation is also the same with the only difference being that the reception rate control unit 206C informs the origin server of a target rate instructed by the prefetch control unit 202C and the origin server sets a transmission rate to the target rate.

Next, effects of the third embodiment of the present invention will be described.

In the third embodiment of the present invention, control of a network band for use in obtaining contents from the origin server is implicitly instructed to the origin server. In the first embodiment, the same control is indirectly conducted by suppressing, by the reception rate control unit, a rate of reading contents from the transport layer control unit to realize flow control of a transport layer. The third embodiment enables more accurate control than that realized by the first embodiment, thereby achieving the first, second and third objects of the present invention with higher precision which can be also realized by the first embodiment.

(Fourth Embodiment)

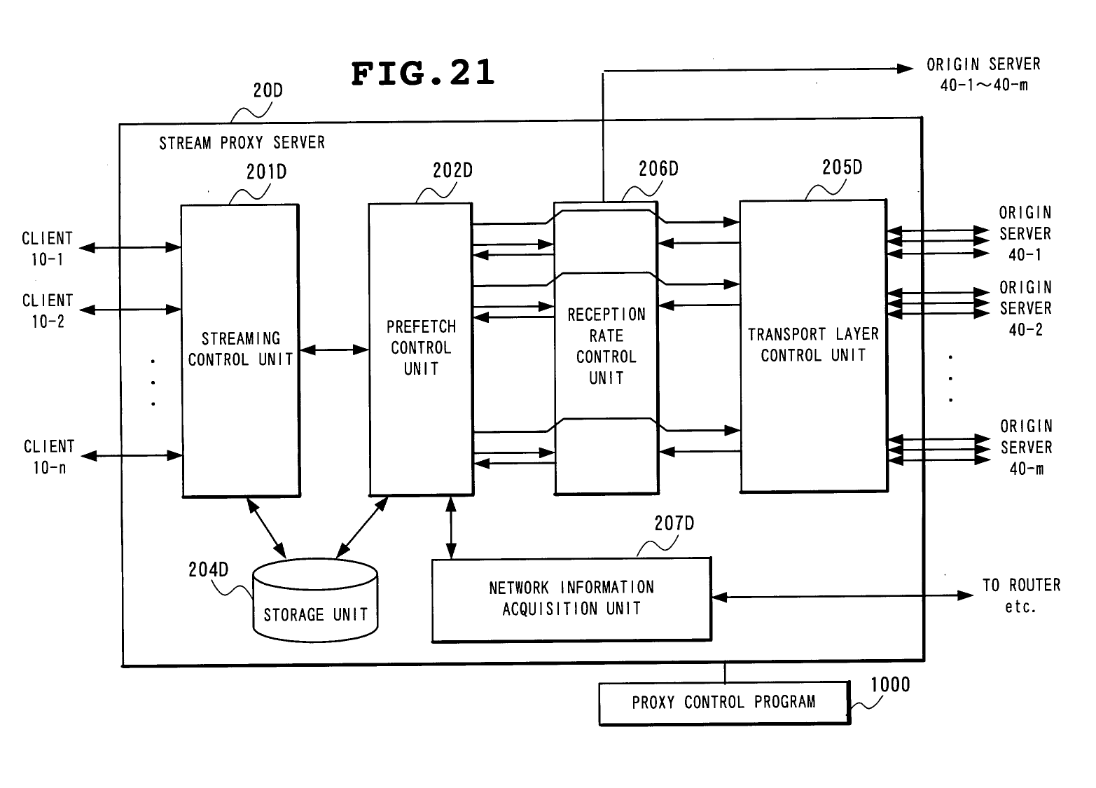

FIG. 21 shows an internal structure of a stream proxy server 20D according to a fourth embodiment of the present invention.

Although the structure is substantially the same as that of the stream proxy server 20B according to the second embodiment of the present invention, because a method of controlling a rate of content transmission from the server differs, the reception rate control unit 206B is replaced by a reception rate control unit 206D. Another difference is that a transport layer protocol for use by a transport layer control unit needs not to have a flow control function.

Regarding the reception rate control unit 206D, its difference form the reception rate control unit 206B according to the second embodiment of the present invention will be described.

While the reception rate control unit 206B of the second embodiment of the present invention controls a rate of reading contents from the transport layer control unit 205B, the reception rate control unit 206D implicitly designates a transmission rate to the origin server. It is, for example, possible to conduct content acquisition from the origin server by means of the transport layer control unit by using the RTCP protocol and implicitly set a transmission rate by the reception rate control unit 206D for the origin server by using a header field called Speed of the RTCP protocol.

Functions and operation of other components, a streaming control unit 201D, a prefetch control unit 202D, a storage unit 204D, a transport layer control unit 205D and a network information acquisition unit 207D are the same as those of the streaming control unit 201B, the prefetch control unit 202B, the storage unit 204B, the transport layer control unit 205B and the network information acquisition unit 207B of the stream proxy server 20B according to the second embodiment of the present invention and the entire operation is also the same with the only difference being that the reception rate control unit 206D informs the origin server of a target rate instructed by the prefetch control unit 202D and the origin server sets a transmission rate to the target rate.

In the fourth embodiment of the present invention, control of a network band for use in obtaining contents from the origin server is implicitly instructed to the origin server. In the second embodiment, the same control is indirectly conducted by suppressing, by the reception rate control unit, a rate of reading contents from the transport layer control unit to realize flow control of a transport layer. The fourth embodiment enables more accurate control and achieves the first, second and third objects of the present invention with higher precision which can be also realized by the second embodiment.

(Fifth Embodiment)

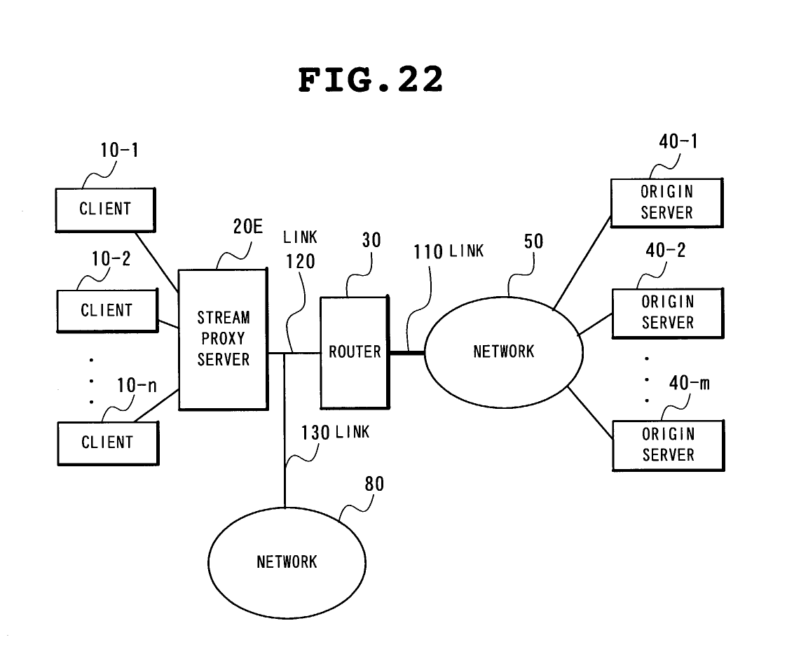

FIG. 22 shows a connection structure of a fifth embodiment of the present invention. A stream proxy server 20E provides the number n of clients 10-1 to 10-n with n-stream proxy streaming related to contents held by the number m of origin servers 40-1 to 40-m. The stream proxy server 20E and the origin servers 40-1 to 40-m are connected to each other though a link 120, the router 30, a link 110 and the network 50. On the router 30, traffic from other network 80 flows through a link 130 and traffic sent and received by the clients 10-1 to 10-n without passing through the stream proxy server 20E also flows.

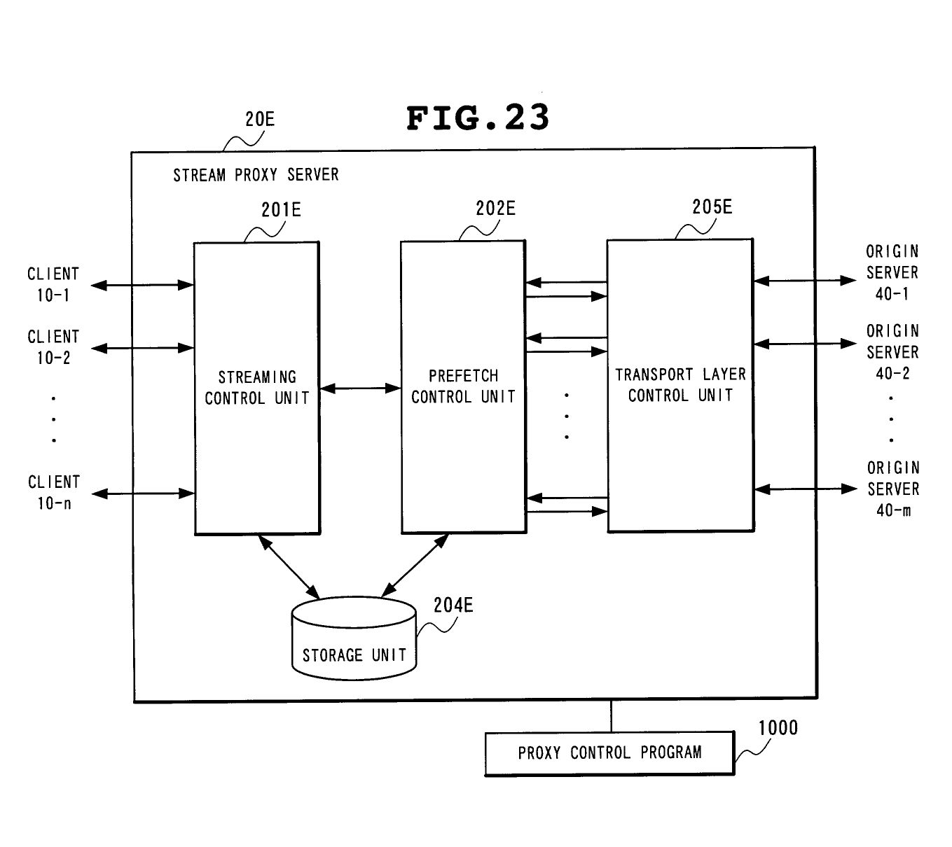

Next, FIG. 23 shows a structure of the stream proxy server of the fifth embodiment of the present invention.

The structure of the present embodiment has nothing different from a conventional structure. Operation as the stream proxy server is substantially the same as that of the conventional example. Only a prefetch control algorithm differs. The fifth embodiment enables limited network bands to be shared as evenly as possible by conducting content fragment acquisition so as not to make a buffer margin be below a reference value to result in accumulating data to be streamed to a client in the stream proxy server all the time and by requesting not all the following data but a minutely divided part of a requested range. Buffer margin, similarly to that of a conventional example, is defined as a difference between a current position of the client's viewing and listening and the final position of a content fragment being viewed and listened to by the client.

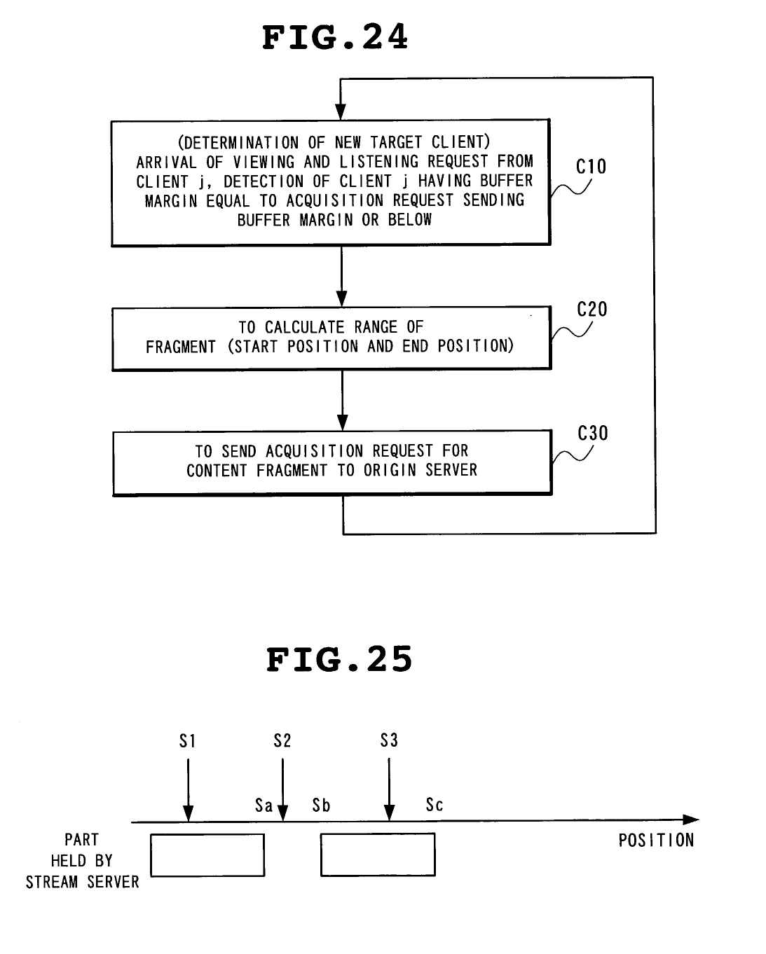

Description will be made of a prefetch control algorithm executed by the prefetch control unit 202E in the present embodiment with reference to the operation flow chart of FIG. 24 and the structural diagram of FIG. 23.

A content prefetch request is generated when a viewing and listening request from the client arrives at the prefetch control unit 202E through the streaming control unit 201E or when a buffer margin of contents being streamed to the client attains a designated threshold (acquisition request sending buffer margin value) or below (Step C10). When data of the contents at the current viewing and listening position is not stored in the storage unit 204E, the margin goes 0. The buffer margin is a value determined by a position of viewing and listening by the client and therefore the value is determined not for each content but for each client. When describing the value, for example, using FIG. 25, assuming that a current viewing and listening position of a client 1 is S1, a viewing and listening position of a client 2 is S2 and a viewing and listening position of a client 3 is S3, a buffer margin of the client 1 will be Sa−S1, a buffer margin of the client 2 will be 0 and a buffer margin of the client 3 will be Sc−Sb.

The present embodiment is premised on that an acquisition request sending buffer margin value is given as a parameter for each client and that an acquisition request sending buffer margin value for a client i is represented as THLi.

Assuming that a buffer margin for the client i at the current time t is bi(t), when bi(t)≦THLi, a subsequent content fragment request will be generated and sent.

The content fragment acquisition request generated upon the buffer margin of the client i having the relationship bi(t)≦THLi is for the prefetch aiming at streaming to the client i. Hereinafter, a content fragment acquisition request aiming at streaming to the client i will be referred to as an acquisition request targeting the client i.

When sending of a content acquisition request targeting the client i is determined, the prefetch control unit 202E determines a range (a start position and an end position) of a content fragment whose prefetch is requested (Step C20). In the present embodiment, a width of a content fragment (difference between a start position and an end position) is assumed to be given as a parameter for each client. A width for the client i is assumed to be given by PFRi. Assume a final position of a content fragment being viewed and listened to by the client i is a start position and a position obtained by adding PFRi to the start position is an end position (a method of dynamically changing PFRi is described as other embodiment). When the content within the range is already held as a content fragment in the storage unit 204E, a range excluding the range in question is requested. Description of the range will be made using FIG. 25. When the viewing and listening position of the client i is S1, the start position is Sa. When Sa+PFRi≦Sb, the end position will be Sa+PFRi and when Sa+PFRi>Sb, it will be Sb because overlap with the content fragment starting at Sb is excluded. When the viewing and listening position is S2, the start position is S2 and when S2+PFRi≦Sb, the end position will be S2+PFRi and when S2+PFRi>Sb, the end position will be Sb because an overlap with the content fragment starting at Sb is excluded. When the viewing and listening position is S3, the start position will be Sc and the end position will be either smaller one of Sc+PFRi and the final part of the contents because no further content fragment exists.

Then, the prefetch control unit 202E instructs the transport layer control unit 205E to send a content acquisition request with the range determined at the preceding step designated to the origin server and receive the content fragment (Step C30). Then, return to Step C10. The transport layer control unit 205E instructed to obtain the content fragment, when no connection exists with the origin server, sets up a connection and when one already exists, reuses the same to execute content fragment acquisition.

The foregoing processing flow is cancelled when the viewing and listening end request from the client i arrives at the prefetch control unit 202E through the streaming control unit 201E. Upon receiving the viewing and listening end request, the prefetch control unit 202E instructs the transport layer control unit 205E to send a request for acquisition cancellation to the origin server. When necessary, also instruct on cut-off of the connection between the origin server and the stream proxy server.

The fifth embodiment of the present invention produces the following effects.

Since prefetch occurs only for contents being viewed and listened to by a client, no band will be wastefully consumed.

Dividing prefetch prevents specific content acquisition from occupying a band for a long period of time.

Content fragment acquisition targeting a client having a good buffer margin can be suppressed. This increases a probability that acquisition of a content fragment targeting a client failing to have a good buffer margin will use a band. As a result, the number of clients whose buffer runs out (buffer margin goes to 0) can be reduced to enable streaming to more clients with stable quality.

(Sixth Embodiment)

The fifth embodiment, however, fails to realize control adapted to network congestion conditions. In a case, for example, where the link 120 congests in FIG. 22, content fragment acquisition targeting a client failing to have a good buffer margin should be preferentially executed and content fragment acquisition targeting a client having a good buffer margin should be suppressed. When a band use rate of a link is low, even with a good buffer margin, content fragment acquisition had better be executed actively as long as a region of a storage unit 204E on the stream proxy server is not constrained. The sixth embodiment therefore introduces a method of adjusting the frequency of sending a content fragment acquisition request according to network congestion conditions.

In a case where it is known that a specific network link portion bottlenecks, it is desirable to pinpoint congestion conditions of the relevant link portion to reflect the obtained information appropriately on the control. Conduct control using information obtained by measuring band use conditions of the bottlenecking link portion.

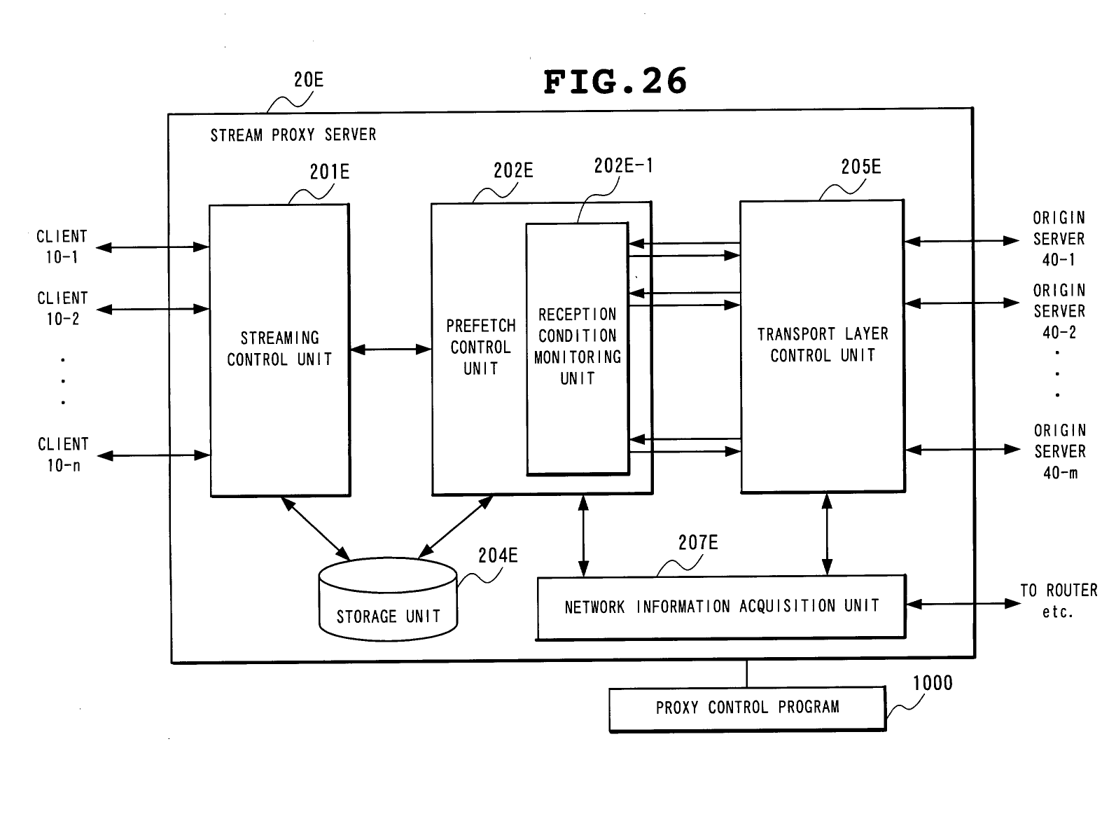

In order to cope with such a case where the bottleneck portion is known as mentioned above, monitor a band use width of the bottlenecking link and monitor an acquisition rate of each connection. For monitoring a band use width of the bottlenecking link, add a network information acquisition unit 207E to the structure of FIG. 23 as illustrated in the structural diagram of FIG. 26. Furthermore, monitor an acquisition rate of each content fragment by means of a reception condition monitoring unit 202E-1. The reception condition monitoring unit 202E-1 measures and stores the following parameters for each connection between the origin server and the stream proxy server:

(1) a round trip time (RTT) from when a content acquisition request is issued until when data of a start position is received, and

(2) a rate of content acquisition from the origin server.

In the present embodiment, a request for obtaining a content fragment by using a bottlenecking link is determined based on a buffer margin. As a result of preferential processing of a request targeting a client having a small buffer margin, no client will have its buffer run out to realize stable streaming. When at the time of sending a new acquisition request, determination is made that a necessary acquisition rate can not be ensured due to congestion of a bottlenecking link, check a buffer margin of a request being executed and when the request being executed has a buffer margin larger than that of the new acquisition request, cancel the execution to ensure a necessary acquisition rate.

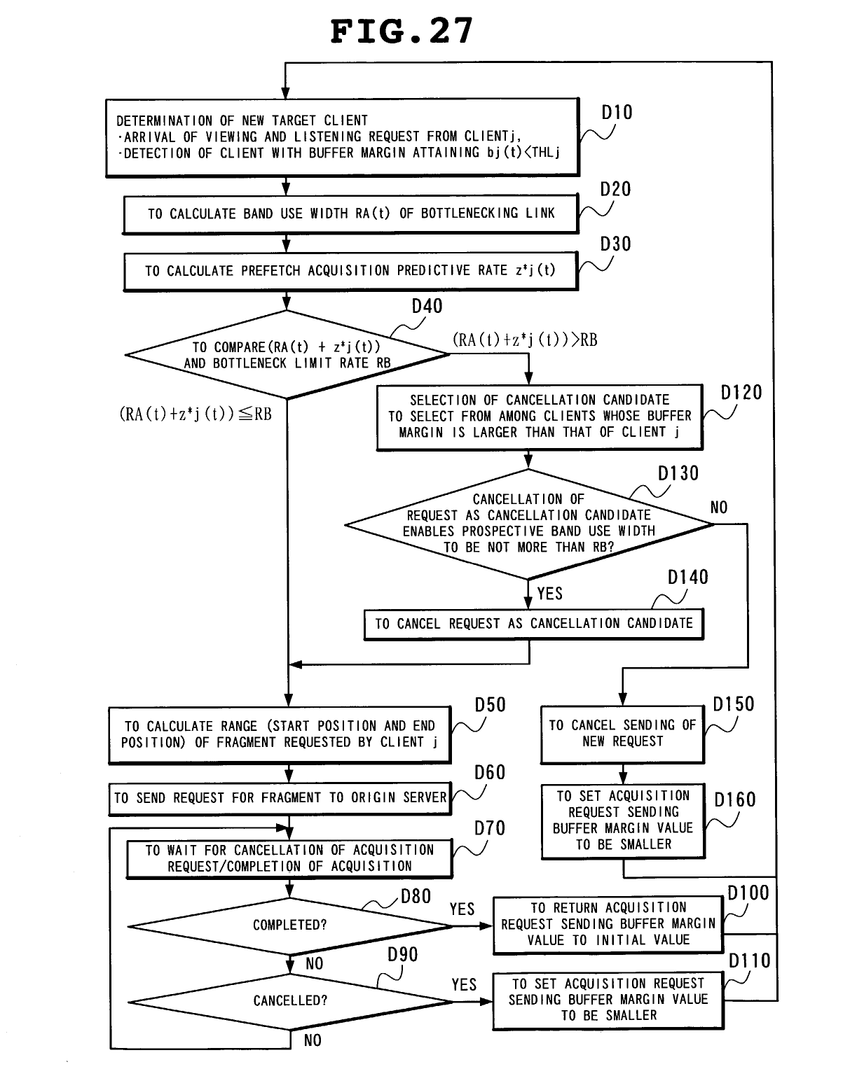

Details of the sixth embodiment will be described with reference to the flow chart of FIG. 27 and the structural diagram of FIG. 26.

Similarly to the fifth embodiment, a content fragment acquisition request is generated when a viewing and listening request from a client arrives at a prefetch control unit 202E through a streaming control unit 201E or when a buffer margin of the client attains a threshold value of an acquisition request sending buffer margin or below. Waiting for either event to occur, the prefetch control unit 202E determines a client j as a target of a new content fragment acquisition request (hereinafter referred to as a new target client) (Step D10). The new content fragment acquisition request will be referred to as a new acquisition request in the following. A buffer margin calculation method is the same as that of the conventional example.

First, the prefetch control unit 202E acquires a band use width RA(t) of the bottlenecking link at the current time t from the network information acquisition unit 207E (Step D20). At this time, which band use width should be measured by the network information acquisition unit 207E will be described with respect to the network structure shown in FIG. 22. When the link 120 connected to a stream proxy server 20E is a bottleneck and the stream proxy server 20E is connected as a transparent cache, the bottleneck band use width will be measured by a transport layer control unit 205E and the network information acquisition unit 207E will inquire of the transport layer control unit 205E. When such a link through which other traffic than that flowing through the stream proxy server 20E also flows as the link 110 is a bottleneck, for example, in a case of FIG. 22, a band use width is measured by the router 30. By inquiring of the router 30 by using SNMP or the like, the network information acquisition unit 207E is allowed to know a current band use width of the bottleneck.

An acquisition rate of each content fragment is measured by the reception condition monitoring unit 202E-1. Express a content fragment acquisition rate targeting the client j at time t as rj(t).

Next, execute a new acquisition request and an acquisition rate at the time of receiving a content fragment from the origin server by the stream proxy server is estimated by the prefetch control unit 202E (Step D30). This will be referred to as a prefetch acquisition predictive rate and expressed as z*j(t). When a part of contents requested by the new acquisition request has a history of being already accumulated in the storage unit 204E as a content fragment, the reception condition monitoring unit 202E-1 stores the then acquisition rate. By the then rate, z*j(t) can be approximated. It is also possible to obtain such information as a mean viewing and listening rate and a peak viewing and listening rate at the time of viewing and listening contents by a client as meta data of the contents or the like by the prefetch control unit 202E from the origin server and set the values as a prefetch predictive rate z*j(t).

Next, the prefetch control unit 202E determines whether bottlenecking link congests or not when the new acquisition request is sent (Step D40). More specifically, with z*j(t) as a prefetch predictive acquisition rate and RA(t) as a bottleneck band use width, determination is made based on whether a prospective band use width RA(t)+z*j(t) exceeds a threshold value RB or not when a request is newly sent. As the threshold value RB (bottleneck limit rate), a bandwidth of a bottlenecking link may be designated or 80% the value of the band width may be designated for the safety's sake. When a means for obtaining an effective bandwidth is available, the value may be dynamically set to be an effective band obtained by the means.

When the prospective band use width RA(t)+z*j(t) is not more than the bottleneck limit rate RB, the prefetch control unit 202E calculates a range of a content fragment whose acquisition is requested (Step D50). Method of calculating a content fragment range is the same as that of the fifth embodiment.

Then, the prefetch control unit 202E instructs the transport layer control unit 205E to send a content acquisition request with the range determined at the preceding step designated to the origin server and receive the content fragment (Step D60). The transport layer control unit 205E instructed to obtain the content fragment, when no connection exists with the origin server, sets up a connection and when it already exists, reuses the same to execute content fragment acquisition.

Then, after sending the content fragment acquisition request, the prefetch control unit 202E waits for any of the following events to occur (Step D70).

More specifically, the events are completion of an acquisition request targeting the client j (Step D80) and cancellation of the acquisition request targeting the client j (Step D90).

When the event of the completion of the acquisition request arrives from the transport layer control unit 205E (Step D80), the prefetch control unit 202E returns the acquisition request sending buffer margin value THLj to an initial value (Step D100). Then, return to Step D10.

When detecting cancellation of the acquisition request (Step D90), the prefetch control unit 202E sets the acquisition request sending buffer margin value THLj to be a value smaller than the current buffer margin of the client j (Step D110). For example, multiply the current buffer margin bj(t) by adj (adj<1) or the like. In other words, set THLj=adj×bj(t). Then, return to Step D10. This is to make a time interval before a subsequent acquisition request is generated for obtaining a content fragment for the client j which is the target of the cancelled request. Since when a value larger than the current buffer margin is set as an acquisition request sending buffer margin, an acquisition request is immediately generated, it is necessary to set a value smaller than the current buffer margin.

Returning the value to the initial value at Step D100 is intended to reset the acquisition request sending buffer margin value which is reduced at Step D110.

When the prospective band use width RA(t)+z*j(t) is larger than RB, sending a new content acquisition request invites bottlenecking link congestion. In order to avoid such a situation, it is necessary to cancel sending-out of a new acquisition request targeting the client j or cancel other content acquisition request being executed instead of sending. The prefetch control unit 202E therefore checks whether an acquisition request that can be cancelled exists or not and when it exists, selects the same as a cancellation candidate (Step D120). The simplest way is sequentially considering an acquisition request as a cancellation candidate in descending order of buffer margins of target clients. When there exists an acquisition request targeting a client having a buffer margin larger than the buffer margin of the new target client j, the prefetch control unit 202E selects the same as a cancellation candidate. When canceling an acquisition request only according to a relative size of a buffer margin, buffer margins of all the requests might be monotonously decreased to result in degrading viewing and listening quality of all the clients. Therefore, not to select an acquisition request whose target client has a prospective buffer margin value not more than a set minimum buffer margin threshold value as a cancellation candidate.

Then, the prefetch control unit 202E calculates whether cancellation of these acquisition requests as cancellation candidates enables a bottleneck prospective band use width to be not more than the bottleneck limit rate (Step D130). For example, assume that when checking a buffer margin of a client as a target of an acquisition request being executed, clients having buffer margins larger than that of the client j are found to be k1, k2, . . . , kv. In other words, assume that bj(t)<bki(t) (i=1, 2, . . . , v). Even when these requests are all cancelled, if the prospective band use width will not be equal to or below the bottleneck limit rate, the prefetch control unit 202E cancels sending of a new acquisition request targeting the client j (Step D150). More specifically, assuming that an acquisition rate from the origin server to the stream proxy server 20E is given as zki(t) (i=1, . . . , v) as a result of measurement by the reception condition monitoring unit 202E-1, when the following expression fails to establish, the new acquisition request is cancelled:

$$RA ( t ) - {\sum }_{i = 1}^{v} {z}_{ki} ( t ) + {z}_{j}^{*} ( t ) \leq RB$$

Then, the prefetch control unit 202E sets the acquisition request sending buffer margin value THLj for the client j to be smaller than the current buffer margin (Step D160) to return to Step D10. This is intended to make a time interval before a content fragment acquisition request targeting the client j is generated. When the following expression establishes, the prefetch control unit 202E cancels as many requests as the number necessary for reducing the prospective band use width to be equal to or below the bottleneck limit rate (Step D140):

$$RA ( t ) - {\sum }_{i = 1}^{v} {z}_{ki} ( t ) + {z}_{j}^{*} ( t ) \leq RB$$

More specifically, when the following expression holds, the prefetch control unit 202E cancels a number w of requests:

$$RA ( t ) - {\sum }_{i = 1}^{w} {z}_{ki} ( t ) + {z}_{j}^{*} ( t ) \leq RB , w \leq v$$

The prefetch control unit 202E instructs the transport layer control unit 205E to send a request for canceling acquisition to the origin server. In addition, when necessary, instruct on cut-off of the connection between the origin server and the stream proxy server.

The foregoing processing flow is cancelled when the viewing and listening end request from the client j arrives at the prefetch control unit 202E through the streaming control unit 201E. Upon receiving the viewing and listening end request, the prefetch control unit 202E instructs the transport layer control unit 205E to send a request for canceling acquisition to the origin server. In addition, when necessary, instruct on cut-off of the connection between the origin server and the stream proxy server.

The effect of the sixth embodiment is realizing control adapted to network congestion conditions. Monitoring a bottleneck band use condition enables adjustment of the number of requests to be sent so as to prevent the network from congesting. At that time, giving priority to a request having a small buffer margin prevents buffer margins of more acquisition requests from running out. As a result, high-quality streaming can be realized stably for more clients.

(Seventh Embodiment)

In the sixth embodiment, when selecting a candidate for a request whose acquisition is to be cancelled, selection is made in descending order of buffer margins of target clients. Another possible method is setting priority to an acquisition request based on other index and selecting a cancellation candidate in ascending order of priority. Take the following as an example.

(1) Set priority for each origin server at which requested content is located,

(2) set priority for each client executing a request, and

(3) set priority for each content.

The effect of the seventh embodiment is enabling discrimination among requests by using other criterion than a buffer margin to be introduced. Although when a buffer margin of a target client is reduced, a new request should be sent to inevitably require a buffer margin for determining request generation timing, the order of priority of requests to be executed is not necessarily determined by a buffer margin. By determining candidates for acquisition requests to be cancelled according to the above-described index, prioritization of a request can be realized.

(Eighth Embodiment)

The fifth, sixth and seventh embodiments are premised on that a content acquisition request is generated when a viewing and listening request from a client arrives at the prefetch control unit 202E through the streaming control unit 201E or when a buffer margin of a client becomes not more than an acquisition request sending buffer margin threshold. Based on the then buffer margin, a content fragment whose acquisition is to be requested is determined.

According to this method, however, even if a client has a good buffer margin at the moment, when a specific link located on a path of a connection set up between the stream proxy server 20E currently obtaining contents and the origin server abruptly congests, sending a content fragment acquisition request after the buffer margin becomes small prevents acquisition from being in time to cause the buffer to run out, which might be followed by degradation of viewing and listening quality of the client.

To prevent the problem, a buffer margin should be redefined as a criterion taking an acquisition rate and a viewing and listening rate into consideration to conduct control based on the newly defined buffer margin. As an index replacing a buffer margin, a prospective buffer margin is therefore defined. A prospective buffer margin is defined as a buffer margin expected at designated time posterior to the current time.

Express a difference between designated time for calculating a prospective buffer margin and the current time as DT (sec). Express a range of contents that the proxy stream server 20E can obtain from the origin server from the current time t until a designated time after DT from the current time as CT (sec). Assuming that the current buffer margin is bi(t), the prospective buffer margin b*i(t) can be calculated as b*i(t)=bi(t)−DT+CT.

In the present eighth embodiment, a defined prospective buffer margin is calculated from a high-low relationship between a content fragment acquisition rate and a client's viewing and listening rate and the current buffer margin to conduct control based on the calculation. The principles will be outlined in the following.

When the buffer is just before running out (when the buffer margin is approximate to 0), whether a content fragment should be acquired or not is determined by a high-low relationship between a content fragment acquisition rate and a user's viewing and listening rate. When the acquisition rate is lower than the viewing and listening rate, there is no prospect of recovery of a buffer margin. The prospective buffer margin is calculated to be 0. In this case, since streaming to the client is interrupted, content fragment acquisition only accelerates band congestion. Therefore, cancel a further content fragment request. On the other hand, when the acquisition rate is higher than the client's viewing and listening rate, even if the buffer is just before running out, the buffer margin can be recovered. In other words, a predictive buffer margin is expected to have a value of a certain amount. Therefore, by requesting a content fragment within a wide range to a certain extent, an acquisition rate which can be currently ensured should be maintained as long a period of time as possible to recover the buffer margin.

Next, consider a case where a buffer margin is not so large (not so small as to be just before running out). When the acquisition rate is higher than the viewing and listening rate, a prospective buffer margin can be expected to have a value of a certain amount similarly to the above-described case. By requesting a content fragment within a wide range to a certain extent, an acquisition rate which can be currently ensured should be maintained as long a period of time as possible to recover the buffer margin. When the acquisition rate is lower than the viewing and listening rate, the buffer margin will be further reduced. In other words, the prospective buffer margin approximates to 0. Since the buffer will run out unless countermeasures are taken, an appropriate acquisition rate should be ensured as soon as possible. For this purpose, with a request whose target client has a large buffer margin, interrupt the acquisition and succeed to the band used by the request to ensure a necessary acquisition rate. However, interruption of other request is possible only when a request having a larger buffer margin exists. When such a request fails to exist, it is impossible to ensure a necessary acquisition rate. However, when acquiring no content fragment at all until a necessary acquisition rate is ensured, the buffer will shortly run out (a prospective buffer margin becomes 0). Therefore, it is necessary to obtain a content fragment at a possible acquisition rate as a temporary measure to put off coming of a time when the buffer runs out. However, even if the present acquisition rate continues for a long period of time, it is clear that the buffer margin of the target client will run out. Acquisition of the content fragment should be completed for a shorter period of time than that of a case where an acquisition rate exceeds a viewing and listening rate to check whether a necessary acquisition rate can be ensured or not. Therefore, reduce a period for ensuring the low acquisition rate, that is, a range of a requested content fragment.

Description will be next made of a case where a buffer margin is good enough. When the buffer margin is large enough, it is in general unnecessary to obtain a content fragment at once. Therefore, sending a content fragment request could be put off. This is not the case, however, when an acquisition rate is significantly lower than a viewing and listening rate. This situation signifies that the network is heavily congesting. This means that a buffer margin large enough at present will run out shortly. In other words, unless content fragment acquisition is conducted, the prospective buffer margin will approximate to 0. In this case, it is better to obtain a content fragment at an available acquisition rate and prevent the buffer from running out to go through until the network congestion is eliminated.

The foregoing is the outline of the principles.

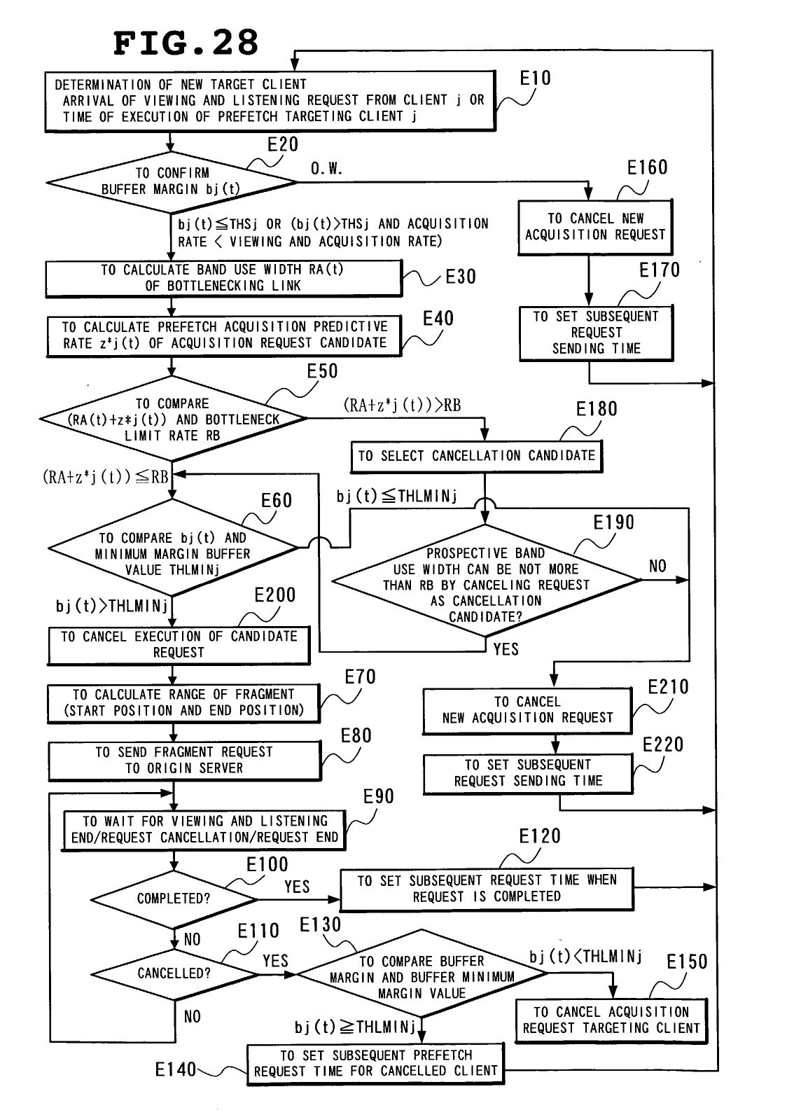

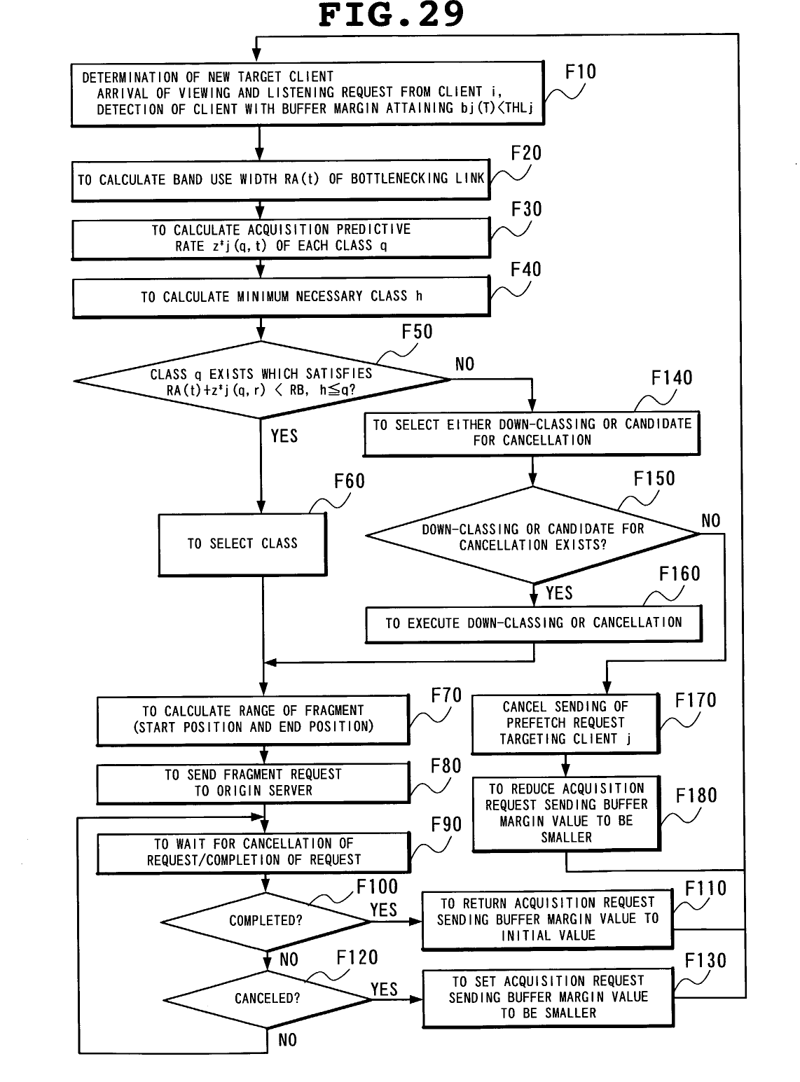

Details of the eighth embodiment under the control using a prospective buffer margin will be described in the following with reference to the flow chart of FIG. 28 and the structural diagram of FIG. 26.

Generation of a content acquisition request occurs at the arrival of a viewing and listening request from a client or at a time point of sending a content fragment acquisition request set for each client which will be described later. The prefetch control unit 202E monitors the events of the arrival of a viewing and listening request from the streaming control unit 201E and detection of a time point of sending a content fragment acquisition request to wait for generation of a new acquisition request. Then, determine a new target client j (Step E10).

First, confirm an actual buffer margin of the client j at the current time (Step E20). In a case where the buffer margin bj(t) is larger than a desired buffer margin value THSj designated for each client (bj(t)>THSj) and an acquisition rate of a request targeting the client j exceeds a viewing and listening rate of the client j, determination is made that there is still a margin to cancel sending of a new acquisition request (Step E160). Then, when the content is being viewed and listened to by the client, set subsequent request generation time (Step E170). Method of setting subsequent request generation time will be described at the step to follow (Step E140). When the buffer margin is not more than THSj or when the buffer margin exceeds THSj but the acquisition rate of the request targeting the client j is below the viewing and listening rate of the client j, proceed to Step E30.

When bj(t)≦THMj, the prefetch control unit 202E obtains a bottleneck link band use width RA(t) from the network information acquisition unit 207E (Step E30). Method of obtaining RA(t) of the network information acquisition unit 207E is the same as that of the fifth embodiment.

The prefetch control unit 202E predicts a rate of obtaining contents by the stream proxy server 20E from the origin server at the time of executing new acquisition targeting the client j (Step E40). This rate will be referred to as a prefetch acquisition predictive rate and be represented as z*j(t). Method of estimating the z*j(t) is assumed to be the same as that of the sixth embodiment.

Check whether a prospective band use width obtained by adding traffic of the prefetch acquisition predictive rate to the bottlenecking link, that is, RA(t)+z*j(t), exceeds the bottleneck limit rate RB (Step E50). When not exceeding, proceed to Step E60.

When the prospective band use width RA(t)+z*j(t) is larger than RB, sending a new acquisition request invites congestion of the bottlenecking link. In order to prevent such a situation, it is necessary to stop sending a new acquisition request or instead of sending, cancel other content fragment acquisition request being executed. Therefore, the prefetch control unit 202E checks whether there exists a cancelable acquisition request or not and when it exists, selects the same as a cancellation candidate (Step E180). The most simplest manner is sequentially considering a request as a candidate for cancellation in descending order of prospective buffer margins.

Compare buffer margins as of a time point after a designated time width PT. From when a request is sent until when it is actually cancelled, it takes as much time as that required for a packet to arrive at the origin server from the proxy stream server 20E. Express a time required for canceling a content fragment acquisition request targeting the client i as RCSi. Here, RCSi should be approximated by half of RTTi, which is the RTT of an acquisition request targeting the client i measured by the reception condition monitoring unit 202E-1.

For the simplicity of description, assume that a content fragment acquisition rate targeting the client i is zi substantially without change and a viewing and listening rate is ri in CBR. Then, a prospective buffer margin b*i(t) when the request by the client i is cancelled is expressed as follows with the current buffer margin denoted as bit(t):

b*i(t)=bi(t)−PT+(zi−ri)×RCSi

When an acquisition request is being executed targeting a client having a prospective buffer margin larger than the prospective buffer margin b*j(t) of the client j who makes a new content acquisition request, select such a request as a cancellation candidate. However, when an acquisition request is cancelled according only to a size of a relative prospective buffer margin, buffer margins of all the requests will be monotonously decreased to result in having a possibility of degradation in quality of streaming to all the clients. Therefore, select none of acquisition requests having a prospective buffer margin value of a target client not more than a set minimum prospective buffer margin threshold as a cancellation candidate.

Then, by canceling acquisition requests as these cancellation candidates, check whether a prospective band use width of the bottleneck can be equal to or below the bottleneck limit rate (Step E190). Assume, for example, checking a prospective buffer margin of a client as a target of an acquisition request being executed finds that clients whose prospective buffer margin is larger than that of the client j are k1, k2, . . . , kv. In other words, assume that b j(t)<b*ki(t) (i=1, 2, . . . , v). Then, assume acquisition rates of the clients k1, k2, . . . , kv at the current time t are zk1(t), zk2(t), . . . , zkv(t). If canceling all these requests will not result in making the prospective band use width be equal to or below the bottleneck limit rate, that is, if the following expression holds:

$$RA ( t ) - {\sum }_{i = 1}^{v} {z}_{ki} ( t ) + {z}_{j}^{*} ( t ) > RB$$

the prefetch control unit 202E cancels sending of a new request from the client j (Step E210). Then, set time of sending a content fragment acquisition request targeting the client j according to the method shown in Step E140 which will be described layer.

At Step E190, when a prospective band use width can be equal to or below the bottleneck limit rate by canceling some of the requests as cancellation candidates, proceed to Step E60 and when at Step E60, the buffer margin is larger than THLMINj, cancel as many requests as the number required for making the prospective band use width be equal to or below the bottleneck limit rate (Step E200). At this time, when the following expression holds, cancel the number w of the requests:

$$RA ( t ) - {{\sum }_{i = 1}}^{w} {z}_{ki} ( t ) + {z}_{j}^{*} ( t ) \leq RB , w \leq v$$

When the determination is made at Step E50 that a band necessary for sending a new acquisition request is ensured, the prefetch control unit 202E intends to proceed to calculation of a range of a requested content fragment conducted at Step E70 and the following steps. However, when the calculated prefetch acquisition predictive rate z*j(t) is low, exhaustion of a buffer (buffer margin attaining 0) is inevitable even by conducting prefetch. In such a case, the new acquisition request should be given up. This determination is made at Step E60. More specifically, when the buffer margin bj(t) is equal to or below a designated minimum buffer margin value THLMINj, proceed to Step E210 to cancel sending of the new acquisition request. When the buffer margin is larger than THLMINj, proceed to Step E200 to cancel a candidate request as described above, as well as proceeding to Step E70 and the following steps to send the new acquisition request.

At Step E70, calculate a range of a content fragment of the new acquisition request. First, a start position coincides with a larger value of either an end position of the latest request or a current viewing and listening position. This is the same as that of the fifth embodiment. An end position is assumed to be a position which enables a prospective buffer margin at the time of completion of execution of an acquisition request to be a desired buffer margin value THSj. Description will be made of a method of calculating an end position in a case, for example, where a stream is encoded as CBR of a fixed viewing and listening rate rj when a rate of obtaining stream data from the origin server by the stream proxy server 20E is constantly zi. The proxy stream server 20E increases a buffer at a rate of (zj−rj) (bps) from when data of a requested position arrives until when data at an end position arrives. In terms of a buffer margin, a buffer margin equivalent to (zj−rj)/rj second per unit time is generated. Assuming the time from when the content acquisition request is sent until reception of the data of the end position is to be ST, a prospective buffer margin b*j(t+ST) after ST will be expressed by the following expression taking RTTj which is RTT from the transmission of the request until the reception of the data of the start position:

$${b}_{j}^{*} ( t + ST ) = {b}_{j} ( t ) + \frac{( {z}_{j} - {r}_{j} )}{{r}_{j}} \times ( ST - {RTT}_{j} )$$

b*j(t+ST)=THSj is established when the following expression holds:

$$ST = \frac{{r}_{j}}{( {z}_{j} - {r}_{j} )} \times ( {THS}_{j} - {b}_{j} ( t ) ) + {RTT}_{j}$$

in which ST>RTTj should hold (because it is strange that scheduled time of data acquisition completion is set to be shorter than RTT). Therefore, when THSj>bj(t), zj>rj should hold. How to cope with a case where THSj>bj(t) and zj≦rj will be considered on other occasion. When THSj≦bj(t), zj<ri holds without fail because a case where an acquisition rate exceeds a viewing and listening rate is excluded at Step E20, so that ST>RTTj is established. When satisfying ST>RTTj, a range CST of contents obtained after ST sec will be expressed by the following expression:

$$CST = \frac{( ST - {RTT}_{j} ) {z}_{j}}{{r}_{j}} = \frac{( {THS}_{j} - {b}_{j} ( t ) ) {z}_{j}}{( {z}_{j} - {r}_{j} )}$$

Therefore, set the end position to be “start position+CST”. By this arrangement, the buffer margin of the client j is expected to be THSj after ST sec from the current time.

However, when THSj>bj(t) and zj≦rj, the buffer margin can not be THSj. Issuing no acquisition request at all because the buffer margin can not be a desired buffer margin value, however, results in further constraining the buffer margin. Although an appropriate content fragment range should be set to execute acquisition, requesting a too wide range will result in delaying timing for ensuring an acquisition rate, causing the buffer margin to be constrained. The range should be desirably set to be narrow such that a subsequent acquisition request is executed as soon as possible. Therefore, with the minimum buffer margin value THLMINj designated, the prefetch control unit 202E sets a range where the prospective buffer margin attains THLMINj. b*j(t)=THLMINj is established when the following expression holds:

$$ST = \frac{{r}_{j}}{( {r}_{j} - {z}_{j} )} \times ( {b}_{j} ( t ) - {THLMIN}_{j} ) + {RTT}_{j}$$

ST>RTTj should hold. Since a case where bj(t)≦THLMINj (where the minimum buffer margin value can not be ensured) is already excluded at Step E60, ST>RTTj always holds. When bj(t)>THLMINj, request a range represented by the following expression:

$$CST = \frac{( ST - {RTT}_{j} ) {z}_{j}}{{r}_{j}} = \frac{( {b}_{j} ( t ) - {THLMIN}_{j} ) {z}_{j}}{{r}_{j} - {z}_{j}}$$

Set the end position to be “start position+CST” using this CST. As a result of this setting, the buffer margin of the client j after ST sec from the current time can be expected not to be equal to or below THLMINj.

Then, the prefetch control unit 202E instructs the transport layer control unit 205E to send a content acquisition request with a range determined at the preceding step designated to the origin server and receive a content fragment (Step E80). The transport layer control unit 205E instructed to obtain the content fragment sets up a connection with the origin server when it fails to exist and reuses the same when it already exists to execute content fragment acquisition.

Then, the prefetch control unit 202E waits for either of the events, the cancellation of the sent request (Step E110) or the completion of acquisition of the content fragment by the sent request (Step E100) to occur (Step E90).

When the content fragment acquisition is completed (Step E100), the prefetch control unit 202E sets subsequent sending time of an acquisition request targeting the client j (Step E120). Set as the subsequent request sending time is predicted time when the buffer margin will reach the acquisition request sending buffer margin threshold value THLj as subsequent request generation time. Assuming that the current buffer margin is bj(t) (≧THLj), a prospective buffer margin after XT sec, that is, b*j(t+XT) will be expressed as b*j(t+XT)=bj(t)−XT, which will be THLj after XT=bj(t)−THLj sec. Set the current time+XT as subsequent acquisition request sending time. If THLj>bj(t), which means that a buffer margin is not good enough, set the current time as subsequent request acquisition sending time to immediately return to Step E10.

When canceling the request for obtaining a content fragment (Step E110), the prefetch control unit 202E sets subsequent sending time of the acquisition request targeting the client j (Step E140). When the request is cancelled, a time interval before subsequent request sending should have a certain amount of time. This is because executing re-request immediately will accelerate network congestion. When the current buffer margin value is bj(t)>THLj, the subsequent request generation time should be predicted time when the buffer margin will reach the acquisition request sending buffer margin threshold value THLj similarly to a case of completion. On the other hand, when the current buffer margin value is bj(t)≦THLj, set as subsequent request sending time is predicted time when the prospective buffer margin will reach the minimum buffer margin value THLMINj as subsequent request generation time. Assuming the current buffer margin to be bj(t) (≧THLMINj), the prospective buffer margin after XT sec, that is, b*j(t+XT) will be expressed as b*j(t+XT)=bj(t)−XT, which will be THLMINj after XT=bj(t)−THLMINj sec. Set the current time+XT as subsequent acquisition request sending time. If THLMINj>bj(t), determining that the buffer margin is not good enough to maintain viewing and listening quality, give up acquisition of the content fragment targeting the client j (Step E150).

The foregoing processing flow is cancelled when a viewing and listening end request from the client j arrives at the prefetch control unit 202E through the streaming control unit 201E. Upon receiving the viewing and listening end request, the prefetch control unit 202E instructs the transport layer control unit 205E to send an acquisition cancellation request to the origin server. In addition, when necessary instruct on cut-off of the connection between the origin server and the stream proxy server.

The effect of the eighth embodiment is spontaneously coping with rapid condition change of the network by predicting a buffer margin taking an acquisition rate and a viewing and listening rate into consideration.

(Ninth Embodiment)

The foregoing embodiments are premised on that all the packets are handled evenly in a network layer. There is a case, however, where several classes having different communication speeds exist in the network layer. As an example, there is a case where TCP Reno and TCP Vegas coexist. TCP Vegas is known to have a tendency of giving a band to TCP Reno. Therefore, a content fragment acquisition speed varies with which protocol of TCP Reno and TCP Vegas is used.

Taken as another example is Diffserv. In Diffserv, possible setting is to classify traffic and process the classified traffic according to priority varying with each class. It is possible to have setting, for example, to guarantee for an EF class, a rate up to a set value called PIR and a designated round trip time and for AF1 to AFn classes, conduct best effort processing based on round robin with weighing values of CIR1 to CIRn. In this case, a processing speed varies with which class is selected.

The ninth embodiment shows a control system which enables a buffer margin good enough for more clients to maintain streaming quality to be ensured by appropriately using classes in such a case as described above where a plurality of classes exist having different processing speeds. In the sixth, seventh and eighth embodiments, adjustment among requests contending for a bottleneck is made either by cancellation of a request or by execution of the same. Selectively using classes in the adjustment enables more minute control.

The ninth embodiment will be described with reference to the flow chart of FIG. 29 and the structural diagram of FIG. 26. For the generalization of the description, assume in the following that k kinds of classes from class 1 to k exist in a transport layer.

Request generation may be timed to the arrival of a viewing and listening request from a client or to the detection of the buffer margin lowering an acquisition request sending buffer margin value as in the fifth, sixth and seventh embodiments, while it may be timed to the arrival of a viewing and listening request from a client or to acquisition request sending time set as in the eighth embodiment. Here, description will be made with respect to a case where the request generation is timed to the arrival of a viewing and listening request from the client j or to the detection of the buffer margin of the client j lowering the acquisition request sending buffer margin value. When detecting these events, the prefetch control unit 202E determines a new target client j (Step F10).

First, the prefetch control unit 202E obtains a band use width RA(t) of the bottlenecking link at the current time t from the network information acquisition unit 207E (Step F20). Method of obtaining the band use width RA(t) of the bottlenecking link from the network information acquisition unit 207E is the same as that of the seventh embodiment.

Next, calculate a prefetch acquisition predictive rate of each class (Step F30). The prefetch control unit 202E estimates an acquisition speed at the time of execution of the new acquisition request by each class. Express an acquisition predictive rate at the time t at the execution of the new acquisition request targeting the client j at a class q as z*j(q,t). An acquisition predictive rate for a class in which acquisition of a content fragment targeting the client j is already executed can be approximated by its latest acquisition rate. The latest acquisition rate is recorded by the reception condition monitoring unit 202E-1. In a case where although acquisition of a content fragment targeting the client j is already executed, a part of the classes is not yet used for acquisition, convert a latest rate at a class used for acquisition into an acquisition predictive rate at a class yet to be used.

One specific example of the conversion methods will be described. Assume that preferential control is conducted by Diffserv with three classes, EF having PIR peak rate guaranteed, and AF1 and AF2 being processed based on best effort with weighs of CIR1 and CIR2, respectively. With the EF as a class 1, the AF1 as a class 2 and the AF2 as a class 3, only the latest acquisition rate zj(2, s)(s<t, t: current time) in the AF1 is assumed to be recorded in the reception condition monitoring unit 202E-1. At this time, since a peak rate is guaranteed in the EF, the prefetch control unit 202E is allowed to calculate an acquisition predictive rate in the EF as z*(1, t)=PIR. An acquisition predictive rate of the AF1 will be z*(2, t)=z*(2, s) by the approximation by the latest value. An acquisition predictive rate of the EF2 can be calculated as z*(3,t)=z*(2,t)×CIR2/CIR1 by using weighting.

Even in a case where acquisition of a content fragment targeting the client j is not yet executed, if the same content has been obtained targeting other client, an acquisition predictive rate of each class can be approximated by the latest acquisition rate recorded in the reception condition monitoring unit 202E-1. Even with acquisition records of not all the classes, the rate can be calculated by the above-described conversion method.

When the same content has never been obtained targeting other client, the prefetch control unit 202E checks whether a rate of acquisition from the same origin server is recorded in the reception condition monitoring unit 202E-1 or not. By its latest value, an acquisition predictive rate of each class can be approximated. Even with acquisition records of not all the classes, the above-described conversion method enables calculation.

In a case where no acquisition of a content fragment targeting the client j has ever been executed, none of the same content has ever been obtained targeting other client and no acquisition from the same origin server is recorded, an acquisition predictive rate can be set using a default value for each class.

Next, the prefetch control unit 202E confirms existence of a class enabling a prospective buffer margin after a designated time WT to be a designated desirable buffer margin value BTHj (Step F40). Assume, for example, that a viewing and listening rate of a user is constantly rj, the unit 202E confirms existence of a class satisfying the following condition:

BTHj≦bj(t)+(z*j(q, t)−rj)×(WT−RTTj, q).

When there exists a class satisfying the condition, express the smallest class satisfying the condition as h. “h” will be referred to as a minimum necessary class. Here, RTTj,q represents a time from when an acquisition request targeting the client j is sent at the class q until when data at a start position arrives at the proxy server.

A round trip time RTTj,q of each class is recorded in the reception condition monitoring unit 202E-1 when acquisition targeting the client j has ever been conducted at the class q. When the time is recorded, its value may be used. When not recorded, a value may be obtained by conversion from an appropriate round trip time recorded or an appropriate default value may be used.

One specific example of the round trip time conversion methods will be described. Assume that preferential control is conducted by Diffserv with three classes, EF having a round trip time guaranteed under RTT1, and AF1 and AF2 being processed based on best effort with weighs of CIR1 and CIR2, respectively. With the EF as a class 1, the AF1 as a class 2 and the AF2 as a class 3, assume that only the latest RTT at the EF1, i.e. RTTj, 2 is recorded in the reception condition monitoring unit 202E-1. At this time, calculation can be made at the EF that RTTj, 1=RTT1. As to RTT at the AF1, the latest value can be used. RTT of the EF2 can be calculated as RTTj, 3=RTTj, 2×CIR1/CIR2 by using weighting.

Even in a case where acquisition of a content fragment targeting the client j is not yet executed, if the same content has been obtained targeting other client, an acquisition predictive rate of each class can be approximated by the latest acquisition rate recorded in the reception condition monitoring unit 202E-1. Even with acquisition records of not all the classes, the rate can be calculated by the above-described conversion method.

When the same content has never been obtained targeting other client, the prefetch control unit 202E checks whether an RTT from the same origin server is recorded in the reception condition monitoring unit 202E-1 or not. By its latest value, an RTT of each class can be approximated. Even with acquisition records of not all the classes, the above-described conversion method enables calculation.

In a case where no acquisition of a content fragment targeting the client j has ever been executed, none of the same content has ever been obtained targeting other client and no acquisition from the same origin server is ever recorded, an RTT can be set using a default value for each class.

Check whether there exists, among q=h, . . . , k, a class that satisfies (RA(t)+z*j(q,t)≦RB or not (Step F50). When there exists one satisfying the expression, proceed to Step F60 and the following steps and otherwise proceed to Step F140 and the following steps.

When there exist a plurality of classes q which satisfy (RA(t)+z*j(q,t))≦RB and q≧h, select any of the classes (Step F60). As the selection among the classes q which satisfy (RA(t)+z*j(q,t))≦RB and q≧h, any of the following methods can be used of:

1. selecting a class having the highest prefetch acquisition predictive rate,

2. selecting a class having the lowest prefetch acquisition predictive rate, and

3. making determination according to priority given to each client and selecting a class having a higher prefetch predictive acquisition rate for a client having higher priority.

When the class is selected, calculate an acquisition request range (Step F70). Assume a start position to be a current viewing and listening position or a final position of a content fragment being viewed and listened by the client. An end position will be a position obtained by adding (WT+BTHj−bj(t)) to the start position. By requesting such a range, the buffer margin can be expected to be BTHj after the designated time period WT.

Then, the prefetch control unit 202E instructs the transport layer control unit 205E to send a content acquisition request with a range determined at the preceding step designated to the origin server and receive the content fragment (Step F80). Being instructed to obtain a content fragment, the transport layer control unit 205E sets up a connection with the origin server when none exists and reuses the same when one already exists to execute acquisition of the content fragment.

After sending the content fragment acquisition request, the prefetch control unit 202E waits for any of the following events to occur (Step F90). More specifically, the cancellation of an acquisition request targeting the client j (Step F120) and the completion of an acquisition request targeting the client j (Step F100).

When the event of the completion of an acquisition request occurs (Step F100), return the acquisition request sending buffer margin value THLj to the initial value (Step F110). Then, return to Step F10.

When the acquisition request is cancelled (Step F120), set the acquisition request sending buffer margin value THLj to be a value smaller than the current buffer margin of the client j (Step F130). For example, set the margin value to be adj times (adj<1) the current margin buffer bj(t). In other words, set the value such that THLj=adj×bj(t). Then, return to Step F10. This is to make a time interval before a subsequent acquisition request for obtaining a content fragment targeting the client j which is the target of the cancelled request occurs. Since when a value larger than the current buffer margin is designated as an acquisition request sending buffer margin value, an acquisition request will be immediately generated, it is necessary to set the value to be smaller than the current buffer margin.

Returning to the initial value at Step F110 is intended to reset the acquisition request sending buffer margin value reduced at Step F130.

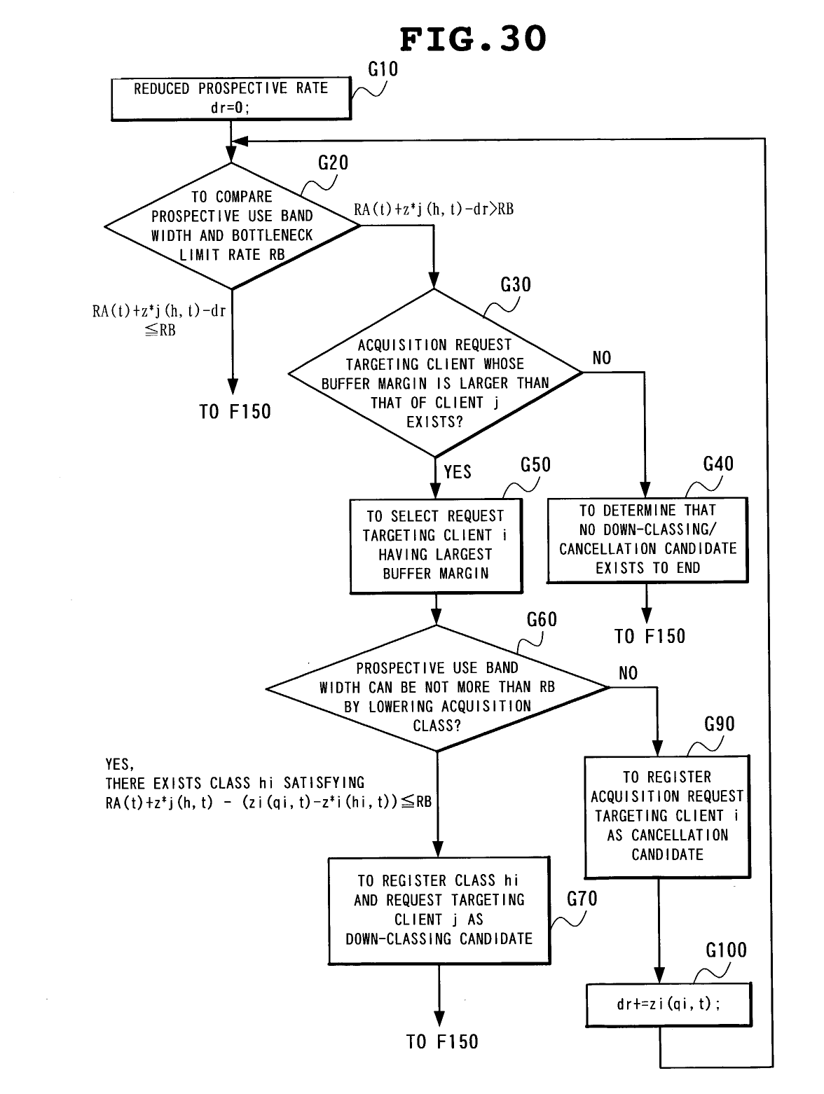

When no class is selected, it is necessary to cancel sending of any of the requests or lower an acquisition rate of the acquisition being executed. At the time of lowering the acquisition rate of the acquisition being executed, conduct switching to a class having a slower processing speed. This processing is referred to as down-classing. The prefetch control unit 202E selects down-classing or a candidate for a request to be cancelled (Step F140). Flow chart detailing Step F140 is shown in FIG. 30.

First, initialize a parameter dr which stores a reduced prospective rate expected by down-classing of the acquisition request being executed or cancellation of the same to 0 (Step G10).

Then, execute suppression of a rate of a down-classing candidate and cancellation of acquisition of a cancellation candidate and further confirm a prospective use band width becoming not more than the bottleneck limit rate RB when a new acquisition request is executed by the minimum necessary class (Step G20). More specifically, assuming that a predictive acquisition rate of a new acquisition request at the lowest class is z*j(h,t) and the current use band width is RA(t), confirm RA(t)+z j(h,t)−dr≦RB being satisfied. When satisfied, proceed to Step F150 and otherwise proceed to the following steps.

Check whether among acquisition requests being executed which are not included in the down-classing candidates/cancellation candidates, there exists a request whose targeting client has a buffer margin larger than that of the new target client j (Step G20). When there exists none, determine that no down-classing/cancellation candidate exists to end the processing (Step G40).

When there exists among the acquisition requests being executed which are not included in the down-classing candidates/cancellation candidates, a request whose target client has a buffer margin larger than that of the new target client j, select an acquisition request targeting a client i having the largest buffer margin (Step G50).

With the current acquisition class of the request as pi and the current acquisition rate as zi(qi,t), check whether there exists a class hi satisfying (RA(t)+z*j(h,t)−(zi(pi,t)−z*i(hi,ti))≦RB and hi<q. In other words, check whether there exists a class enabling a prospective use band width to be not more than the bottleneck link limit rate (Step G60).

When there exists such a class, consider a pair of the request and the class hi as a down-classing candidate to add zi(pi,t)−zi(hi,t) to the reduced prospective rate dr (Step G70). Then, proceed to Step F150 of FIG. 29.

When the class hi which satisfies (RA(t)+z*j(h,t)−(zi(pi,t)−z*i(hi,t))≦RB and hi<q fails to exist, register the acquisition request targeting the client i as a cancellation candidate (Step G80) and add the current acquisition rate z*i(pi,t) of this request to the reduced prospective rate dr to return to Step G20 (Step G90).

When the selection of a down-classing candidate/cancellation candidate is completed at Step F140, proceed to Step F150. At Step F150, confirm a down-classing candidate/cancellation candidate being registered. When not registered, cancel sending of a new acquisition request (Step F170) to set the acquisition request sending buffer margin value of the client j to be smaller than the current buffer margin (Step F180). For example, set the value to be adj times (adj<1) the current buffer margin. In other words, set the value such that THLj=adj×bj(t). Setting the value to be smaller than the current buffer margin is intended to make an interval before an acquisition request targeting the client j is issued.

If, the down-classing candidate/cancellation candidate is registered, execute down-classing of the candidate and cancellation. Then, proceed to Step F70.

The foregoing processing is cancelled when the viewing and listening end request from the client j arrives at the prefetch control unit 202E through the streaming control unit 201E. Upon receiving the viewing and listening end request, the prefetch control unit 202E instructs the transport layer control unit 205E to send a request for acquisition cancellation to the origin server. In addition, when necessary, instruct on the cut-off of the connection between the origin server and the stream proxy server.

The effect of the ninth embodiment is enabling more minute control of adjustment among requests contending for the bottleneck by selectively using classes as compared with the sixth, seventh and eighth embodiments. Free band can be more efficiently used to avoid congestion more effectively.

(Tenth Embodiment)

According to the fifth to ninth embodiments, a new content fragment acquisition request is generated depending on an amount of a buffer margin or a prospective buffer margin. Then, by adjusting bands for generated request, network congestion is prevented. These systems inevitably generate a new acquisition request (which might be cancelled later) regardless of network congestion conditions. In other words, the fifth to ninth embodiments fail to realize a mechanism for suppressing sending of a request according to network congestion conditions. Control for increasing a request sending interval at the time of congestion by the control of decreasing an acquisition request sending buffer margin value at the time of request cancellation is realized also by the sixth to ninth embodiments. Increasing a request sending interval upon detection of network congestion will result in preventing the network congestion earlier. Conversely, when the network is free, decreasing a request sending interval will result in ensuring a buffer margin more effectively without making a space in network bands. Under these circumstances, a tenth embodiment shows a system of adjusting a buffer margin or a prospective buffer margin according to network congestion. Although shown here will be a system of adjusting a buffer margin, the margin may be replaced by a prospective buffer margin.

A value reflecting end-to-end network congestion conditions is a round trip time (hereinafter referred to as RTT) from when a content fragment request is sent until when data arrives. The reception condition monitoring unit 202E-1 therefore measures an RTT at the time of each content fragment acquisition. By using information of an RTT effectively, make the most of a free band and prevent contention for bands at the time of congestion.

The present embodiment is characterized in seizing network congestion conditions by using an RTT to decrease an acquisition request sending buffer margin value and increase request sending interval at the time of RTT increase, that is, when determination is made that a network congests. Because this control enables request sending to be suppressed at the time of network congestion, earlier elimination of the network congestion can be expected. On the other hand, at the time of RTT decrease, that is, when the determination is made that the network is free, an acquisition request sending buffer margin value is increased to decrease a request sending interval. This control realizes content fragment acquisition using a free band actively.

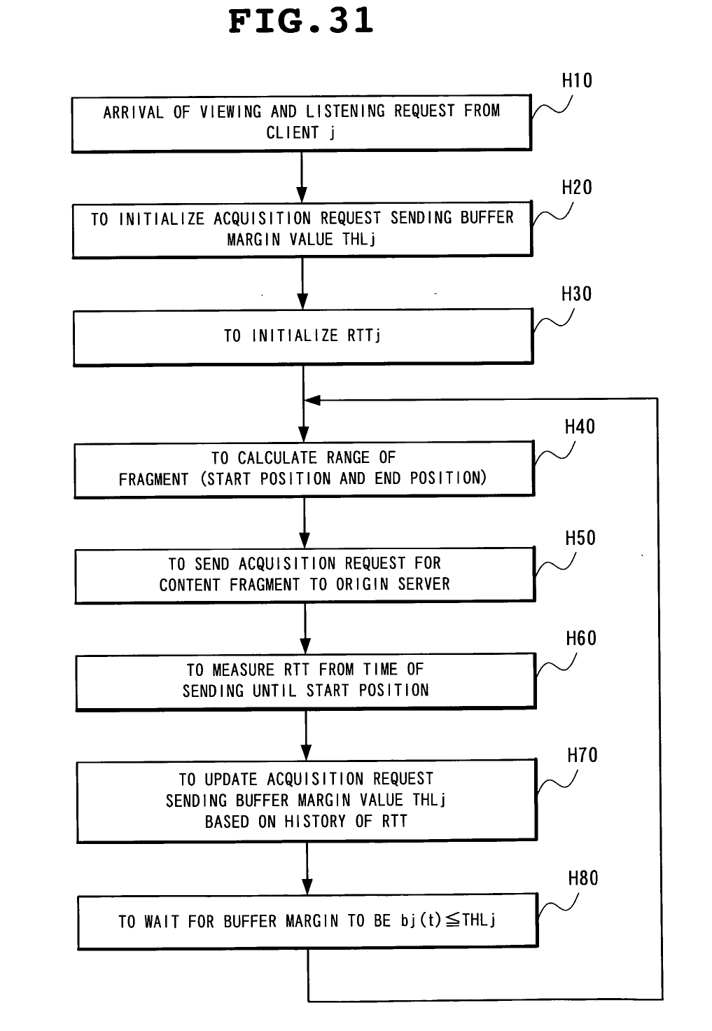

Processing flow of the tenth embodiment will be described with reference to the flow chart of FIG. 31 and the structural diagram of FIG. 23. When a viewing and listening request from a client arrives at the prefetch control unit 202E through the streaming control unit 201E (Step H10), the prefetch control unit 202E initializes an acquisition request sending buffer margin value THLj of the new target client j to an initial value designated (Step H20).

An RTT from when a content fragment acquisition request targeting the client j is sent until when content data at a start position arrives (hereinafter referred to as RTTj) has no measurement history at the start of the viewing and listening. Therefore, set the initial value of the RTTj by any of the following methods (Step H30).

(1) When content fragment acquisition for the same content targeting other client i is executed, use an RTT of the client i, that is, set RTTj=RTTi.

(2) When a request for the same content was made in the past, use the latest RTT.

(3) Initialize to an appropriate default value.

Then, the prefetch control unit 202E calculates a content fragment acquisition range (Step H40). Method of calculating the range is the same as that of the fifth embodiment.

Then, the prefetch control unit 202E instructs the transport layer control unit 205E to send a content acquisition request with the range determined at the preceding step designated to the origin server and receive a content fragment (Step H50). The transport layer control unit 205E being instructed on content fragment acquisition sets up a connection with the origin server when none exists and reuses the same when one already exists to execute content fragment acquisition.

The reception condition monitoring unit 202E-1 measures and records a time (RTT) from when the request is sent until when a start position of the requested content fragment arrives (Step H60). At this time, store an old RTTj in RTTj_old.

Then, depending on an RTT from when an acquisition request for a content fragment targeting the client j is sent until when content data at the start position arrives, dynamically change the acquisition request sending buffer margin value THLj of the client j given as a fixed value in the fifth embodiment (Step H70). As the RTT of the content fragment acquisition targeting the client j is increased, the reception condition monitoring unit 202E-1 decreases the THLj. As the RTT is decreased, increase the THLj. Assume, for example, that the RTT of the preceding content fragment request is RTTj_old and the RTT of the content fragment request this time is RTTj, update the THLj according to the following expressions:

THLj_old=THLj;

THLj=THLj_old×RTTj_old/RTTj.

Method of decreasing (increasing) the THLj with an increase (decrease) of the RTT is not limited to thus described method. By decreasing the THLj when the RTT is increased, a possibility that a request will be sent at the time of network congestion can be reduced.

Decreasing the THLj too much results in that network congestion lingers to cause the buffer to run out and add a probability of degradation in viewing and listening quality of a client. Therefore, make not the THLj be the minimum THLmin-j set or below. In addition, since having too large a buffer margin is meaningless in view of constraints on space of the storage unit 204E, make not the THLj be the maximum THLmax-j designated or above.

Then, the prefetch control unit 202E monitors the buffer margin value bj(t) to wait for the value to be the acquisition request sending buffer margin value THLj or below (Step H80). When the value becomes THLj or below, return to Step H40 to send a request again.

The foregoing processing flow is cancelled when a viewing and listening end request from the client j arrives at the prefetch control unit 202E through the streaming control unit 201E. Upon receiving the viewing and listening end request, the prefetch control unit 202E instructs the transport layer control unit 205E to send a request for acquisition cancellation to the origin server. In addition, when necessary, instruct on the cut-off of the connection between the origin server and the stream proxy server.

The above-described tenth embodiment shows control based on an RTT. Network congestion, however, can be detected not only by an RTT. RTT can be replaced by other index for detecting network congestion. Control is possible, for example, with an RTT replaced by a rate of use of a bottlenecking link. More specifically, the acquisition request sending buffer margin value THLj at Step H70 is dynamically changed depending on a rate of use of a bottleneck. Structure used in this case is the same as that of the sixth embodiment shown in FIG. 26. The prefetch control unit 202E obtains a rate of use of the bottlenecking link from the network information acquisition unit 207E. With an increase in a rate of use of the bottlenecking link, decrease the THLj. When the RTT is decreased, increase the THLj. Assume, for example, that for each time slot of a certain time width, the prefetch control unit 202E obtains a rate of use of the bottlenecking link from the network information acquisition unit 207E. With a rate of use of the link at the preceding time slot expressed as Uold and that of the time slot at this time expressed as U, update the THLj according to the following expressions:

THLj_old=THLj;

THLj=THLj_old×Uold/U.

Method of decreasing (increasing) the THLj with an increase (decrease) of a rate of use of the bottlenecking link is not limited to thus described method. By decreasing the THLj when the rate of use of the bottlenecking link is increased, a possibility that a request will be sent at the time of network congestion can be reduced.

Moreover, although the tenth embodiment described so far is based on the fifth embodiment, control as a basis can be replaced by those of the sixth to ninth embodiments with ease.

Effect of the tenth embodiment is enabling network congestion to be prevented earlier than in the fifth to ninth embodiments. With a mechanism for suppressing request sending according to network congestion conditions incorporated, increasing a request sending interval at a time point of detecting network congestion and conversely decreasing the request sending interval when the network is free realizes the effect.

(Eleventh Embodiment)

The tenth embodiment is partly characterized in preventing request sending at the time of network congestion. This control, however, as described in the tenth embodiment, has a possibility of inviting exhaustion of a buffer margin and degradation in streaming quality when network congestion persists.

There is a case where although no congestion occurs in a bottlenecking link, acquisition from a specific connection (specific origin server) delays due to congestion. In such a case, in response to an increase in an RTT, request sending should be actively conducted conversely to the tenth embodiment. This is because unless an acquisition request is sent as soon as possible, it is highly probable that acquisition will not be in time.

The eleventh embodiment is characterized in seizing network congestion conditions by using an RTT and with an increase in the RTT, that is, when the determination is made that the network congests, conducting content fragment acquisition more frequently as compared with a case having a shorter RTT in order to maintain the buffer margin at as large a value as possible. This control prevents the buffer from running out (buffer margin goes 0) following a delay in data arrival caused by network congestion.

The difference from the tenth embodiment is only the setting of an acquisition request sending buffer margin value THLj at Step H70 of FIG. 31.

With an RTT at the time of a preceding content fragment request denoted as RTTj_old and an RTT of the content fragment request this time as RTTj, update the THLj according to the following expressions:

THLj_old=THLj;

THLj=THLj_old×RTTj/Rttj_old.

Method of increasing (decreasing) the THLj with an increase (decrease) of the RTT is not limited to thus described method. By increasing the THLj when the RTT is increased, a content acquisition request requiring more time for content fragment acquisition is more frequently sent. As a result, exhaustion of a buffer derived from time-consuming data acquisition can be suppressed to guarantee quality of streaming to more clients.

However, since having too large a buffer margin is meaningless in view of constraints on space of the storage unit 204E, make not the THLj be the maximum THLmax-j designated or above. In addition, decreasing the THLj too much results in causing the buffer to run out even because of light congestion of the network and add a probability of degradation in viewing and listening quality of a client. Therefore, make not the THLj be the minimum THLmin-j set or below.

Similarly to the tenth embodiment, basic structure of the eleventh embodiment is allowed to be that of any of the fifth to ninth embodiments. Since based in particular on the seventh to ninth embodiments, bottlenecking link congestion can be avoided to some extent, it is preferable to use the seventh to ninth embodiments as a basis.

Effect of the eleventh embodiment is enabling buffer exhaustion at the time of congestion of a specific connection (acquisition path) to be prevented which could not be conventionally avoided. Employing this effect together with monitoring of a bottlenecking link is expected to produce more excellent effect.

(Twelfth Embodiment)

The foregoing embodiments are premised on that an acquisition request targeting one client is executed only one at the same time. In a case where an effective band which can be used for obtaining data by one acquisition request is limited, however, even when a band has free space, such a constraint that an acquisition request targeting one client is executed one at a time hinders realization of active acquisition making the most of the free band. Such a situation occurs, for example, in a case where an origin server is designed to send data only at the same rate as a viewing and listening rate of a client. Since executing only one acquisition request targeting one client at the same time obtains data only at a viewing and listening rate, it is impossible to increase a buffer margin from a current value. In this case, when data arrives with a delay due to network congestion or the like, shortage of a buffer margin will immediately occur to have a possibility of degradation in quality of a stream sent to a client.

Even when an effective band usable for obtaining data by one acquisition request is limited, executing a plurality of acquisition requests targeting one client at the same time leads to active acquisition making the most of a free band.

The twelfth embodiment shows a control system realizes, even when an effective band usable for obtaining data by one acquisition request is limited, active acquisition making the most of a free band by simultaneously executing a plurality of acquisition requests targeting one client, thereby enabling more clients to ensure a buffer margin good enough for maintaining streaming quality.

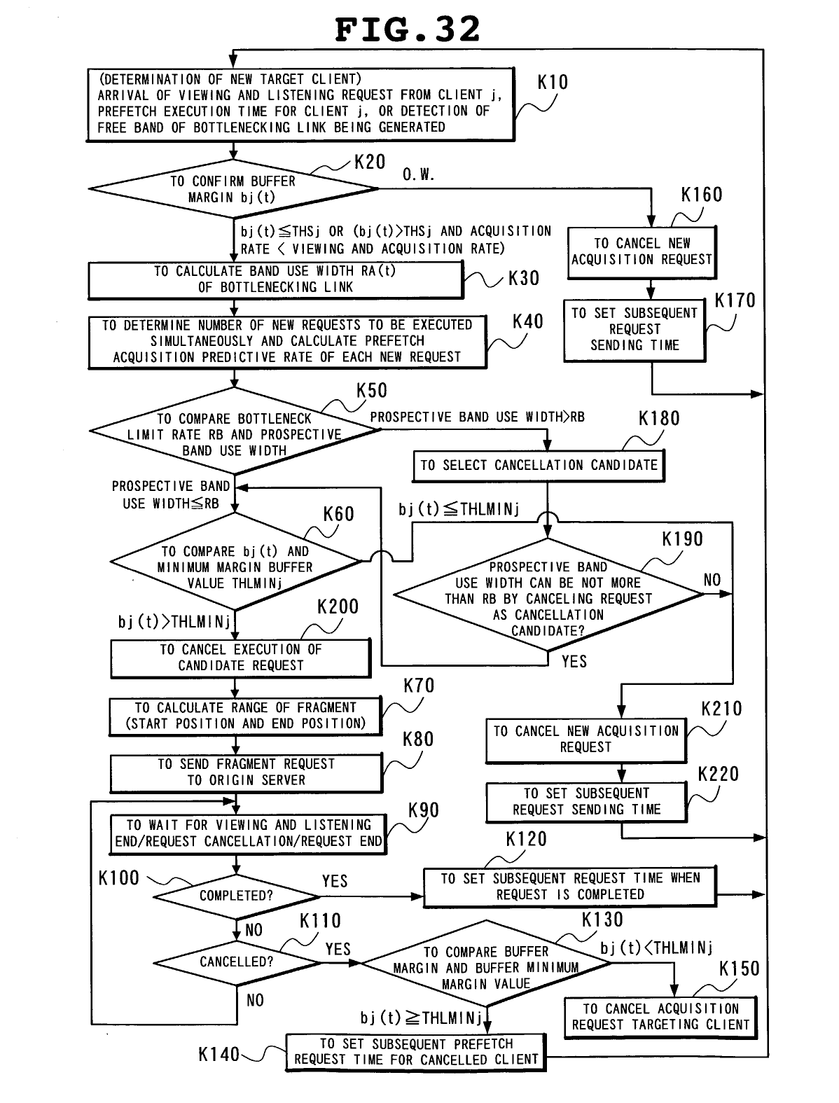

With reference to the flow chart of FIG. 32 and the structural diagram of FIG. 26, the twelfth embodiment will be described. Although the following embodiment is based on the control using a prospective buffer margin in the eighth embodiment, using a prospective buffer margin is not an essential part of the present embodiment. The essential part of the present embodiment includes realizing an increase in a rate of data acquisition in response to acquisition requests targeting the same client by simultaneous execution of a plurality of acquisition requests and suppressing the number of requests to be simultaneously executed within a range causing no network congestion.

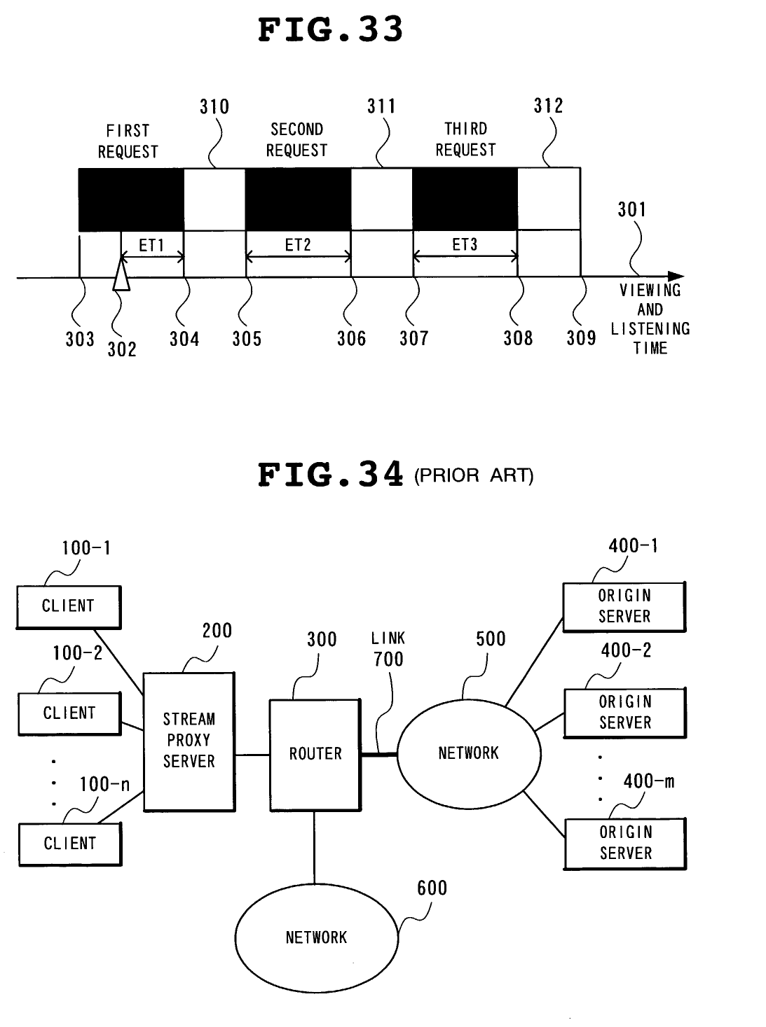

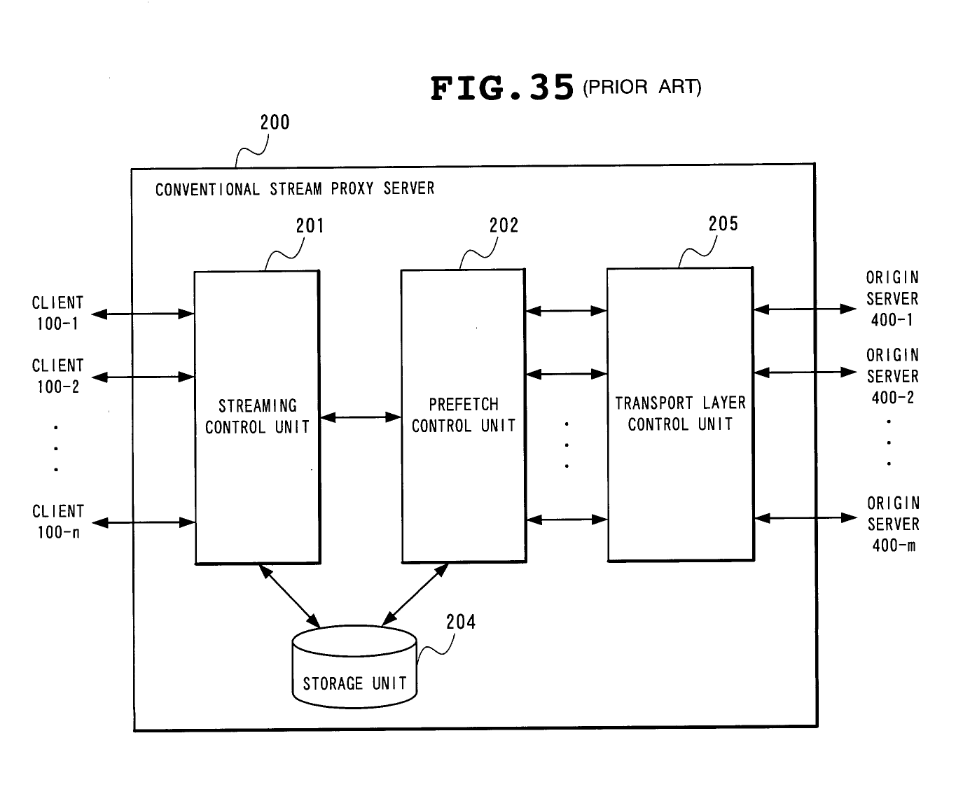

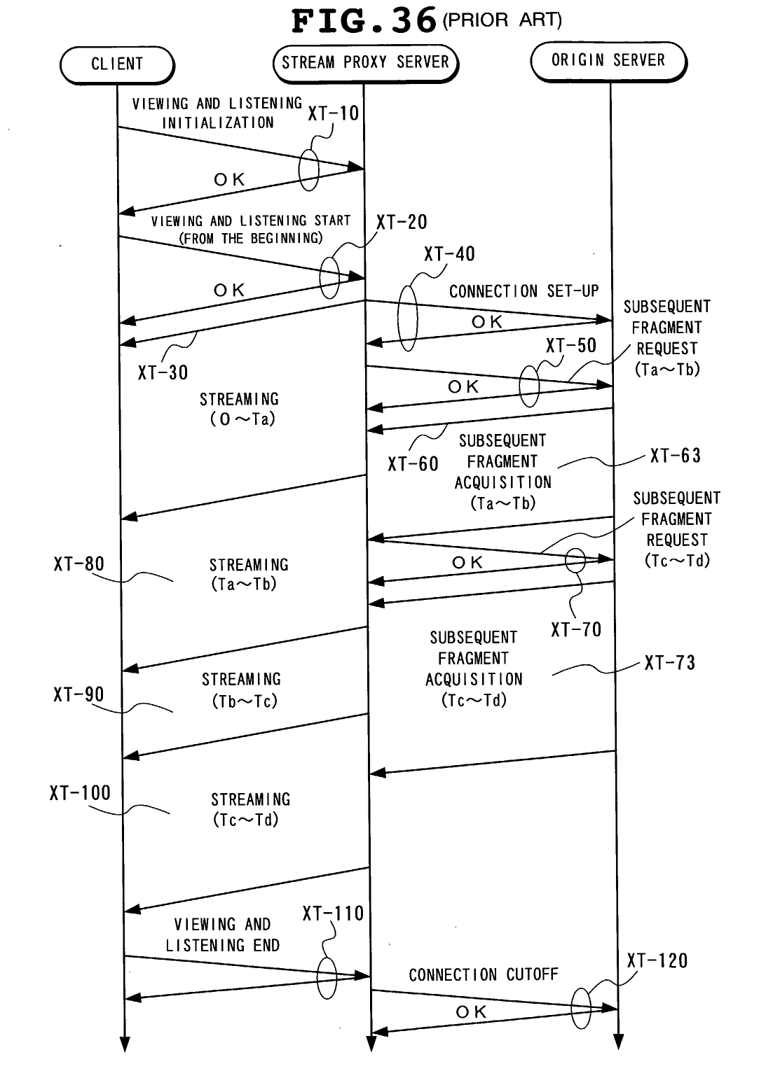

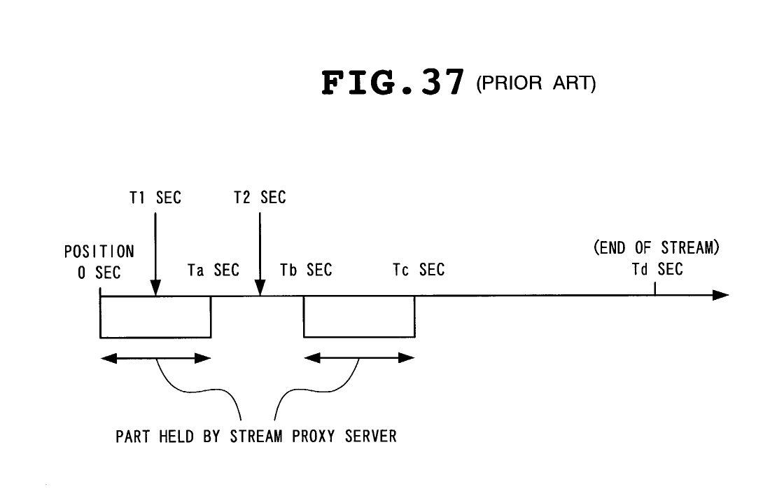

Here, a prospective buffer margin according to the present embodiment will be defined with reference to FIG. 33. An abscissa 301 represents a viewing and listening time in FIG. 33. A client's viewing and listening position after time PT is assumed to be at a position indicated by a triangle of 302. Then, assume that three requests targeting the same client are being currently executed. A first request (311) is estimated to obtain data from a position indicated by 303 on the stream proxy server to a position indicated by 304 after the time PT and an acquisition request is assumed to be completed at a position indicted by 305. Assume a time width between 302 and 304 to be ET1. A second request (312) is estimated to obtain data from a position indicated by 305 on the stream proxy server to a position indicated by 306 after the time PT and an acquisition request is assumed to be completed at a position indicated by 307. Assume a time width between 305 and 306 to be ET2. A third request (313) is estimated to obtain data from a position indicated by 307 on the stream proxy server to a position indicated by 308 after the time PT and an acquisition request is assumed to be completed at a position indicated by 309. Assume a time width between 307 and 308 to be ET3. First, as one definition, a prospective buffer margin is a time of data yet to be viewed and listened by a client among data obtained by requests targeting the same client at time after the time PT from the current time. At this time, the prospective buffer margin will be ET1+ET2+ET3. As another definition, in data obtained at time after the time PT from the viewing and listening position, the margin can be a time of the data before the data breaks seen from the current viewing and listening position. In this case, in the example of FIG. 33, the ET1 will be a prospective buffer margin.

Although a prospective buffer margin can be thus defined in several manners, the following is the description using the definition that the margin is a time of data yet to be viewed and listened to by a client among data obtained by requests targeting the same client at time after the time PT from the current time. This is not an essential part of the present embodiment and also by replacing the definition by another that the margin can be a time, on data obtained at time after the time PT from the viewing and listening position, before data breaks seen from the current viewing and listening position, substantially the same embodiment can be realized.

Next, the principle of the present embodiment will be outlined.

When a buffer is just before running out (buffer margin is approximate to 0), whether content fragment should be obtained or not is determined by a high and low relationship between an acquisition rate and a user viewing and listening rate. When the acquisition rate is lower than the viewing and listening rate, there is no chance of recovery of the buffer margin. The prospective buffer margin can be calculated as 0. In this case, since streaming to a client will be interrupted immediately, obtaining a content fragment will only accelerate band congestion. Therefore, cancel a further request for a content fragment. In the foregoing embodiments, since the number of acquisition requests for one target client to be executed simultaneously is limited to one, this determination is made based on an acquisition rate which can be realized by one acquisition request (one connection). On the other hand, the present embodiment allows execution of a plurality of acquisition requests targeting the same client as long as a band has an allowance. Even when a plurality of acquisition requests are executed in parallel to each other in a free band, if a total acquisition rate of data by these acquisition requests is lower than the client's viewing and listening rate and there is no chance of recovery of a buffer margin, cancel sending of an acquisition request. When a total acquisition rate of data by these acquisition requests is higher than the client's viewing and listening rate, even if the buffer is just before running out, there is a chance of recovery of a buffer margin. In other words, the prospective buffer margin can be expected to have a value of a certain amount. Therefore, intend to recover a buffer margin by ensuring a total acquisition rate necessary for recovering the buffer margin by executing acquisition requests in parallel to each other as long as a band permits.

Next, consider a case where a buffer margin is not so good (not so small as being just before running out). When a total acquisition rate of data by acquisition requests targeting the same client is higher than the viewing and listening rate, a prospective buffer margin can be expected to have a value of a certain amount similarly to the above case. By ensuring a rate by executing acquisition requests in parallel to each other as long as a band permits, intend to increase a buffer margin. When the total acquisition rate of data by acquisition requests targeting the same client is lower than the viewing and listening rate, the prospective buffer margin will be further reduced. In other words, the prospective buffer margin approximates to 0. Since the buffer will in due course run out unless countermeasures are taken, it is desirable to ensure an appropriate acquisition rate as soon as possible. For this purpose, when requests whose target client has a large buffer margin exist, interrupt the acquisition therefor and succeed in bands used by these requests to ensure a necessary acquisition rate. At this occasion, preferentially cancel a subsequent content fragment acquisition request until a necessary band is ensured. Interruption of other request is possible when a request having a larger buffer margin exists. When such a request fails to exist, it is impossible to obtain a required acquisition rate. However, when obtaining no content fragment at all until a necessary acquisition rate is ensured, the buffer will shortly run out (prospective buffer margin becomes 0). It is therefore necessary as a temporary measure to put off a time of exhaustion of the buffer by obtaining a content fragment at a possible rate as a temporal measure. However, when the acquisition rate continues for a long period of time as it is, it is apparent that a buffer margin of the target client will run out. Acquisition of a content fragment should be ended for a shorter period of time than that in a case where an acquisition rate is higher than a viewing and listening rate to check whether a necessary acquisition rate can be ensured. Therefore, reduce a period of time when a low acquisition rate is ensured, that is, a requested range.

Next, consideration will be given to a case where a buffer margin is good enough. When a buffer margin is good enough, it is in general unnecessary to obtain a content fragment at once. Sending of a content fragment request accordingly could be postponed. This is not the case when an acquisition rate is significantly lower than a viewing and listening rate. This case represents that a network is considerably congesting, which means that a good buffer margin at present will shortly run out. In other words, unless content fragment acquisition is conducted, the prospective buffer margin will approximate to 0. In this case, it is better to obtain a content fragment at an available acquisition rate and prevent the buffer from running out to go through until the network congestion is eliminated.

Detailed control will be described in the following with reference to the flow chart of FIG. 32 and the structural diagram of FIG. 26.

Generation of a content acquisition request occurs at the arrival of a viewing and listening request from a client, at a time point of sending a content fragment acquisition request set for each client which will be described in the following or at the detection, by the network information acquisition unit 207E, of a free band being generated in a bottlenecking link. The prefetch control unit 202E monitors the events of the arrival of a viewing and listening request from the streaming control unit 201E and a time point of sending of a content fragment acquisition request to wait for generation of a new acquisition request. Then, determine a new target client j. In addition, when detecting a free band being generated in the bottlenecking link, the network information acquisition unit 207E instructs the prefetch control unit 202E to generate a new acquisition request. The prefetch control unit 202E determines the target client j having the lowest prospective buffer margin as a new target client (Step K10).

First, confirm an actual buffer margin of the client j at the current time (Step K20). In a case where the buffer margin bj(t) is larger than a desired buffer margin value THSj designated for each client (bj(t)>THSj) and a total acquisition rate of all the requests being executed targeting the client j exceeds a viewing and listening rate of the client j, determination is made that there is still a margin to cancel sending of a new acquisition request (Step K160). Then, when the content is being viewed and listened to by the client, set subsequent request generation time (Step K170). Method of setting subsequent request generation time will be described at Step K140 which will be described later. When the buffer margin is not more than THSj or when the buffer margin exceeds THSj but the acquisition rate of the request targeting the client j is below the viewing and listening rate of the client j, proceed to Step K30 and the following steps.

When bj(t)≦THSj, the prefetch control unit 202E obtains a bottlenecking link band use width RA(t) from the network information acquisition unit 207E (Step K30). Method of obtaining RA(t) of the network information acquisition unit 207E is the same as that of the fifth embodiment.

Next, determine how many new acquisition requests are to be executed in parallel to each other and calculate a prefetch acquisition predictive rate expected for each request (Step K40). Assume that a number mj of acquisition requests targeting the client j are being already executed. Acquisition requests within the range are labeled with 1 to mj in ascending order. Then, assume that a rate of data acquisition by these requests is zj,h(t) (h=1, . . . , mj). Here, the prefetch control unit 202E predicts a prefetch predictive acquisition rate expected when an acquisition request targeting the client j is newly added. This rate will be referred to as a prefetch predictive acquisition rate and represented as z j,mj+k(t) (h=1, . . . ). Assume that a method of estimating the z*j,mj+k(t) can be found by inquiring of the origin server similarly to the sixth embodiment. Then, based on the prefetch predictive acquisition rate, calculate how many new acquisition requests are to be executed. Calculate how many connections are required for realizing a rate necessary for making a buffer margin have a desired value, that is, how many new acquisition requests should be executed in parallel to each other. Possible system is, for example, newly ensuring an acquisition rate for making a buffer margin have the desired buffer margin value THSj after the time PT from the current time. Express a time from when the client j sends a request until when data arrives at the origin server as RGSj. Also express an estimated time of acquisition completion of an h-th (in the previous labeling) request targeting the client j as TFj,h. A desired acquisition rate is that required for ensuring the desired buffer margin value THSj after the time PT by newly sending an acquisition request when execution of an acquisition request being currently executed continues. This is obtained by calculating vj(t) which satisfies the following expression:

$${THS}_{j} = {b}_{j} ( t ) - PT + \frac{( {\sum }_{h = 1}^{{m}_{j}} {z}_{j , h}^{*} ( t ) \times min ( {TF}_{j} , PT ) )}{{r}_{j} ( t )} + \frac{{v}_{j} ( t )}{{r}_{j} ( t )} \times ( PT - {RGS}_{j} )$$

in which min(x,y) is a function which returns a smaller one of x and y and is calculated by the following expression:

$${v}_{j} ( t ) = {r}_{j} ( t ) \times [ {THS}_{j} - ( {b}_{j} ( t ) - PT + \frac{( {\sum }_{h = 1}^{{m}_{j}} {z}_{j , h}^{*} ( t ) \times min ( {TF}_{j} , PT ) )}{{r}_{j} ( t )} ) ] / ( PT - {RGS}_{j} )$$

In order to realize the rate, calculate how many new acquisition requests should be sent (the number of requests to be executed simultaneously). In other words, obtain a minimum k which satisfies the following expression:

$${z}_{j , mj + 1}^{*} ( t ) + … + {z}_{j , mj + k}^{*} ( t ) \geq {v}_{j} ( t )$$

When such k fails to exist (when a desired acquisition rate can not be ensured even if the number of requests to be executed simultaneously is increased), select a value most approximate to vj(t) as the number k of requests to be simultaneously executed.

Confirm a prefetch based use width not exceeding the bottleneck limit rate RB or not, which width is obtained when traffic of the prefetch acquisition predictive rate is added to the bottlenecking link (Step K50). In other words, check if the following expression holds or not:

$$RA ( t ) + {\sum }_{h = {m}_{j} + 1}^{{m}_{j} + k} {z}_{j , h}^{*} ( t ) > RB$$

When the expression fails to hold, proceed to Step K60 and the following steps. In a case where the following expression holds:

$$RA ( t ) + {\sum }_{h = {m}_{j} + 1}^{{m}_{j} + k} {z}_{j}^{*} ( h , t ) > RB$$

sending all the new acquisition requests invites congestion of the bottlenecking link. In order to avoid such a situation, it is necessary to cancel sending of some (or all) of the new acquisition requests or instead of sending, stop other acquisition request for a content fragment being executed. Therefore, the prefetch control unit 202E checks whether acquisition requests including new acquisition requests that can be cancelled exist or not and when such a request exists, select the same as a cancellation candidate (Step K180). The simplest manner is, with respect to an acquisition request being executed, calculating a prospective buffer margin obtained when its execution is cancelled (cancellation buffer margin) and as to a new acquisition request, calculating a prospective buffer margin obtained when the request is not executed (buffer margin at the time of no sending) and considering a request whose cancellation buffer margin and buffer margin at the time of no sending are large in descending order as a candidate for cancellation.

One example of cancellation buffer margin calculation methods will be here described. Define a prospective buffer margin a designated time width PT after the current time obtained when the request in question is cancelled as a cancellation buffer margin. From the request sending to the actual cancellation, it takes as much time as that required for a packet to arrive from the proxy stream server 20E at the origin server. Express a time required for canceling an acquisition request for a content fragment targeting the client i as RCSi. Here, the RCSi may be approximated by half the RTTi, which is an RTT of an acquisition request targeting the client i measured by the reception condition monitoring unit 202E-1. Assume that the request in question is mi-th (in the previous labeling) of the requests targeting the client i. When the mi-th is selected as a candidate for cancellation, even if the (mi+1)th and following requests exist, they are already regarded as candidates for cancellation because a candidate for cancellation is determined starting with subsequent requests. As a result, when the request in question is cancelled, a prospective buffer margin under a condition that the (mi−1)th and the following requests are executed will be a cancellation buffer margin. More specifically, a cancellation buffer margin of the mi-th acquisition request targeting the client i will be calculated by the following expression:

$${b}_{i}^{*} ( t - PT ) = {b}_{i} ( t ) - PT + \frac{{\sum }_{h = 1}^{{m}_{j} - 1} {z}_{i , h} ( t ) \times min ( {TF}_{i , h} , PT )}{{r}_{i} ( t )} + \frac{{z}_{i , mi} ( t )}{{r}_{i} ( t )} \times min ( {TF}_{i , mi} , {RCS}_{i} )$$

wherein TFi,h denotes an estimated time when an h-th acquisition request targeting the client i completes data acquisition.

Next, one example of methods of calculating a buffer margin at the time of no sending will be described. Assuming that a new acquisition request is an (mi+h)th request targeting the client i in the previous labeling, the buffer margin at the time of no sending is equivalent to a buffer margin obtained when new requests up to mi+(h−1)th are sent. In other words, the buffer margin at the time of no sending is calculated by the following expression:

$${b}_{i}^{*} ( t - PT ) = \frac{{\sum }_{h = 1}^{{m}_{j} - 1} {z}_{i , h} ( t ) \times min ( {TF}_{i , h} , PT )}{{r}_{i} ( t )} + \frac{{\sum }_{h = {m}_{i} + 1}^{{m}_{i} + h - 1} {z}_{i , h} ( t ) \times min ( {TF}_{i , h} , {RCS}_{i} )}{{r}_{i} ( t )}$$

For each request, calculate a cancellation buffer margin and a buffer margin at the time of no sending. Then, consider the requests as a candidate for cancellation in descending order of their values. Candidates for cancellation will be selected, even when execution of a request being executed which is not considered to be a candidate for cancellation is continued and furthermore a new acquisition request which is not considered to be a candidate for cancellation is executed, until a total of an acquisition rate of the request being executed and a predictive acquisition rate of the new request attains the bottleneck limit rate or below.

However, when continuing canceling an acquisition request according only to a relative amount of a prospective buffer margin, buffer margins of all the requests will be monotonously decreased to result in having a possibility of degradation in quality of streaming to all the clients. Therefore, stop selecting a candidate for cancellation upon the prospective buffer margin value for the target client becoming a set minimum prospective buffer margin threshold value or below.

Then, check if canceling a selected acquisition request as a candidate for cancellation enables a prospective band use width of the bottleneck to be equal to or below the bottleneck limit rate (Step K190). Express an acquisition rate of a request h targeting the client i at the current time t as zi,h(t). Assume that the number of targeting clients is M, that requests targeting the client i which are not considered to be a candidate for cancellation exist as many as a number mi (i=1, . . . , M), and that new acquisition requests not considered to be a candidate for cancellation exist as many as a number ni (i=1, . . . , M). If a prospective band use width will not be equal to or below the bottleneck limit rate even when all these requests are cancelled, that is, the following expression holds, the prefetch control unit 202E cancels sending of a new request from the client j (Step K210):

$$RA ( t ) + {\sum }_{i = 1}^{M} ( {\sum }_{h = 1}^{{m}_{j}} {z}_{i , h} ( t ) + {1}_{( {n}_{1} > 1 )} {\sum }_{h = {m}_{i} + 1}^{{m}_{i} + {n}_{i}} {z}_{i , h}^{*} ( t ) ) > RB$$

Then, set a time of sending an acquisition request for a content fragment targeting the client j according to the method which will be described later at Step K140. Here, 1(ni1) is a variable attaining 1 when ni>1 and otherwise attaining 0. In addition, although execution of a request selected as a candidate for cancellation may be or may not be cancelled, the flow chart of the present embodiment assumes that it is not cancelled.

At Step K190, when the prospective band use width can be equal to or below the bottleneck limit rate by canceling a candidate for cancellation, proceed to Step K60 and when the buffer margin is larger than THLMINj at Step K60, cancel execution of the request as a candidate for cancellation being executed and abandon a new acquisition request included in the cancellation candidates (Step K200).

When the determination is made at Step K50 that a band necessary for sending a new acquisition request is ensured, the prefetch control unit 202E intends to proceed to calculation of a requested content fragment range at Step K70 and the following steps.

However, when a total of a prefetch acquisition predictive rate of an acquisition request being executed and that of a new acquisition request calculated (hereinafter referred to as a total acquisition predictive rate) expressed by the following expression is smaller, exhaustion of a buffer (buffer margin becomes 0) is inevitable even by looking ahead:

$${z}_{j}^{*} ( t ) = {\sum }_{h = 1}^{{m}_{i}} {z}_{i , h} ( t ) + {\sum }_{h = {m}_{i} + 1}^{{m}_{i} + {n}_{i}} {z}_{i , h}^{*} ( t )$$

In such a case, the new acquisition request should be given up. This determination is made at Step K60. More specifically, when a prospective buffer margin b*j(t) is equal to or below a designated minimum buffer margin value THLMINj, proceed to Step K210 to cancel sending of a new acquisition request. When the buffer margin is larger than THLMINj, proceed to Step K200 to cancel a candidate request as described above, as well as proceeding to Step K70 and the following steps to send a new acquisition request.

At Step K70, calculate a range of a content fragment of the new acquisition request. First, a start position of a leading new acquisition request coincides with a larger one of an end position of a preceding request and a current viewing and listening position. This is the same as that of the fifth and sixth embodiments. Assume an end position of a final acquisition request (last request among requests targeting the client j) to be a position which enables a prospective buffer margin obtained at the time of completion of execution of an acquisition request to be a desired buffer margin value THSj. Description will be made of a method of calculating an end position in a case, for example, where a stream is encoded as CBR of a fixed viewing and listening rate rj and a total acquisition predictive rate for obtaining stream data from the origin server by the proxy stream server 20E is constantly zj. The proxy stream server 20E increases a buffer at a rate of (zj−rj) (bps) from the arrival of data located at the requested start position until the arrival of data located at the end position. In terms of a buffer margin, this generates a buffer margin of (zj−rj)/rj sec per unit time. With a time from when the proxy stream server 20E transmits a content acquisition request until when receiving data at the end position expressed as ST, a prospective buffer margin b*j(t+ST) after ST will be calculated as follows taking RTTj which is an RTT from request transmission until reception of data at a start position into consideration:

$${b}_{j}^{*} ( t + ST ) = {b}_{j} ( t ) + \frac{( {z}_{j} - {r}_{j} )}{{r}_{j}} \times ( ST - {RTT}_{j} )$$

b*j(t)=THSj is established when the following expression holds:

$$ST = \frac{{r}_{j}}{( {z}_{j} - {r}_{j} )} \times ( {THS}_{j} - {b}_{j} ( t ) ) + {RTT}_{j}$$

In this expression, ST>RTTj should hold (because it is strange that scheduled time of data acquisition completion is set to be shorter than RTT). Therefore, when THSj>bj(t), zj>rj should hold. How to cope with a case where THSj>bj(t) and zj≦rj will be considered on other occasion. When THSj≦bj(t), zj<ri holds without fail because a case where an acquisition rate exceeds a viewing and listening rate is excluded at Step E20, so that ST>RTTj is established. When satisfying ST>RTTj, a range CST of contents obtained after ST sec will be expressed as follows:

$$CST = \frac{( ST - {RTT}_{j} ) {z}_{j}}{{r}_{j}} = \frac{( {THS}_{j} - {b}_{j} ( t ) ) {z}_{j}}{( {z}_{j} - {r}_{j} )}$$

Therefore, set the end position of a final request to be “start position+CST”. By this arrangement, the buffer margin of the client j is expected to be THSj after ST sec from the current time. The simplest manner of obtaining a range of each request is evenly sharing a width of “start position+CST”. Other possible manner is setting a range such that the later a request is, the shorter a width is taking into consideration that cancellation is applied starting with the last request. It is further possible to give a part so as to have an overlap to some extent and not a completely different part.

However, when THSj>bj(t) and zj≦rj, the buffer margin can not be THSj. Issuing no acquisition request at all because the buffer margin can not be a desired buffer margin value, however, results in further constraining the buffer margin. Although an appropriate content fragment range should be set to execute acquisition, requesting a too wide range will result in delaying timing for ensuring an acquisition rate, causing the buffer margin to be constrained. The range should be desirably set to be narrow such that a subsequent acquisition request is executed as soon as possible. Therefore, with the minimum buffer margin value THLMINj designated, the prefetch control unit 202E sets a range where the prospective buffer margin attains THLMINj. b*j(t)=THLMINj is established when the following expression holds:

$$ST = \frac{{r}_{j}}{( {r}_{j} - {z}_{j} )} \times ( {b}_{j} ( t ) - {THLMIN}_{j} ) + {RTT}_{j}$$

ST>RTTj should hold. Since a case where bj(t)≦THLMINj (where the minimum buffer margin value can not be ensured) is already excluded at Step K60, ST>RTTj always holds. When bj(t)>THLMINj, request a range represented by the following expression:

$$CST = \frac{( ST - {RTT}_{j} ) {z}_{j}}{{r}_{j}} = \frac{( {b}_{j} ( t ) - {THLMIN}_{j} ) {z}_{j}}{{r}_{j} - {z}_{j}}$$

Set the end position to be “start position+CST” using this CST. As a result of this setting, the buffer margin of the client j after ST sec from the current time can be expected not to be equal to or below THLMINj. The simplest manner of obtaining a range of each request is evenly sharing a width of “start position+CST”. Other possible manner is setting a range such that the later a request is, the shorter a width is taking into consideration that cancellation is applied starting with the last request.

Then, the prefetch control unit 202E instructs the transport layer control unit 205E to send the number ni of the new content acquisition requests which are not considered to be a cancellation candidate with a range determined at the preceding step designated to the origin server and receive a content fragment (Step K80).

Then, the prefetch control unit 202E waits for either of the events, the cancellation of the sent request (Step K110) or the completion of acquisition of the content fragment by the sent request (Step K100) to occur (Step K90).

When the content fragment acquisition is completed (Step K100), the prefetch control unit 202E sets subsequent sending time of an acquisition request targeting the client j (Step K120). Set as the subsequent request sending time is predicted time when the buffer margin will reach the acquisition request sending buffer margin threshold value THLj as subsequent request generation time. Assuming that the current buffer margin is bj(t) (≧THLj), a prospective buffer margin after XT sec, i.e. b*j(t+XT), will be calculated by the following expression, with the number of requests being executed targeting the client j expressed as mi:

$${b}_{j}^{*} ( t - XT ) = {b}_{ji} ( t ) - XT + \frac{{\sum }_{h = 1}^{{m}_{j}} {z}_{j , h} ( t ) \times min ( {TF}_{jh} , XT )}{{r}_{j} ( t )}$$

Obtain XT which satisfies the expression and set “the current time+XT” as subsequent acquisition request sending time. If THLj>bj(t), which means that a buffer margin is not good enough, set the current time as subsequent request acquisition sending time to immediately return to Step E10.

When canceling a request for obtaining a content fragment (Step K110), the prefetch control unit 202E sets subsequent sending time of the acquisition request targeting the client j (Step K140). When the request is cancelled, a time interval before subsequent request sending should have a certain amount of time. This is because executing re-request immediately will accelerate network congestion. When the current buffer margin value is bj(t)>THLj, the subsequent request generation time should be predicted time when the buffer margin will reach the acquisition request sending buffer margin threshold THLj similarly to the case of completion. On the other hand, when the current buffer margin value is bj(t)≦THLj, set as subsequent request sending time is predicted time when the prospective buffer margin will reach the minimum buffer margin value THLMINj as subsequent request generation time. Assuming the current buffer margin to be bj(t) (≧THLMINj), the prospective buffer margin after XT sec, i.e. b*j(t+XT), will be expressed by the following expression with the number of requests being executed targeting the client j after the cancellation expressed as ki:

$${b}_{j}^{*} ( t - XT ) = {b}_{ji} ( t ) - XT + \frac{{\sum }_{h = 1}^{{k}_{j}} {z}_{j , h} ( t ) \times min ( {TF}_{jh} , XT )}{{r}_{j} ( t )}$$

Obtain XT which satisfies the expression and set “the current time+XT” as subsequent acquisition request sending time. If THLMINj>bj(t), determining that the buffer margin is not large enough to maintain viewing and listening quality, give up acquisition of the content fragment targeting the client j (Step K150).

The foregoing processing flow is cancelled when a viewing and listening end request from the client j arrives at the prefetch control unit 202E through the streaming control unit 201E. Upon receiving the viewing and listening end request, the prefetch control unit 202E instructs the transport layer control unit 205E to send an acquisition cancellation request to the origin server. In addition, when necessary, instruct on cut-off of the connection between the origin server and the stream proxy server.

Effect of the twelfth embodiment is even when an effective band usable for obtaining data by one acquisition request is limited, realizing active acquisition making the most of a free band by simultaneously executing a plurality of acquisition requests targeting one client.

In the above-described respective embodiments, the functions of the streaming control unit, the prefetch control unit, the reception rate control unit, the transport layer control unit and the network information acquisition unit and other functions of the stream proxy server can be realized not only by hardware but also as software by loading a proxy control program having the respective functions into a memory of a computer processing device. A proxy control program 1000 is stored in a recording medium such as a magnetic disc, a semiconductor memory or the like. Then, loading the program from the recording medium into the computer processing device to control operation of the computer processing device realizes the above-described each function.

Although the present invention has been described with respect to the preferred modes and embodiments in the foregoing, the present invention is not limited to the above-described modes and embodiments but implemented in various forms within a scope of its technical idea.

As described in the foregoing, the present invention attains the following effects.

First, acquisition of contents from the origin server can be realized in the proxy server with effects on other traffic flowing in the network suppressed as much as possible.

Secondly, controlling a rate of content acquisition from the origin server and controlling band assignment among contents sharing the same bottleneck by the proxy server enables a possibility of degradation in viewing and listening quality to be reduced as much as possible.

Thirdly, controlling a rate of content acquisition from the origin server by the proxy server enables a possibility that degradation in viewing and listening quality will occur related to viewing and listening having high priority to be minimized.

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

1. A proxy server, with a part or all of contents stored in a storage device, for streaming the contents from the storage device to a client, while obtaining a part of the contents not held from an origin server and adding the part to said storage device, which controls
a rate of content acquisition from said origin server according to at least either network conditions or conditions of a reception buffer of said contents.

2. A proxy server, with a part or all of contents stored in a storage device, for streaming the contents from the storage device to a client, while obtaining a part of the contents not held from an origin server and adding the part to said storage device, which selects
a protocol for use in obtaining contents from said origin server from among a plurality of protocols having different band sharing characteristics according to at least either network conditions or conditions of a reception buffer of said contents.

3. The proxy server as set forth in claim 1, which obtains contents from said origin server by using a protocol having a flow control function and realizes the control of the rate of content acquisition from said origin server by the control of a rate of reading contents from the reception buffer of said protocol.

4. The proxy server as set forth in claim 1, which selects a protocol for use in obtaining contents from said origin server from among a plurality of kinds of protocols having a flow control function and different band sharing characteristics according to at least either network conditions or conditions of the reception buffer of said contents and realizes the control of the rate of content acquisition from said origin server by the control of a rate of reading contents from the reception buffer of said protocol.

5. The proxy server as set forth in claim 1, which realizes the control of the rate of content acquisition from said origin server by instructing said origin server on a transmission rate.

6. The proxy server as set forth in claim 1, which realizes content acquisition from said origin server by selecting a protocol for use in obtaining contents from among a plurality of kinds of protocols having different band sharing characteristics according to at least either network conditions or conditions of the reception buffer of said contents and realizing the control of the rate of content acquisition from said origin server by instructing said origin server on a transmission rate.

7. The proxy server as set forth in claim 1, which determines the rate of content acquisition from said origin server also taking priority set for said contents or client into consideration.

8. A proxy server, with a part of contents accumulated in a buffer, for streaming the contents from said buffer to a client, while obtaining a part of the contents following a current position of accumulation of the contents in the buffer from an origin server and adding the part to the buffer, which detects
the remainder of time of the contents accumulated in said buffer and obtains said content part following the current position of accumulation of the content in question in the buffer from said origin server at the timing when said remainder of time attains a value equal to or below a threshold value.

9. The proxy server as set forth in claim 8, which,
with priority given to acquisitions of said following content parts, makes adjustment to prevent a band use width of a bottlenecking link from exceeding a reference value by canceling acquisition whose said priority is low.

10. The proxy server as set forth in claim 9, which sets said priority based on a difference between a position of content viewing and listening by said client and the accumulation position in said buffer.

11. The proxy server as set forth in claim 9, which sets said priority for at least any of each origin server in which said contents are accumulated, each client to which the contents are streamed and each content to be obtained.

12. A proxy server, with a part of contents accumulated in a buffer, for streaming the contents from the buffer to a client, while obtaining a part of the contents following a current position of accumulation of the contents in the buffer from an origin server and adding the part to the buffer, which obtains
the content part following the current position of accumulation of the content in question in the buffer from the origin server by predicting that the remainder of time of contents accumulated in said buffer will attain a value equal to or below a threshold value at designated time.

13. The proxy server as set forth in claim 8, which obtains a content part following the current position of accumulation of the content in question in the buffer from said origin server such that at designated time, the remainder of time of the contents accumulated in the buffer exceeds a designated value by selectively using a plurality of data transmission and reception means having different communication speeds.

14. The proxy server as set forth in claim 13, which uses protocols having preferential control as a plurality of data transmission and reception means having different communication speeds.

15. The proxy server as set forth in claim 13, which selectively uses different transport layer protocols as a plurality of data transmission and reception means having different communication speeds.

16. The proxy server as set forth in claim 8, which dynamically updates a threshold value for determining timing of obtaining a content part following the current position of accumulation of the content in question in the buffer from said origin server according to a change of congestion conditions of a network connected with said origin server.

17. A proxy server, with a part or all of contents stored in a storage device, for streaming the contents from the storage device to a client, while obtaining a part of the contents not held from an origin server and adding the part to the storage device, which selects
a protocol having a transmission rate control function for use in obtaining contents from said origin server from among a plurality of protocols having different band sharing characteristics according to at least either network conditions or conditions of a reception buffer.

18. The proxy server as set forth in claim 1, which obtains contents from said origin server by using a protocol having a flow control function and a transmission rate control function and realizes the control of the rate of content acquisition from said origin server by the control of a rate of reading contents from the reception buffer of said protocol having the flow control and transmission rate control functions.

19. The proxy server as set forth in claim 1, which selects a protocol having a transmission rate control function for use in obtaining contents from said origin server from among a plurality of kinds of protocols having a flow control function and different band sharing characteristics according to at least either network conditions or conditions of the reception buffer and realizes the control of the rate of content acquisition from said origin server by the control of a rate of reading contents from the reception buffer of the protocol having the transmission rate control function.

20. The proxy server as set forth in claim 1, which selects a protocol for use in obtaining contents from said origin server from among a plurality of kinds of protocols having different band sharing characteristics and a transmission rate control function according to at least either network conditions or conditions of the reception buffer and realizes the control of the rate of content acquisition from said origin server by instructing a transmission rate to said origin server.

21. The proxy server as set forth in claim 1, which uses as conditions of said reception buffer, a difference between a buffer margin set as a target and a current buffer margin.

22. The proxy server as set forth in claim 21, which changes said buffer margin set as a target according to network conditions.

23. The proxy server as set forth in claim 8, which simultaneously executes a plurality of prefetchs for contents as the same streaming targets.

24. The proxy server as set forth in claim 8, which,
in prefetchs for contents as the same streaming targets, simultaneously executes the prefetchs as a plurality of requests for different parts.

25. The proxy server as set forth in claim 15, which simultaneously executes a plurality of prefetchs for contents as the same streaming targets within a range which invites no network congestion.

26. The proxy server as set forth in claim 8, which,
in prefetchs for contents as the same streaming targets, simultaneously executes the prefetchs as a plurality of requests for different parts within a range which invites no network congestion.

27. A proxy control program executed on a computer, with a part or all of contents stored in a storage device, for streaming the contents from the storage device to a client, while obtaining a part of the contents not held from an origin server and adding the part to said storage device, which has
a function of controlling a rate of content acquisition from said origin server according to at least either network conditions or conditions of a reception buffer of said contents.

28. A proxy control program executed on a computer, with a part or all of contents stored in a storage device, for streaming the contents from the storage device to a client, while obtaining a part of the contents not held from an origin server and adding the part to said storage device, which has
a function of selecting a protocol for use in obtaining contents from said origin server from among a plurality of protocols having different band sharing characteristics according to at least either network conditions or conditions of a reception buffer of said contents.

29. A proxy control program executed on a computer, with a part of contents accumulated in a buffer, for streaming the contents from said buffer to a client, while obtaining a part of the contents following a current position of accumulation of the contents in the buffer from an origin server and adding the part to the buffer, which has
a function of detecting the remainder of time of the contents accumulated in said buffer and obtaining said content part following the current position of accumulation of the content in question in the buffer from said origin server at timing when said remainder of time attains a value equal to or below a threshold value.

30. A proxy control program executed on a computer, with a part of contents accumulated in a buffer, for streaming the contents from the buffer to a client, while obtaining a part of the contents following a current position of accumulation of the contents in the buffer from an origin server and adding the part to the buffer, which has
a function of obtaining the content part following the current position of accumulation of the content in question in the buffer from the origin server by predicting that the remainder of time of the contents accumulated in said buffer will attain a value equal to or below a threshold value at designated time.

31. A proxy control program executed on a computer, with a part or all of contents stored in a storage device, for streaming the contents from the storage device to a client, while obtaining a part of the contents not held from an origin server and adding the part to the storage device, which has
a function of selecting a protocol having a transmission rate control function for use in obtaining contents from said origin server from among a plurality of protocols having different band sharing characteristics according to at least either network conditions or conditions of a reception buffer.
